(19) United States
(12) Patent Application Publication
(10) Pub. No.: US 2005/0051011 A1
(43) Pub. Date: Mar. 10, 2005

(54) Cutting device for recording medium and recording apparatus incorporating the same

(75) Inventors: Wataru Onishi, Nagano (JP); Takahiro Abe, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/873,641

(22) Filed: Jun. 23, 2004

(30) Foreign Application Priority Data
Jun. 23, 2003 (JP) P2003-177817
Jun. 23, 2003 (JP) P2003-177819
Jul. 7, 2003 (JP) P2003-192635
Jul. 7, 2003 (JP) P2003-192636
Jul. 7, 2003 (JP) P2003-192637
Jul. 11, 2003 (JP) P2003-195514
Jul. 11, 2003 (JP) P2003-195515
Jul. 25, 2003 (JP) P2003-201518
Aug. 22, 2003 (JP) P2003-298223

(51) Int. Cl. B26D 1/01

(52) U.S. Cl. 83/428; 83/563

(57) ABSTRACT

In a cutting device for a recording medium, a cutter cuts a portion of the recording medium, which has been transported in a first direction and subjected to a recording operation, in the first direction and a second direction perpendicular to the first direction. A press roller is disposed adjacent to the cutter to retain the recording medium when the cutting operation is performed. A first driver moves the cutter and the press roller between a first position and a second position in a third direction orthogonal to the first direction and the second direction. A second driver changes an attitude of at least one of the cutter and the press roller in accordance with the direction of the cutting operation.

### BACKGROUND OF THE INVENTION

The present invention relates to a cutting device comprising a cutter for cutting a recorded portion of a transported recording medium in both of a transporting direction and a direction perpendicular to the transporting direction, and a press roller arranged adjacent to the cutter to retain the recording medium during the cutting operation. The present invention also relates to a recording apparatus incorporating such a cutting device.

There has been proposed a printer having a function for cutting a rolled sheet which has been subjected to the printing by a cutter moving in the widthwise direction of the rolled sheet while the rolled sheet is transported in the longitudinal direction by a roller. In this type printer, the feed quantity of the roller and the moving quantity of the cutter are controlled so that the rolled sheet can be cut in accordance with a required shape (cf., Japanese Patent Publication No. 2002-1692A).

In a printer incorporating the above cutting device, there is a possibility that the rolled sheet will be curled by resisting force generated between the rolled sheet and the cutter because the cutter cuts the rolled sheet while moving on the rolled sheet transported to the cutter. If such curling occurs in the rolled sheet R, there is an anxiety that cutting accuracy is deteriorated because the cutter is displaced from the original cutting position of the rolled sheet R.

### SUMMARY OF THE INVENTION

It is therefore an object of the invention is to provide a cutting device capable of cutting a recording medium accurately, and a recording apparatus incorporating such a cutting device.

In order to achieve the above object, according to the invention, there is provided a cutting device for a recording medium, comprising: a cutter by which a recorded portion of a recording medium transported and recorded is cut both in a transporting direction and in a direction perpendicular to the transporting direction; a press roller arranged adjacent to the cutter and provided for pressing the recording medium during the cutting operation; an actuator for moving the cutter and the press roller forward or backward relative to an opposed portion of the recording medium; and a changer for changing the attitude of at least one of the cutter and the press roller in accordance with the cutting direction. In this configuration, because the press roller always presses the recording medium while the cutter cuts the recording medium, the recording medium can be prevented from being curled, so that cutting accuracy can be kept high. Moreover, setting can be made so that the press roller is rolling on the outside of a cutting region, that is, on a surface of the recording medium except the recorded portion. Accordingly, the recording agent can be prevented from being deposited on the press roller.

The cutting device further comprises a controller which moves the cutter and the press roller to a cutting position in accordance with the next cutting position after cutting of the rolled sheet in one direction and which drives the actuator and/or the changer in the cutting position. In this configuration, it is always unnecessary to change the direction of the edge of the cutter after cutting of the rolled sheet in one direction. The invention can be applied even to the case where the cutting sequence is set at random.

The cutter and the press roller are provided so that the directions thereof can be integrally changed by driving force of the driver. In this configuration, the member for driving the cutter can serve as a member for driving the press roller. Accordingly, simple configuration can be provided, so that reduction in size and cost can be achieved.

The cutter and the press roller are provided so that the directions thereof can be individually changed by driving force of the driver. In this configuration, the position of the cutter relative to the press roller can be set at option. Accordingly, the degree of freedom for the setting can be improved.

The cutter is provided so that the attitude of the cutter can be changed by shearing force at the time of cutting whereas the press roller is provided so that the attitude of the press roller can be changed by driving force of the driver. In this configuration, the driver for the cutter can be omitted. Accordingly, simple configuration can be provided, so that reduction in size and cost can be achieved.

Because the recording medium can be cut while being pulled backward in the transporting direction, cutting accuracy can be improved. The changer includes a motor, and a gear mechanism. In this configuration, simple configuration can be provided, so that reduction in size and cost can be achieved.

The cutter comprises a cutting edge for cutting the recorded portion, a housing for accommodating the cutting edge together with the press roller relative to the recording surface of the recording medium, and a driver for retractably protruding the cutting edge from the housing. In this configuration, the mechanism of the cutting device can be simplified, so that reduction in size and cost can be achieved.

When a first cutter runs in a direction perpendicular to the transporting direction automatically while the recording medium is in a standstill state, the first cutter cuts the recorded portion of the recording medium in the direction perpendicular to the transporting direction. When the recording medium is transported backward while the second cutter is in a standstill state, a second cutter cuts the recorded portion in the transporting direction. In this configuration, cutting can be completed if the first and second cutters can move only in a direction perpendicular to the transporting direction. Accordingly, the moving mechanism for the cutter can be simplified. Moreover, because the recording medium can be cut while being pulled backward in the transporting direction, cutting accuracy can be improved.

The cutting device further comprises a retainer for retaining a part of the recording medium when the recording medium is cut. In this configuration, retaining force due to pressing as well as retaining force due to suction is applied on the recording medium, so that the recording medium can be prevented from being displaced when the recording medium is cut. Thus, the recording medium can be cut accurately

The retainer retains a part of the recording medium when the recording medium transported is cut in the direction perpendicular to the transporting direction. Generally, a recording medium held by suction is easily displaced by force acting in a direction orthogonal to the direction of suction. Because retaining force due to pressing as well as retaining force due to suction is however applied on the recording medium, the recording medium can be prevented from being displaced when the recording medium is cut in a direction perpendicular to the transporting direction.

The retainer retains the cutting start side of the recording medium. In this configuration, there is no gap formed under the recording medium at the cutting start point. Moreover, because the recording medium is pulled in the cutting direction after the start of cutting, there is no gap formed under the recording medium. Accordingly, the recording medium can be cut accurately.

The retainer comprises a press member for pressing the recording medium, and a driver for retractably bring the press member to press contact with the recording medium. In this configuration, the retainer can be retracted when the recording medium is not cut. Accordingly, the recording medium can be prevented from interfering with the retainer.

Grooves are provided in a portion opposite to the cutter through the recording medium. In this configuration, the portion opposite to the cutter through the recording medium can be prevented from being damaged by the cutter which passes through the recording medium when the recording medium is cut.

The grooves are arranged at intervals of a predetermined pitch in a direction perpendicular to the transporting direction. In this configuration, when the cutter is moved in a direction perpendicular to the transporting direction, the cutter can be made coincident with one of the grooves. Accordingly, the portion opposite to the cutter through the recording medium can be prevented from being damaged.

The grooves may be provided in the circumferential face of the transport roller which is provided for transporting the recording medium. In this configuration, the transport roller can be prevented from being damaged, so that the life of the transport roller can be made long.

The cutting device further comprises an actuator for moving the transport roller in a direction perpendicular to the transporting direction. In this configuration, the cutter can be made always coincident with one of the grooves. Accordingly, even in the case where the cutter moves to any position in a direction perpendicular to the transporting direction, the portion of the transport roller opposite to the cutter through the recording medium can be perfectly prevented from being damaged.

The grooves may be provided in a guide face of a transport guide for guiding transporting of the recording medium. In this configuration, the guide face of the transport guide can be prevented from being damaged, so that transporting accuracy can be improved.

The cutting device further comprises an actuator for moving a transport guide in a direction perpendicular to the transporting direction. In this configuration, the cutter can be made always coincident with one of the grooves. Accordingly, even in the case where the cutter moves to any position in a direction perpendicular to the transporting direction, the portion of the guide face of the transport guide opposite to the cutter through the recording medium can be perfectly prevented from being damaged.

The cutter is provided so that a portion in which the press roller is not rolling on the recorded portion is cut first and a portion in which the press roller is rolling on the recorded portion is cut second. In this configuration, even in the case where the recorded portion is not fully dried at the point of time of the start of cutting, the recording agent can be prevented from being deposited on the press roller because the press roller is not rolling on the recorded portion when the first cutting operation is carried out. On the other hand, when the second cutting operation is carried out, the press roller is rolling on the recorded portion. At this point of time, the recording agent can be however prevented from being deposited on the press roller because the recorded portion has been already dried.

The portion in which the press roller is not rolling is on the front side of the front end of the recorded portion and on the side of one side end of the recorded portion. The portion in which the press roller is rolling is on the side of the other side end of the recorded portion and on the front side of the rear side end of the recorded portion. In this configuration, the press roller arranged adjacent to the cutter can press the recording medium on the front side of the front end of the recorded portion and on the side of one side end of the recorded portion so as not to roll on the recorded portion.

The cutter may be provided so that a front end, one side end, the other side end and a rear end of the recorded portion are cut in this order. The cutter may be provided so that one side end, a front end, the other side end and a rear end of the recorded portion are cut in this order. In this configuration, the cutting lines of the recording medium can be prevented from being caught in the ejection roller or the like after completion of cutting operation. Accordingly, the recording medium can be ejected smoothly in the transporting direction.

When the cutter runs in a direction perpendicular to the transporting direction while the recording medium is in a standstill state, the cutter cuts the recorded portion of the recording medium in the direction perpendicular to the transporting direction. When the recording medium is transported backward while the cutter is in a standstill state, the cutter cuts the recorded portion in the transporting direction. In this configuration, cutting can be completed if the cutter can move only in a direction perpendicular to the transporting direction. Accordingly, the moving mechanism for the cutter can be simplified. Moreover, because the recording medium can be cut while being pulled backward in the transporting direction, cutting accuracy can be improved.

The cutter includes a first cutting member for cutting the recorded portion in a direction perpendicular to the transporting directions and a second cutting member for cutting the recorded portion in the transporting direction. The first and second cutting members may be provided separately. In this configuration, while one cutting member makes a cutting operation, the other cutting member can make a moving operation. Accordingly, the time required for the cutting process can be shortened.

The first cutting member and the second cutting member may be integrated with each other. In this configuration, the moving mechanism can be simplified. The cutter may include one cutting member which is formed so that the attitude of the cutting member can be changed to the transporting direction and to a direction perpendicular to the transporting direction. In this configuration, cutting can be completed by one cutting edge, so that the cutting edge can be exchanged easily.

According to the invention, there is also provided a method for cutting a recording medium carried out by a cutting device comprising a cutter by which a recorded portion of a recording medium transported and recorded is cut both in a transporting direction and in a direction perpendicular to the transporting direction, and a press roller arranged on a side of the cutter and provided for pressing the recording medium when the recording medium is cut The cutting method comprises steps of: cutting first a portion in which the press roller is not rolling on the recorded portion by the cutter; and then cutting a portion in which the press roller is rolling on the recorded portion by the cutter. In this configuration, even in the case where the recorded portion is not fully dried at the point of time of the start of cutting, the recording agent can be prevented from being deposited on the press roller because the press roller is not rolling on the recorded portion when the first cutting operation is carried out. On the other hand, when the second cutting operation is carried out, the press roller is rolling on the recorded portion. At this point of time, the recording agent can be however prevented from being deposited on the press roller because the recorded portion has been already dried.

A front end, one side end, the other side end and a rear end of the recorded portion may be cut by the cutter in this order. Alternatively, one side end, a front end, the other side end and a rear end of the recorded portion may be cut by the cutter in this order. In this configuration, the cutting lines of the recording medium can be prevented from being caught in the ejection roller or the like after completion of cutting operation. Accordingly, the recording medium can be ejected smoothly in the transporting direction.

The cutter may be provided so that a plurality of images recorded in the transporting direction and in a direction perpendicular to the transporting direction are cut successively in the transporting direction in the order of recording position nearer to one side end of the recording medium and then cut successively in the direction perpendicular to the transporting direction in the order of recording position nearer to the leading end of the recording medium. In this configuration, even in the case where a plurality of images with free sizes are recorded so as to be arranged freely on the recording medium, the respective images can be cut automatically. Accordingly, the conventional user's operation of cutting the rolled sheet can be omitted, so that images high in cutting accuracy can be obtained easily.

The cutter is movable in a direction perpendicular to the transporting direction. When the recording medium is transported backward while the cutter is stopped in a predetermined position in the direction perpendicular to the transporting direction, the cutter cuts the recording medium in the transporting direction. In this configuration, the recording medium can be cut while being pulled. Accordingly, cutting accuracy can be improved.

The cutter is movable in a direction perpendicular to the transporting direction. When the cutter moves in the direction perpendicular to the transporting direction while the recording medium is stopped in a predetermined portion, the cutter cuts the recording medium in the direction perpendicular to the transporting direction. In this configuration, for example, the cutter can be moved in the condition that the cutter is attached to the carriage provided with the recording heads. Accordingly, it is unnecessary to provide any actuator for the cutter individually. The apparatus can be formed compactly while the cost of the apparatus can be reduced.

According to the invention, there is also provided a method for cutting a recording medium carried out by a cutting device comprising a cutter by which a recorded portion of a recording medium transported and recorded is cut both in a transporting direction and in a direction perpendicular to the transporting direction. In the cutting method, a plurality of images recorded in the transporting direction and in the direction perpendicular to the transporting direction are cut successively in the transporting direction in the order of recording position nearer to one side end of the recording medium and then cut successively in the direction perpendicular to the transporting direction in the order of recording position nearer to the leading end of the recording medium. In this configuration, even in the case where a plurality of images with free sizes are recorded so as to be arranged freely on the recording medium, the respective images can be cut automatically. Accordingly, the conventional user's operation of cutting the rolled sheet can be omitted, so that images high in cutting accuracy can be obtained easily.

The cutter may be provided so that a plurality of images recorded in the transporting direction and in a direction perpendicular to the transporting direction are cut individually in accordance with the images. In this configuration, images with free sizes recorded so as to be arranged freely in the size of the recoding recording medium in the direction perpendicular to the transporting direction can be cut individually automatically. Accordingly, both recording efficiency and cutting efficiency can be improved.

A plurality of images recorded so as to be arranged in a direction perpendicular to the transporting direction are cut individually in accordance with the images. In this configuration, even in the case where the size of the recording medium in the direction perpendicular to the transporting direction is large, a plurality of images can be arranged in accordance with the size of the recording medium. Accordingly, efficiency in use of the recording medium can be improved.

A plurality of images recorded without any gap in the transporting direction but recorded with a gap in a direction perpendicular to the transporting direction are cut individually in accordance with the images. In this configuration, good cutting can be obtained if the cutter is formed so that positioning accuracy in the transporting direction is made high. Accordingly, the cutter can be achieved by a simple configuration.

Images arranged in the transporting direction among the plurality of images are recorded so that the sizes of the images in the direction perpendicular to the transporting direction are equalized. These images are cut individually in accordance with the images. In this configuration, the images arranged in the transporting direction can be cut linearly in the transporting direction. Accordingly, cutting efficiency can be improved.

Images arranged in a direction perpendicular to the transporting direction among the plurality of images are recorded so that the sizes of the images in the transporting direction are equalized. These images are cut individually in accordance with the images. In this configuration, the images arranged in the direction perpendicular to the transporting direction can be cut linearly in the direction perpendicular to the transporting direction. Accordingly, cutting efficiency can be improved.

The cutter may be provided so that all the recorded portions of the recording medium are cut in the transporting direction and then cut in the direction perpendicular to the transporting direction. In this configuration, the images can be ejected successively so that the image which has been cut on the leading end of the recording medium is cut first. Accordingly, transporting error can be prevented from being caused by interference between the recording medium and the transporter.

The cutter may be provided so that the recording medium is cut along cutting lines automatically calculated on the basis of input margins around each image. In this configuration, when the user merely inputs desired margins, each image with the margins can be obtained. Accordingly, the labor for cutting the images manually can be omitted.

According to the invention, there is provided a method for cutting a recorded portion of a recording medium transported and recorded is cut both in a transporting direction and in a direction perpendicular to the transporting direction. In the cutting method, data concerning the recording medium, data concerning each image recorded on the recording medium and data concerning margins provided around each image are set. The size of the image in the direction perpendicular to the transporting direction and the size of the margins in the direction perpendicular to the transporting direction are added up. If necessary, the interval of cutting lines in the direction perpendicular to the transporting direction is further added. The size of the recording medium in the direction perpendicular to the transporting direction is compared with the sum obtained in the aforementioned manner. When the size of the recording medium in the direction perpendicular to the transporting direction is larger than the sum, the position of the cutting line is calculated and the recording medium is cut along the cutting line. In this configuration, the user can obtain each image with desired margins. Accordingly, the labor for cutting the images manually can be omitted.

The cutter may be provided so that images automatically arranged in arbitrary positions in the cutting region are cut on the basis of the input cutting sizes. In this configuration, when the user merely inputs desired cutting sizes, images with the cutting sizes can be obtained. Accordingly, the labor for cutting the images manually can be omitted.

Data concerning the recording medium, data concerning each image recorded on the recording medium and data concerning the cutting size of each image are set. The size of the recording medium in the direction perpendicular to the transporting direction is compared with the cutting size in the direction perpendicular to the transporting direction. When the size of the recording medium in the direction perpendicular to the transporting direction is larger than the cutting size in the direction perpendicular to the transporting direction, data concerning margins provided around the image are set. A recording position of the image is calculated and the recording medium is cut on the basis of the recording position. In this configuration, the user can obtain each image of a desired cutting size. Accordingly, the labor for cutting the image manually can be omitted.

Cutting sizes may be input in accordance with the plurality of images. In this configuration, for example, even in the case where a plurality of images are different in size, images equal in cutting size can be obtained.

The images are arranged on the basis of input margins provided around each image. In this configuration, when the user merely inputs desired margins and cutting size, each image of the cutting size with the margins can be obtained.

The margins can be input in accordance with the plurality of images. In this configuration, each image with margins requested by the user in accordance with the image can be obtained.

The margins can be input individually in accordance with four sides of one image. In this configuration, for example, images with binding margins can be provided.

Each margin is defined by the distance between an edge of the image and the cutting line. In this configuration, the user can input margins while assuming the margins specifically.

The distance between the cutting lines of adjacent images is automatically set in accordance with the kind of the recording medium. In this configuration, images can be cut so that a portion between the images is kept rigid. Accordingly, the portion between the images can be prevented from interfering with transporting and recording of the recording medium after cutting.

A unit region is defined as a region in which a plurality of images are regarded. After images contained in the unit region are cut out, the unit region is cut away in the direction perpendicular to the transporting direction. In this configuration, the leading end portion of the recording medium is cut away whenever the set of images are cut out. Accordingly, when a next set of images are recorded, there is no large hole in the leading end portion of the recording medium. The recording medium can be sucked and transported reliably, so that recording accuracy can be kept high.

The cutter is movable in a direction perpendicular to the transporting direction. When the recording medium is transported backward while the cutter is stopped in a predetermined position in the direction perpendicular to the transporting direction, the cutter cuts the recording medium in the transporting direction. In this configuration, the recording medium can be cut while being pulled. Accordingly, cutting accuracy can be improved.

The cutter is movable in a direction perpendicular to the transporting direction. When the cutter moves in the direction perpendicular to the transporting direction while the recording medium is stopped in a predetermined position, the cutter cuts the recording medium in the direction perpendicular to the transporting direction. In this configuration, for example, the cutter can be moved in the condition that the cutter is attached to the carriage for carrying the recording heads. Accordingly, it is unnecessary to provide any actuator for the cutter individually. Accordingly, the apparatus can be made compact while the cost of the apparatus can be reduced.

### BRIEF DESCRIPTION OF THE DRAWINGS

FIG. 1 is a perspective view showing a configuration example of an ink jet printer which is a recording apparatus incorporating a recoding recording medium cutting device of the invention;

FIG. 2 is a perspective view showing an example of internal configuration of an essential part of the printer of FIG. 1;

FIG. 3 is a sectional view of essential part of the printer of FIG. 1;

FIG. 4 is a perspective view showing the details of the cutting device according to a first embodiment of the invention;

FIG. 5 is a view showing a first example of a cutting method of the invention executed by the cutting device of FIG. 4;

FIG. 6 is a perspective view showing the details of the cutting device according to a second embodiment of the invention;

FIG. 7 is a perspective view showing the details of the cutting device according to a third embodiment of the invention;

FIG. 8 is a perspective view showing the details of the cutting device according to a fourth embodiment of the invention;

FIGS. 9 to 16 are views showing a procedure for using the printer of FIG. 1;

FIG. 17 is a perspective view showing the details of the cutting device according to a fifth embodiment of the invention;

FIGS. 18 to 20 are views showing a procedure for using a printer incorporating the cutting device of FIG. 17;

FIG. 21 is a perspective view showing the details of the cutting device according to a sixth embodiment of the invention;

FIGS. 22 to 24 are views showing a procedure for using a printer provided incorporating the cutting device of FIG. 21;

FIG. 25 is a sectional view of an essential part of a printer incorporating a cutting device according to a seventh embodiment of the invention;

FIG. 26 is a perspective view showing the details of a part of a transport roller in the printer of FIG. 25;

FIG. 27 is a perspective view showing the details of a transport guide in the printer of FIG. 25;

FIG. 28 is a view showing the positional relations among the transport roller, grooves of the transport guide and the cutter of FIGS. 26 and 27;

FIGS. 29 to 31 are views showing a procedure of use of the printer incorporating the cutting device of FIG. 25;

FIG. 32 is a perspective view showing an ejection roller driving mechanism and its vicinity in the printer of FIG. 1;

FIGS. 33 and 34 are plan views showing the ejection roller driving mechanism and its vicinity of FIG. 32;

FIG. 35 is a perspective view showing a first modified example of the ejection roller driving mechanism and its vicinity in the printer of FIG. 1;

FIG. 36 is a plan view showing the ejection roller driving mechanism and its vicinity of FIG. 35;

FIG. 37 is a perspective view showing a second modified example of the ejection roller driving mechanism and its vicinity in the printer of FIG. 1;

FIG. 38 is a plan view showing the ejection roller driving mechanism and its vicinity of FIG. 37;

FIG. 39 is a perspective view showing the essential part of the cutting device according to any one of the embodiments;

FIGS. 40A and 40B are views showing a second example of a cutting method of the invention carried out by the cutting device of FIG. 39;

FIGS. 41A to 41C are views showing examples of images to be cut by the cutting device of FIG. 39;

FIG. 42 is a view for explaining a third example of a cutting method of the invention carried out by the cutting device of FIG. 39;

FIG. 43 is a flow chart for explaining the cutting operation of FIG. 42;

FIGS. 44A and 44B are views for explaining a fourth example of a cutting method of the invention carried out by the cutting device of FIG. 39;

FIG. 45 is a flow chart for explaining the cutting operation of FIGS. 44A and 44B;

FIGS. 46A to 46C are views showing a fifth example of a cutting method of the invention carried out by the cutting device of FIG. 39; and

FIGS. 47A and 47B are views showing a sixth example of a cutting method of the invention carried out by the cutting device of FIG. 39.

### DETAILED DESCRIPTION OF THE INVENTION

Embodiment of the present invention will be described below in detail with reference to the drawings.

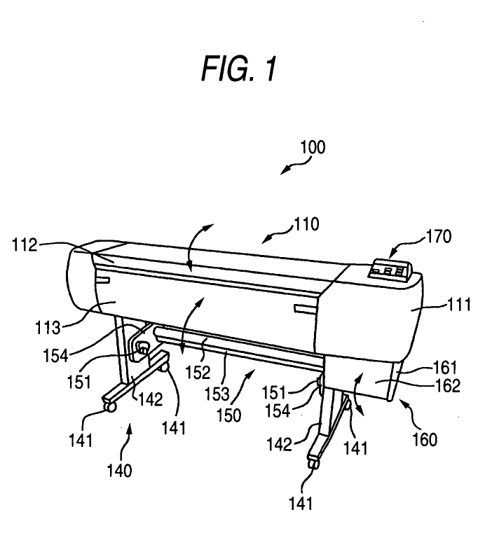

An ink jet printer 100 shown in FIGS. 1 to 3 is a large-size printer which can record an image on a rolled sheet having a relatively large width such as A1-size sheet or B1-size sheet according to Japanese Industrial Standards (JIS). The ink jet printer 100 includes a body section 110, a recording section 120, a sheet ejecting section 130, leg sections 140, and a sheet feeding section 150. The recording section 120, the sheet ejecting section 130 and a cutting device 200 are disposed in the body section 110 of the ink jet printer 100. The sheet feeding section 150 is disposed between the leg sections 140 which support the body section 110.

As shown in FIGS. 1 to 3, the body section 110 includes a housing 111 which is made of a plastic or metal plate and with which the recording section 120 and the sheet ejecting section 130 are covered. As shown in FIGS. 1 to 3, the housing 111 is provided with upper and front covers 112 and 113 which are made of semitransparent or transparent plastic or metal plates respectively and which are provided so that upper and front parts of the housing 11 can be opened.

As shown in FIGS. 1 to 3, the upper cover 112 is pivoted on its rear portion so that the upper cover 112 can be opened or dosed when a user pushes up or down the upper cover 112 while gripping a front portion of the upper cover 112. Because the recording section 120 and the sheet ejecting section 130 can be made open upward largely when the upper cover 112 is opened by the user, the maintenance of recording heads 121, a carriage 122, etc. and the removal of sheet transporting error such as a sheet jam during recording or sheet ejection can be made easily.

As shown in FIGS. 1 to 3, the front cover 113 is pivoted on its lower portion so that the front cover 113 can be opened or dosed when the user pushed down or up the front cover 113 while gripping an upper portion of the front cover 113. Because the lower parts of the recording section 120 and the sheet ejecting section 130 can be made open largely when the front cover 113 is opened by the user, the removal of sheet transporting error such as a sheet jam during sheet feeding can be made easily.

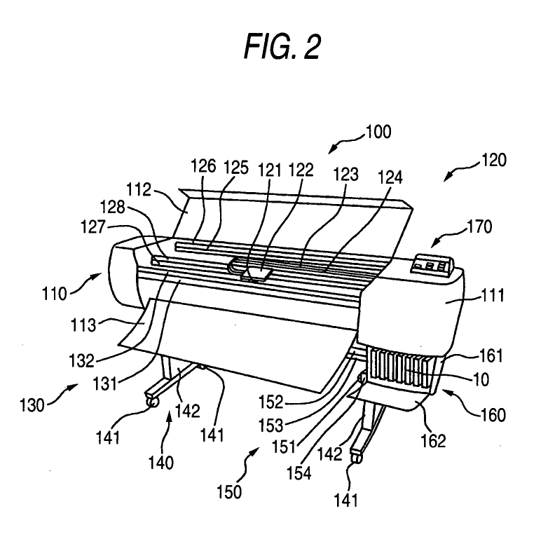

As shown in FIGS. 1 and 2, an ink cartridge holder 160 is disposed in the lower right section of the body section 110 when viewed from the front. The ink cartridge holder 160 has a holder body 161 for receiving and holding respective color ink cartridges 10, and a cover 162 with which the front of the holder body 161 is covered. The cover 162 is pivoted on its lower portion so that the cover 162 can pivot relative to the holder body 161. That is, the cover 162 can be opened or closed when the user pushes down or up the cover 162 while gripping an upper portion of the cover 162. Because the holder body 161 can be made open largely when the cover 162 is opened by the user, the ink cartridges 10 can be replaced easily.

As shown in FIGS. 1 and 2, a control panel 170 operated by the user for recording control etc. is disposed in the upper right section of the body section 110 when viewed from the front. A liquid crystal display and various kinds of buttons are disposed in the control panel 170 so that the user can operate the buttons while watching the liquid crystal display for confirmation. Because the user can operate the buttons reliably on the basis of visibility, operation errors, operating mistakes, etc. can be eliminated.

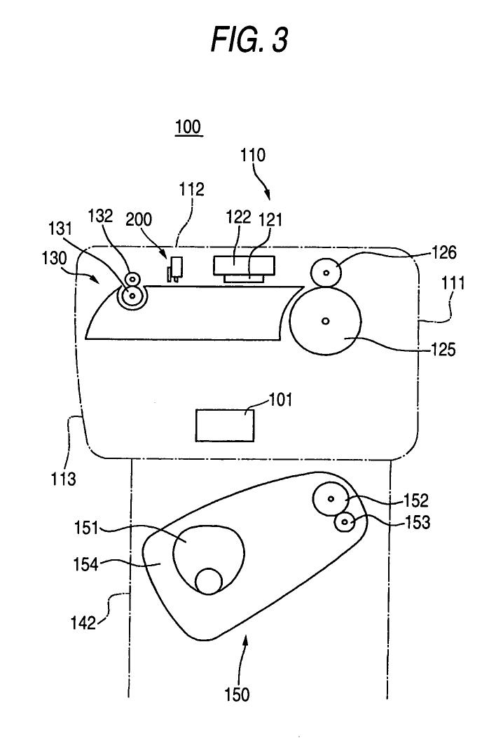

As shown in FIGS. 2 and 3, the recording section 120 comprises: a carriage 122 which carries recording heads 121; a flexible flat cable (hereinafter referred to as FFC) 123 which electrically connects the recording heads 121 to a controller 101 for executing recording; ink tubes 124 which connect the recording heads 121 to the ink cartridges 10 each containing ink; a feeding roller 125 which transports the rolled sheet; a follower roller 126 which is driven by the feeding roller 125; and a not-shown sheet suction unit for preventing the transported rolled sheet from being floated up.

The recording heads 121 include a black ink recording head for jetting black ink, and a plurality of color ink recording heads for jetting various colors of ink such as dark yellow, yellow, light cyan, cyan, light magenta, magenta, etc. Pressure generating chambers and nozzle orifices respectively communicated with the pressure generating chambers are provided in the recording heads 121. When each pressure generating chamber is pressurized with a predetermined value in the condition that ink is reserved in the pressure generating chamber, an ink drop having a controlled size is jetted from a corresponding nozzle orifice toward the rolled sheet R.

As shown in FIG. 2, the carriage 122 is placed on a rail 127 through bearings and connected to a carriage belt 128. The rail 127 is provided in a primary scanning direction. When the carriage belt 128 is operated by a carriage actuator not shown, the carriage 122 makes a reciprocating motion while guided by the rail 127 in accordance with the movement of the carriage belt 128. The FFC 123 has one end connected to a connector of the controller 101, and the other end connected to a connector of the recording heads 121 so that a recording signal can be sent from the controller 101 to the recording heads 121.

The ink tubes 124 are provided for the various colors of ink. Each ink tube 124 has one end connected to a corresponding color ink cartridge 10 by way of a compressor not shown, and the other end connected to a corresponding color recording head 121. Each ink tube 124 is provided so that a corresponding color of ink pressurized by the compressor is fed from a corresponding ink cartridge 10 to a corresponding recording head 121.

The feeding roller 125 is driven to rotate forward and backward by driving force transmitted from a motor not shown. The follower roller 126 is pressed against the feeding roller 125 by an urging member such as a spring. The follower roller 126 follows the feeding roller 125 so that the follower roller 126 can rotate forward/backward with the forward/backward rotation of the feeding roller 125. The feeding roller 125 and the follower roller 126 feed the supplied rolled sheet while the rolled sheet is held between the feeding roller 125 and the follower roller 126.

As shown in FIGS. 2 and 3, the sheet ejecting section 130 has a ejection roller 131, and a follower roller 132. The ejection roller 131 and the follower roller 132 transport the rolled sheet in the primary scanning direction to eject the roller of sheet. The ejection roller 131 is driven to rotate forward and backward by driving force transmitted from a motor through the feeding roller 125. The follower roller 132 is pressed against the ejection roller 131 by an urging member such as a spring. The follower roller 132 follows the ejection roller 131 so that the follower roller 132 can rotate forward with the forward rotation of the ejection roller 131. The ejection roller 131 and the follower roller 132 feed the rolled sheet while the roller of sheet transported is held between the ejection roller 131 and the follower roller 132.

As shown in FIG. 3, the cutting device 200 is disposed so as to be movable both in a vertical direction and in the primary scanning direction. The cutting device 200 is configured so that a recorded portion of the rolled sheet is cut in the primary and secondary scanning directions, and that the rolled sheet is retained while the cutting operation is performed.

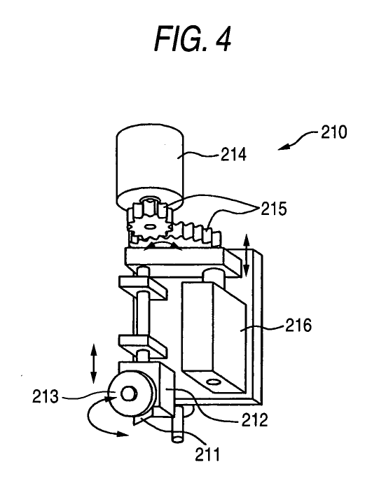

A first embodiment of the cutting device 200 configured as described above will be described in detail with reference to FIG. 4.

A cutting device 210 includes a single-edged cutter 211, a holder 212, and a press roller 213. The cutter 211 is provided for cutting the recorded portion of the rolled sheet in the primary and secondary scanning directions. The cutter 211 is attached to a lower end of the holder 212. The press roller 213 is attached to the holder 212 so as to be arranged on a side of the cutter 211. The press roller 213 retains the rolled sheet while the rolled sheet is cut in the primary and secondary scanning directions.

The cutting device 210 further includes a motor 214 and a gear mechanism 215 serving us a selective driver, and a solenoid coil 216 serving as an actuator. The motor 214 and the gear mechanism 215 rotate the holder 212 by 90 degrees together with the cutter 211 and the press roller 213. The solenoid coil 216 moves the holder 212 vertically together with the cutter 211, the press roller 213, the motor 214 and the gear mechanism 215. The motor 214 and the gear mechanism 215 are provided so that the directions of the cutter 211 and the press roller 213 can be integrally changed to select the cutting direction such as the primary scanning direction or the secondary scanning direction.

For example, the solenoid coil 216 serves to move the holder 212 vertically together with the cutter 211, the press roller 213, the motor 214 and the gear mechanism 215 may be replaced by an air cylinder, an oil pressure cylinder or a combination of a motor and a gear or pulley mechanism. For example, a combination of a motor and a pulley mechanism may be used to move the cutter 211, the holder 212, the press roller 213, the motor 214 and the gear mechanism 215 in the primary scanning direction. Alternatively, the device may be directly attached to the carriage 122.

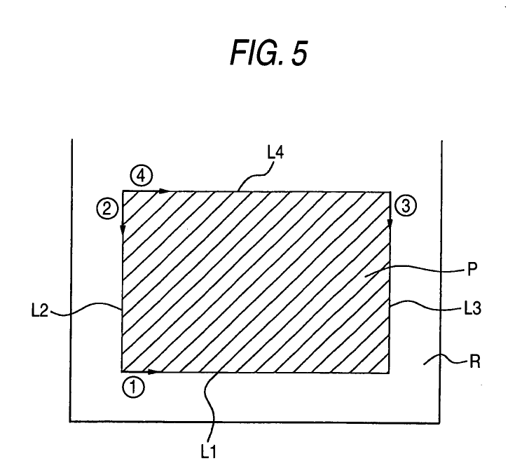

A method of cutting the rolled sheet R by the cutting device 210 configured as described above will be described with reference to FIG. 5.

This method for cutting the recorded portion P of the rolled sheet R into a required size comprises steps of; cutting a portion in which the press roller 213 is not rolling on the recorded portion P; and cutting a portion in which the press roller 213 is rolling on the recorded portion P.

That is, the cutter 211 first moves in the primary scanning direction and cuts a front side \mathring{1} of the recorded portion P relative to the transporting direction of the rolled sheet R. On this occasion, the press roller 213 is rolling in the front side of a cutting line L1 of the cutter 211 so that the press roller 213 does not interfere with the recorded portion P. Accordingly, even in the case where the recorded portion P is not fully dried, the rolled sheet R can be prevented from being contaminated with ink. Although FIG. 5 shows the case where the cutter 211 cuts the front side \mathring{1} while moving rightward, the cutter 211 may cut the front side \mathring{1} while moving leftward.

Then, the cutter 211 cuts a left side \mathring{2} of the recorded portion P while the rolled sheet R is transported backward. On this occasion, the press roller 213 is rolling in the left side of a cutting line L2 of the cutter 211 so that the press roller 213 does not interfere with the recorded portion P. Accordingly, even in the case where the recorded portion P is not fully dried, the rolled sheet R can be prevented from being contaminated with ink. Although FIG. 5 shows the case where the cutter 211 cuts the left side \mathring{2} from the rear end to the front end, the cutter 211 may cut the left side \mathring{2} from the front end to the rear end while the rolled sheet R is transported forward.

Then, the cutter 211 cuts a right side \mathring{3} of the recorded portion P while the rolled sheet R is transported backward. On this occasion, the press roller 213 is rolling in the left of a cutting line L3 of the cutter 211 so that the press roller 213 interferes with the recorded portion P. At this point of time, the rolled sheet R can be however prevented from being contaminated with ink because the recorded portion P has been already dried. Although FIG. 5 shows the case where the cutter 211 cuts the right side \mathring{3} from the rear end to the front end, the cutter 211 may cut the right side \mathring{3} from the front end to the rear end while the rolled sheet R is transported forward.

Finally, the cutter 211 moves in the primary scanning direction and cuts a rear side \mathring{4} of the recorded portion P. On this occasion, the press roller 213 is rolling in front of a cutting line L4 of the cutter 211 so that the press roller 213 interferes with the recorded portion P. At this point of time, the rolled sheet R can be however prevented from being contaminated with ink because the recorded portion P has been already dried. Although FIG. 5 shows the case where the cutter 211 cuts the rear side \mathring{4} while moving rightward, the cutter 211 may cut the rear side \mathring{4} while moving leftward. According to the aforementioned method, wasteful standby time for waiting for drying of ink to start cutting can be dispensed with.

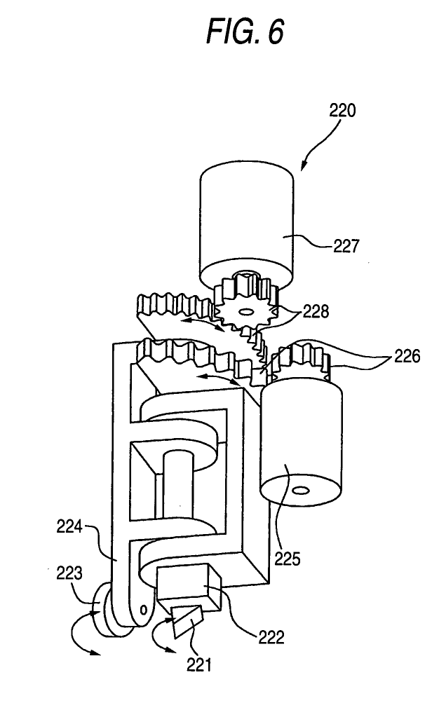

FIG. 6 shows the details of a second embodiment of the cutting device 200. A cutting device 220 includes a single-edged cutter 221, a holder 222, a press roller 223, and a holder 224. The cutter 221 cuts the recorded portion P of the rolled sheet in the primary and secondary scanning directions. The cutter 221 is attached to a lower end of the holder 222. The press roller 223 retains the rolled sheet while the rolled sheet is cut in the primary and secondary scanning directions. The press roller 223 is attached to the holder 224 so that the press roller 223 is arranged on a side of the cutter 221.

The cutting device 220 further includes a motor 225, a gear mechanism 226, a motor 227, a gear mechanism 228, and a solenoid coil not shown. The motor 225 and the gear mechanism 226 rotate the holder 222 by 90 degrees together with the cutter 221. The motor 227 and the gear mechanism 228 rotate the holder 224 by 90 degrees together with the press roller 223. The solenoid coil moves the holders 222 and 224 vertically together with the cutter 221, the press roller 223, the motors 225 and 227 and the gear mechanisms 226 and 228. The motors 225 and 227 and the gear mechanisms 226 and 228 are provided so that the directions of the cutter 221 and the press roller 223 can be changed individually in accordance with the cutting direction such as the primary scanning direction or the secondary scanning direction.

For example, the solenoid coil provided as the actuator for moving the holders 222 and 224 vertically together with the cutter 221, the press roller 223, the motors 225 and 227 and the gear mechanisms 226 and 228 may be replaced by an air cylinder, an oil pressure cylinder or a combination of a motor and a gear or pulley mechanism. For example, a combination of a motor and a pulley mechanism may be used to move the cutter 221, the holders 222 and 224, the press roller 223, the motors 225 and 227 and the gear mechanisms 226 and 228 in the primary scanning direction. The device may be directly attached to the carriage 122.

The method of cutting the rolled sheet R as shown in FIG. 5 can be applied to the cutting device 220 configured as described above. According to this cutting method, the press roller 223 is not rolling on the recorded portion P when the front side \mathring{1} and the left side \mathring{2} of the recorded portion P are cut. Accordingly, even in the case where the recorded portion P is not fully dried at the point of time of the start of cutting, ink is not deposited on the press roller 223 so that the rolled sheet R can be prevented from being contaminated with ink. On the other hand, the press roller 223 is rolling on the recorded portion P when the right side \mathring{3} and the rear side \mathring{4} of the recorded portion P are cut. At this point of time, the recorded portion P has been however already dried. Accordingly, ink is not deposited on the press roller 223 so that the rolled sheet R can be prevented from being contaminated with ink.

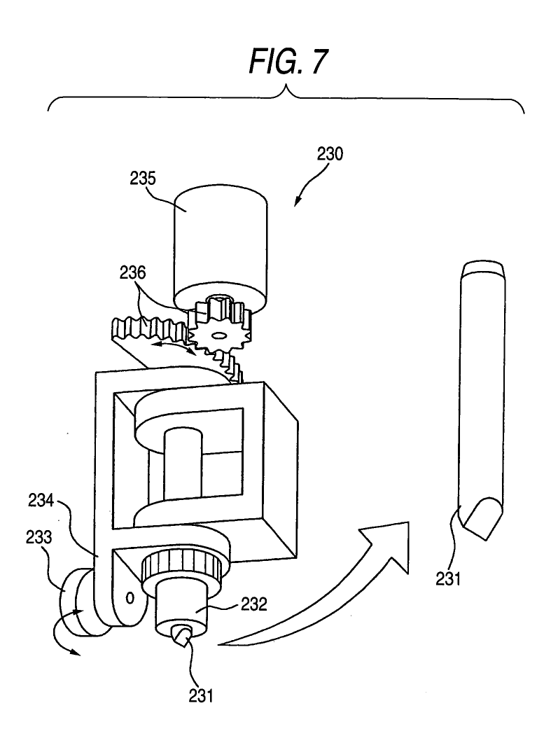

FIG. 7 shows the details of a third embodiment of the cutting device 200. A cutting device 230 includes a rounded rod-shaped cutter 231, a holder 232, a press roller 233, and a holder 234. The cutter 231 cuts the recorded portion P of the rolled sheet in the primary and secondary scanning directions. The cutter 231 is attached to a lower end of the holder 232. The press roller 233 retains the rolled sheet while the rolled sheet is cut in the primary and secondary scanning directions. The press roller 233 is attached to the holder 234 so as to be arranged on a side of the cutter 231. The round rod-shaped cutter 231 is a well-known cutter in which the direction of the cutter 231 can be changed automatically in accordance with the direction of movement of the cutter 231 relative to the rolled sheet R.

The cutting device 230 further includes a motor 235, a gear mechanism 236, and a solenoid coil not shown. The motor 235 and the gear mechanism 236 rotate the holder 234 by 90 degrees together with the press roller 233. The solenoid coil moves the holders 232 and 234 vertically together with the cutter 231, the press roller 233, the motor 235 and the gear mechanism 236. The motor 235 and the gear mechanism 236 are provided so that the direction of the press roller 233 can be changed in accordance with the cutting direction such as the primary scanning direction or the secondary scanning direction.

For example, the solenoid coil provided as the actuator for moving the holders 232 and 234 vertically together with the cutter 231, the press roller 233, the motor 235 and the gear mechanism 236 may be replaced by an air cylinder, an oil pressure cylinder or a combination of a motor and a gear or pulley mechanism. For example, a combination of a motor and a pulley mechanism may be used to move the cutter 231, the holders 232 and 234, the press roller 233, the motor 235 and the gear mechanism 236 in the primary scanning direction. The device may be directly attached to the carriage 122.

The method of cutting the rolled sheet R as shown in FIG. 5 can be applied to the cutting device 230 configured as described above. According to this cutting method, the press roller 233 is not rolling on the recorded portion P when the front side \mathring{1} and the left side \mathring{2} of the recorded portion P are cut. Accordingly, even in the case where the recorded portion P is not fully dried at the point of time of the start of cutting, ink is not deposited on the press roller 233 so that the rolled sheet R can be prevented from being contaminated with ink. On the other hand, the press roller 233 is rolling on the recorded portion P when the right side \mathring{3} and the rear side \mathring{4} of the recorded portion P are cut. At this point of time, the recorded portion P has been however already dried. Accordingly, ink is not deposited on the press roller 233 so that the rolled sheet R can be prevented from being contaminated with ink.

Incidentally, any one of a single-edged cutter, a double-edged cutter and a round rod-shaped cutter may be used as each of the cutters 211, 221 and 231 in the cutting devices 210, 220 and 230. When these cutters are selected suitably and the gear mechanisms 215, 226, 228 and 236 are configured so that the cutters can rotate by 90 degrees or more, the press rollers 213, 223 and 233 can be set so that the press rollers 213, 223 and 233 are not rolling on the recorded portion P even in the case where any one of the front side \mathring{1}, the left side \mathring{2}, the right side \mathring{3} and the rear side \mathring{4} of the recorded portion P shown in FIG. 5 is cut. As a result, ink is not deposited on the press rollers 213, 223 and 233 so that the rolled sheet R can be prevented from being contaminated with ink.

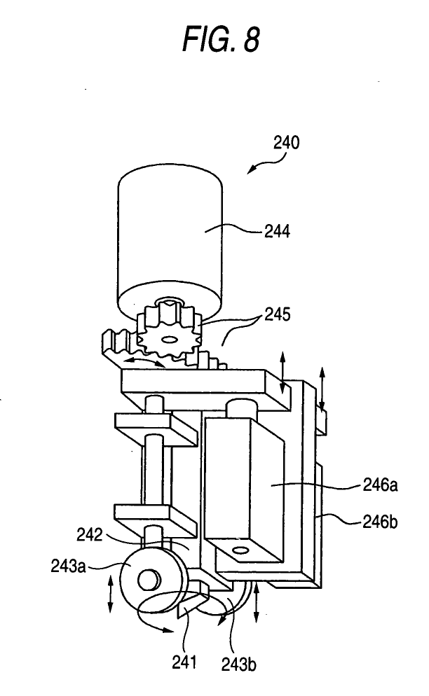

FIG. 8 shows the details of a fourth embodiment of the cutting device 200. A cutting device 240 includes a single-edged cutter 241, a holder 242, and a pair of press rollers 243a and 243b. The cutter 241 cuts the recorded portion P of the rolled sheet in the primary and secondary scanning directions. The cutter 241 is attached to a lower end of the holder 242. The press rollers 243a and 243b are disposed on opposite sides of the cutter 241 so that the press rollers 243a and 243b can move vertically and individually. The press rollers 243a and 243b retain the rolled sheet while the rolled sheet is cut in the primary and secondary scanning directions.

The cutting device 240 further includes a motor 244, a gear mechanism 245, a pair of solenoid coils 246a and 246b, and a solenoid coil not shown. The motor 244 and the gear mechanism 245 rotate the holder 242 by 90 degrees together with the cutter 241 and the press rollers 243a and 243b. The solenoid coils 246a and 246b move the press rollers 243a and 243b vertically and individually. The solenoid coil not shown moves the holder 242 vertically together with the cutter 241, the press rollers 243a and 243b, the motor 244, the gear mechanism 245 and the solenoid coils 246a and 246b. The motor 244 and the gear mechanism 245 are provided so that the directions of the cutter 241 and the press rollers 243a and 243b can be integrally changed in accordance with the cutting direction such as the primary scanning direction or the secondary scanning direction. The solenoid coils 246a and 246b are provided so that the press rollers 243a and 243b can be moved individually in accordance with the cutting direction such as the primary scanning direction or the secondary scanning direction.

For example, each solenoid coil provided as the actuator for moving the press rollers 243a and 243b vertically and individually or as the actuator for moving the holder 242 vertically together with the cutter 241, the press rollers 243a and 243b, the motor 244, the gear mechanism 245 and the solenoid coils 246a and 246b may be replaced by an air cylinder, an oil pressure cylinder or a combination of a motor and a gear or pulley mechanism. For example, a combination of a motor and a pulley mechanism may be used to move the cutter 241, the holder 242, the press rollers 243a and 243b, the motor 244, the gear mechanism 245 and the solenoid coils 246a and 246b in the primary scanning direction. The device may be directly attached to the carriage 122.

When the cutting device 240 configured as described above is used, the press rollers 243a and 243b can be set without any particular change of the cutter 241 and the gear mechanism 245 so that the press rollers 243a and 243b are not rolling on the recorded portion P even in the case where any one of the front side \mathring{1}, the left side \mathring{2}, the right side \mathring{3} and the rear side \mathring{4}of the recorded portion P shown in FIG. 5 is cut. As a result, ink is not deposited on the press rollers 243a and 243b so that the rolled sheet R can be prevented from being more contaminated with ink.

As shown in FIGS. 1 and 2, the leg sections 140 have two props 142 provided with moving rollers 141. The body section 110 is placed on the props 142 and screwed to upper portions of the props 142. Because the props 142 are provided with the moving rollers 141, the body section 110 which is heavy can be moved to a desired position smoothly.

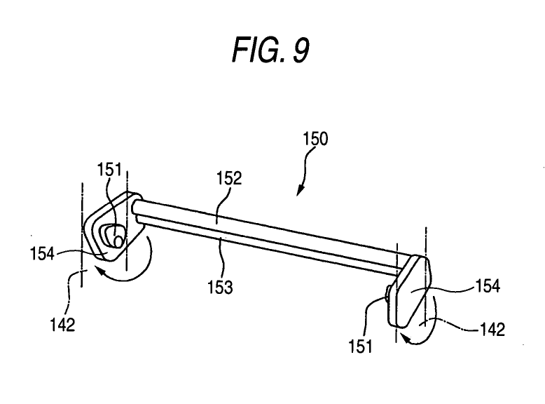

As shown in FIGS. 1 and 3, the sheet feeding section 150 is disposed under the body section 110 and between the leg sections 140. The sheet feeding section 150 includes a pair of supports 151, a delivery roller 152, and a pinch roller 153. The supports 151 support opposite ends of the rolled sheet R. The delivery roller 152 and the pinch roller 153 feed the rolled sheet R. The sheet feeding section 150 further includes a pair of arms 154 to which the supports 151 are fixed and on which respective opposite ends of the delivery roller 152 and the pinch roller 153 are supported. The sheet feeding section 150 configured as described above will be described below more in detail with reference to FIG. 9.

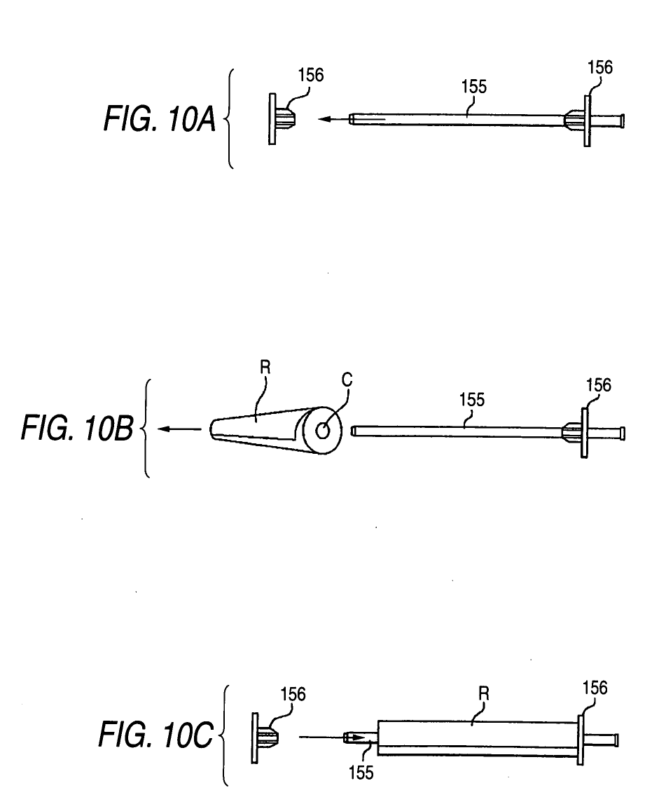

The pair of supports 151 are fixed and mounted onto opposed faces of the pair of arms 154 disposed opposite to each other, respectively. The pair of supports 151 have built-in bearings. As shown in FIGS. 10A to 10C, a spindle 155 is inserted into an inner circumferential portion of the rolled sheet R for supporting the same. Opposite ends of the spindle 155 are rotatably supported by the bearings.

That is, the spindle 155 is laid between the pair of supports 151 in the condition that a pair of flange-shaped clamps 156 are fitted to opposite sides of the rolled sheet R put in the center of the spindle 155. When a user lifts the rolled sheet provided with the spindle 155 and fits the opposite ends of the spindle 155 to the pair of supports 151, mounting of the rolled sheet can be completed. Accordingly, the number of steps for setting the rolled sheet can be reduced greatly.

The delivery roller 152 and the pinch roller 153 are supported to opposed faces of the pair of arms 154 respectively so that the delivery roller 152 and the pinch roller 153 can rotate in the condition that both ends of each of the delivery roller 152 and the pinch roller 153 are disposed opposite to each other. That is, the delivery roller 152 and the pinch roller 153 are disposed so as to be laid between the pair of arms 154. The two ends of the delivery roller 152 are supported at predetermined points of the opposed faces of the pair of arms 154. On the other hand, the two ends of the pinch roller 153 are supported movably, for example, in grooves provided in the opposed faces of the pair of arms 154 so that the pinch roller 153 is retractably brought into contact with the delivery roller 152. The pinch roller 153 is locked in the contact position or the retracted position of the pinch roller 153 relative to the delivery roller 152, for example, by a locking mechanism using a stopper and urging members provided in the opposed faces of the arms 154.

Because the user can easily pull out a leading end portion of the rolled sheet R by the built-in bearings of the supports 151 and can easily insert and hold the leading end portion of the rolled sheet R between the delivery roller 152 and the pinch roller 153 by the moving mechanism of the pinch roller 153, the number of steps for setting the rolled sheet R can be reduced greatly.

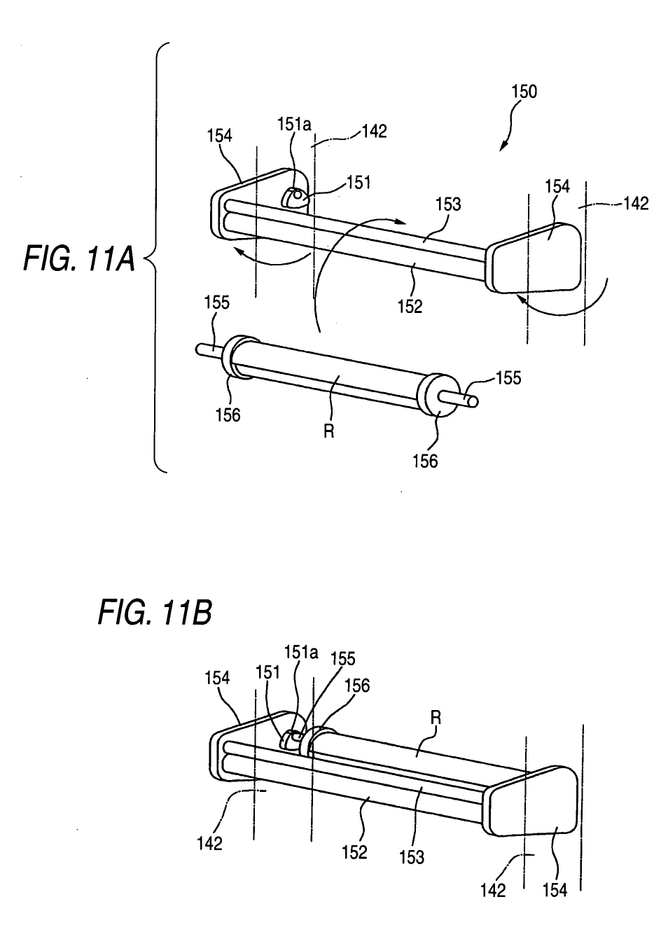

The pair of arms 154 are attached to opposed faces of the two props 142 of the leg sections 140 respectively so that the pair of arms 154 can rotate in directions of the arrows shown in FIG. 9. The rotation of the pair of arms 154 is locked and positioned in the replacement position shown in FIGS. 11A and 11B and in the feeding position shown in FIG. 9, by a locking mechanism using a stopper and urging members provided in the opposed faces of the props 142, for example.

That is, the delivery roller 152 and the pinch roller 153 are provided so that the delivery roller 152 and the pinch roller 153 are protruded to the front of the ink jet printer 100 when the pair of arms 154 are rotated to the replacement position, and that the delivery roller 152 and the pinch roller 153 are pulled into the rear of the ink jet printer 100 so as to be connected to the transporting path of the rolled sheet R when the pair of arms 154 are rotated to the feeding position.

Because the user can operate in an ordinary place on the front side of the ink jet printer 100 without necessity of going to the rear side of the ink jet printer 100 when the leading end portion of the rolled sheet R needs to be inserted and held between the delivery roller 152 and the pinch roller 153, the number of steps for setting the rolled sheet R can be reduced greatly.

Although the aforementioned embodiment has shown the case where the pair of supports 151 are respectively fixed and mounted to the opposed faces of the pair of arms 154 disposed opposite to each other so that the supports 151 can rotate together with the arms 154, the same effect as described above can be obtained also in the case where the pair of supports 151 are fixed and mounted coaxially to rotation shafts of the arms 154 provided on the opposed faces of the two props 142 of the leg sections 140. That is, the supports 151 may be provided as supports always fixed to predetermined positions regardless of the rotation of the arms 154.

In this configuration, a procedure for using the ink jet printer 100 provided with the cutting device 210 according to the first embodiment will be described with reference to FIGS. 10A to 16. First, as shown in FIG. 10A, the user pulls one of the pair of clamps 156 fitted onto the spindle 155 out of one end of the spindle 155. Then, as shown in FIG. 10B, the user inserts the end of the spindle 155 into an axial hole C of the rolled sheet R through one end of the axial hole C.

Then, as shown in FIG. 10C, the user fits one end of the axial hole C of the rolled sheet R to the other clamp 156 fitted onto the other end of the spindle 155 so that the rolled sheet R abuts on the other clamp 156. Then, the user fits one clamp 156 to the other end of the axial hole C of the rolled sheet R through one end of the spindle 155. As a result, the rolled sheet R can rotate together with the spindle 155.

Then, for example, the user pulls the delivery roller 152 forward and pivots the arms 154 from the feeding position shown in FIG. 9 to the replacement position shown in FIG. 11A. Then, the user lifts up the rolled sheet R provided with the spindle 155 from the supports 151 and fits the two end portions of the spindle 155 into grooves 151a of the supports 151 respectively as shown in FIG. 11B. When the two ends of the spindle 155 are fitted to the pair of supports 151 respectively in this manner, mounting of the rolled sheet can be completed. Accordingly, the number of steps for setting the rolled sheet R can be reduced greatly.

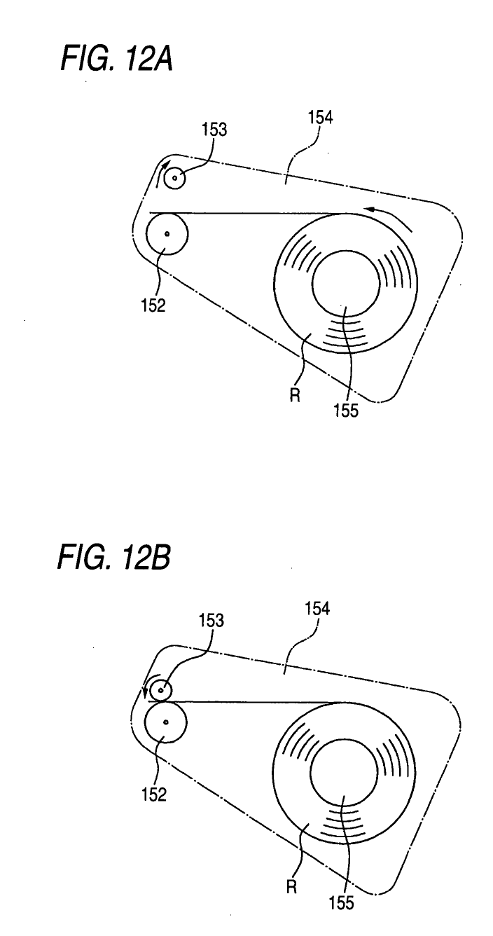

Then, as shown in FIG. 12A, the user lifts the pinch roller 153 and locks the pinch roller 153 in the condition that the pinch roller 153 is retracted from the delivery roller 152. Then, the user pulls the leading end portion of the rolled sheet R forward and inserts the leading end portion of the rolled sheet R between the pinch roller 153 and the delivery roller 152. Then, as shown in FIG. 12B, the user pushes down the pinch roller 153 and locks the pinch roller 153 in the contact position with respect to the delivery roller 152. As a result, the leading end portion of the rolled sheet R is held between the pinch roller 153 and the delivery roller 152. Because the user can operate in an ordinary place on the front side of the ink jet printer 100 in this manner so that the leading end portion of the rolled sheet R is pulled out and held between the delivery roller 152 and the pinch roller 153, the number of steps for setting the rolled sheet R can be reduced greatly.

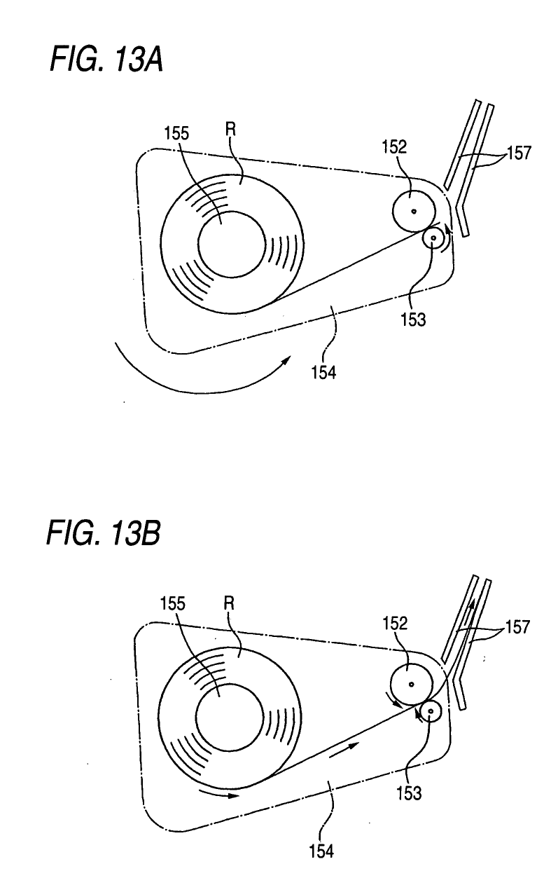

Then, for example, as shown in FIG. 13A, the user pushes the delivery roller 152 backward and pivots the arms 154 from the replacement position to the feeding position. As a result, the leading end portion of the rolled sheet R held between the pinch roller 153 and the delivery roller 152 is aligned with the inlet of a feeding guide 157.

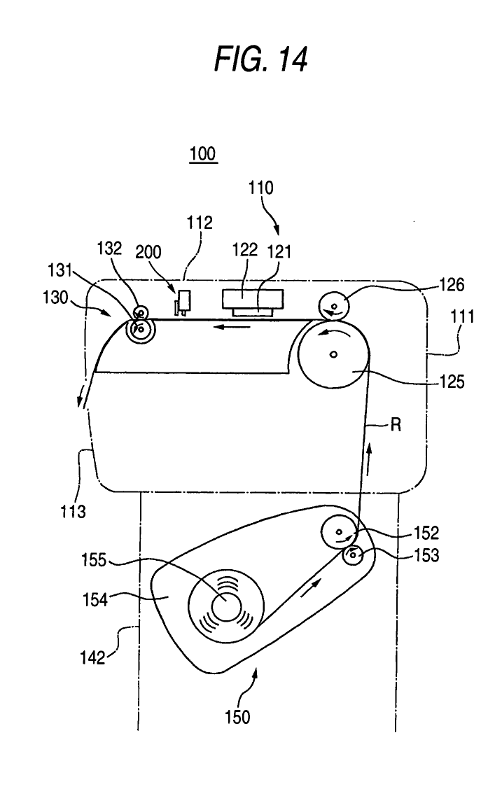

When the user operates the control panel 170 to activate the ink jet printer 100 on this occasion, the delivery roller 152 begins to rotate as shown in FIG. 13B. As a result, the rolled sheet R held between the pinch roller 153 and the delivery roller 152 is guided by the feeding guide 157 and fed to the recording section 120 located above the sheet feeding section 150. Then, as shown in FIG. 14, the rolled sheet R is transported in the secondary scanning direction while the rolled sheet R is held between the feeding roller 125 and the follower roller 126 and held between the ejection roller 131 and the follower roller 132. In this condition, ink drops are jetted from the recording heads 121 moving in the primary scanning direction, so that predetermined information is recorded on the rolled sheet R.

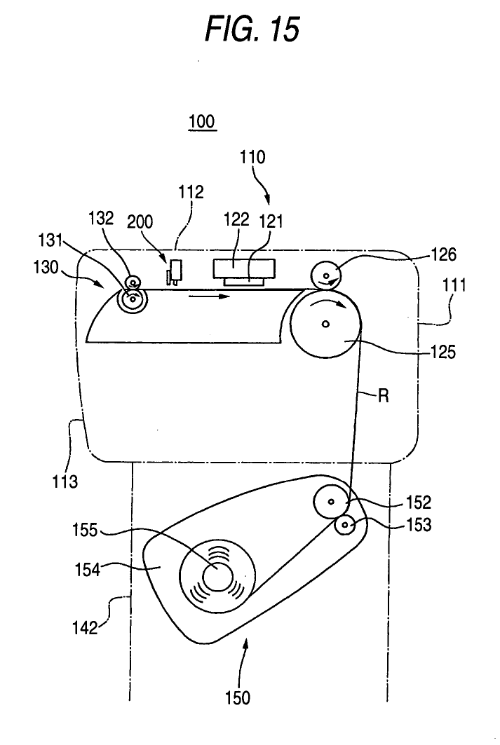

After the completion of the recording, as shown in FIG. 15, the rolled sheet R is transported backward by the backward rotation of the feeding roller 125 and the ejection roller 131 and stopped in a position where the front left corner of the recorded portion P coincides with the cutter 211. Then, the cutter 211 is moved in the primary scanning direction to thereby cut the front end of the recorded portion P. On this occasion, the press roller 213 is rolling in the front side of the cutting line of the cutter 211 so as not to interfere with the recorded portion P. Accordingly, even in the case where the recorded portion is not fully dried, the rolled sheet R can be prevented from being contaminated with ink.

Then, the rolled sheet R is transported by the rotation of the feeding roller 125 and the ejection roller 131 and stopped in a position where the rear left corner of the recorded portion P coincides with the cutter 211. Then, the rolled sheet R is transported backward by the backward rotation of the feeding roller 125 and the ejection roller 131 to thereby cut the left end of the recorded portion P. On this occasion, the press roller 213 is rolling in the left side of the cutting line of the cutter 211 so as not to interfere with the recorded portion P. Accordingly, even in the case where the recorded portion P is not fully dried, the rolled sheet R can be prevented from being contaminated with ink.

Then, the rolled sheet R is transported by the rotation of the feeding roller 125 and the ejection roller 131 and stopped in a position where the rear right corner of the recorded portion P coincides with the cutter 211. Then, the rolled sheet R is transported backward by the backward rotation of the feeding roller 125 and the ejection roller 131 to thereby cut the right end of the recorded portion P. On this occasion, the press roller 213 is rolling in the left side of the cutting line of the cutter 211 so as to interfere with the recorded portion P. At this point of time, the recorded portion P has been however already dried, so that the rolled sheet R can be prevented from being contaminated with ink.

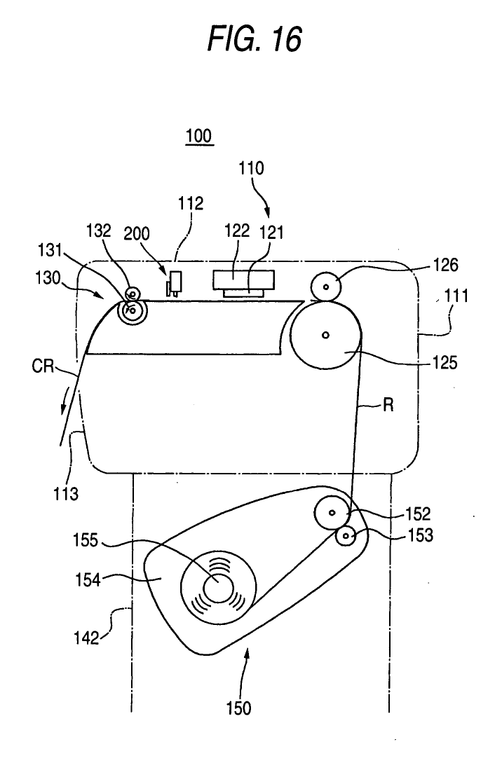

Then, the rolled sheet R is transported by the rotation of the feeding roller 125 and the ejection roller 131 and stopped in a position where the rear left corner of the recorded portion P coincides with the cutter 211. Then, the cutter 211 is moved in the primary scanning direction to thereby cut the rear end of the recorded portion P. On this occasion, the press roller 213 is rolling in the front side of the cutting line of the cutter 211 so as to interfere with the recorded portion P. At this point of time, the recorded portion has been however already dried, so that the rolled sheet R can be prevented from being contaminated with ink. Finally, as shown in FIG. 16, after the completion of cutting, the rolled sheet CR is ejected while held between the ejection roller 131 and the follower roller 132.

As described above, in the cutting device 200 according to any one of the first to fourth embodiments, the directions of the cutter 211, 221 or 231 and the press roller 213, 223 or 233 are changed in accordance with the cutting direction. The directions of the cutter 241 and the press rollers 243a and 243b are changed in accordance with the cutting direction while the press rollers 243a and 243b are moved back and forth in accordance with the cutting direction. Accordingly, because the press roller 213, 223 or 233 can be set so as to be rolling on the outside of a region to be cut out, that is, on the surface of the rolled sheet R except the recorded portion P, the rolled sheet R can be prevented from contaminated with ink deposited on the press roller 213, 223, 233, 243a or 243b.

The cutter 211, 221, 231 or 241 moves in the primary scanning direction automatically so that the recorded portion P of the rolled sheet R in a standstill state is cut in the primary scanning direction. When the cutter 211, 221, 231 or 241 is a standstill state, the rolled sheet R is transported backward so that the recorded portion P is cut in the secondary scanning direction. Accordingly, if the cutter 211, 221, 231 or 241 can move only in the primary scanning direction, cutting of the recorded portion P can be completed. Accordingly, the moving mechanism can be simplified in configuration. Because the rolled sheet R can be cut while being pulled backward in the transporting direction, cutting accuracy can be improved.

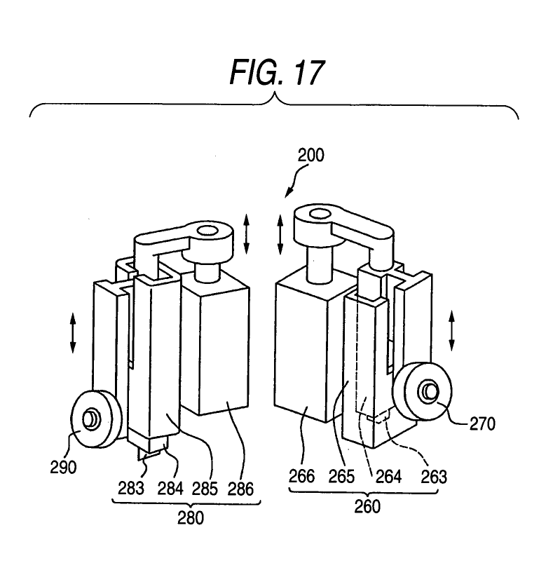

FIG. 17 shows the details of a fifth embodiment of the cutting device 200. The cutting device 200 includes a widthwise cutting unit 260 and a press roller 270. The widthwise cutting unit 260 is used for cutting the recorded portion P of the rolled sheet R in the primary scanning direction. The press roller 270 is disposed adjacent to the widthwise cutting unit 260 so that the rolled sheet R is retained by the press roller 270 while the recorded portion P is cut in the primary scanning direction. The cutting device 200 further includes a lengthwise cutting unit 280 and a press roller 290. The lengthwise cutting unit 280 is used for cutting the recorded portion P of the rolled sheet R in the secondary scanning direction. The press roller 290 is disposed adjacent to the lengthwise cutting unit 280 so that the rolled sheet R is retained by the press roller 290 while the recorded portion P is cut in the secondary scanning direction.

The widthwise cutting unit 260 comprises: a double-edged cutter 263; a slider 264 and a casing 265 serving as a cutter housing; and a solenoid coil 266 serving as an actuator. The lateral direction cutter 263 is attached to a lower end of the slider 264. The press roller 270 is attached to the slider 264 so that the press roller 270 is arranged adjacent to the lateral direction cutter 263. The slider 264 is housed in the casing 265 so that the slider 264 can slide vertically. The solenoid coil 266 drives the slider 264 to move vertically in the casing 265 so that the lateral direction cutter 263 comes into or goes out of the casing 265 in the condition that one of the cutting edges of the lateral direction cutter 263 faces downward.

For example, the solenoid coil 266 provided as the actuator for moving the lateral direction cutter 263 and the press roller 270 vertically may be replaced by an air cylinder, an oil pressure cylinder or a combination of a motor and a gear or pulley mechanism. The widthwise cutting unit 260 and the press roller 270 are disposed so as to be movable in the primary scanning direction. For example, a combination of a motor and a pulley mechanism may be used to move the widthwise cutting unit 260 and the press roller 270 in the primary scanning direction. The device may be directly attached to the carriage 122. Incidentally, the double-edged cutter used as the lateral direction cutter 263 may be replaced by a single-edged cutter.

The lengthwise cutting unit 280 comprises: a single-edged vertical direction cutter 283; a slider 284 and a casing 285 serving as a cutter housing; and a solenoid coil 286 serving as an actuator. The vertical direction cutter 283 is attached to a lower end of the slider 284. The press roller 290 is attached to the slider 284 so as to be arranged adjacent to the vertical direction cutter 283. The slider 284 is housed in the casing 285 so that the slider 284 can slide vertically. The solenoid coil 286 drives the slider 284 to move vertically in the casing 285 so that the vertical direction cutter 283 can come into or go out of the casing 285 in the condition that the edge of the cutter 283 faces downward.

For example, the solenoid coil 286 provided as the actuator for moving the vertical direction cutter 283 and the press roller 290 vertically may be replaced by an air cylinder, an oil pressure cylinder or a combination of a motor and a gear or pulley mechanism. The lengthwise cutting unit 280 and the press roller 290 are disposed so as to be movable in the primary scanning direction. For example, a combination of a motor and a pulley mechanism may be used to move the lengthwise cutting unit 280 and the press roller 290 in the primary scanning direction. The device may be directly attached to the carriage 122. Incidentally, the single-edged cutter used as the vertical direction cutter 283 may be replaced by a double-edged cutter.

The widthwise cutting unit 260 provided with the press roller 270 may be separate from or integrated with the lengthwise cutting unit 280 provided with the press roller 290. In a case where the widthwise cutting unit 260 provided with the press roller 270 is separate from the lengthwise cutting unit 280 provided with the press roller 290, the time required for cutting can be shortened, for example, because the lengthwise cutting unit 280 and the press roller 290 can be moved while the widthwise cutting unit 260 and the press roller 270 carry out a cutting operation. In a case where the widthwise cutting unit 260 provided with the press roller 270 is integrated with the lengthwise cutting unit 280 provided with the press roller 290, the member for moving the widthwise cutting unit 260 and the press roller 270 in the primary scanning direction can serve as the member for moving the lengthwise cutting unit 280 and the press roller 290 in the primary scanning direction.

A method for cutting the rolled sheet R by using the cutting device 200 according to the fifth embodiment will be described with reference to FIG. 5. This cutting method is a method for cutting the recorded portion P of the rolled sheet R into a required size by using the lateral direction cutter 263 or the vertical direction cutter 283. This cutting method comprises steps of: cutting a portion in which the press roller 270 or 290 is not rolling on the recorded portion P; and cutting a portion in which the press roller 270 or 290 is rolling on the recorded portion P.

That is, the lateral direction cutter 263 first moves in the primary scanning direction and cuts a front side \mathring{1} of the recorded portion P. On this occasion, the press roller 270 is rolling in the front side of a cutting line L1 of the lateral direction cutter 263 so that the press roller 270 does not interfere with the recorded portion P. Accordingly, even in the case where the recorded portion P is not fully dried, the rolled sheet R can be prevented from being contaminated with ink. Although FIG. 5 shows the case where the lateral direction cutter 263 cuts the front side \mathring{1} while moving rightward, the lateral direction cutter 263 may cut the front side \mathring{1} while moving leftward.

Then, the vertical direction cutter 283 cuts a left side \mathring{2} of the recorded portion P of the rolled sheet R transported backward. On this occasion, the press roller 290 is rolling in the left side of a cutting line L2 of the vertical direction cutter 283 so that the press roller 290 does not interfere with the recorded portion P. Accordingly, even in the case where the recorded portion P is not fully dried, the rolled sheet R can be prevented from being contaminated with ink. Although FIG. 5 shows the case where the vertical direction cutter 283 cuts the left side \mathring{2} from the rear end to the front end of the recorded portion P, the vertical direction cutter 283 may cut the left side \mathring{2} from the front end to the rear end of the recorded portion P while the rolled sheet R is transported forward.

Then, the vertical direction cutter 283 cuts a right side \mathring{3} of the recorded portion P of the rolled sheet R transported backward. On this occasion, the press roller 290 is rolling in the left side of a cutting line L3 of the vertical direction cutter 283 so that the press roller 290 interferes with the recorded portion P. At this point of time, the rolled sheet R can be however prevented from being contaminated with ink because the recorded portion P has been already dried. Although FIG. 5 shows the case where the vertical direction cutter 283 cuts the right side \mathring{3} from the rear end to the front end of the recorded portion P, the vertical direction cutter 283 may out the right side \mathring{3} from the front end to the rear end of the recorded portion P while the rolled sheet R is transported forward.

Finally, the lateral direction cutter 263 moves in the primary scanning direction and cuts a rear side \mathring{4} of the recorded portion P. On this occasion, the press roller 270 is rolling in the front side of a cutting line L4 of the lateral direction cutter 263 so that the press roller 270 interferes with the recorded portion P. At this point of time, the rolled sheet R can be however prevented from being contaminated with ink because the recorded portion P has been already dried. Although FIG. 5 shows the case where the lateral direction cutter 263 cuts the rear side \mathring{4} while moving rightward, the lateral direction cutter 263 may cut the rear side \mathring{4} while moving leftward. According to the aforementioned method, wasteful standby time for waiting for drying of ink to start cutting can be dispensed with.

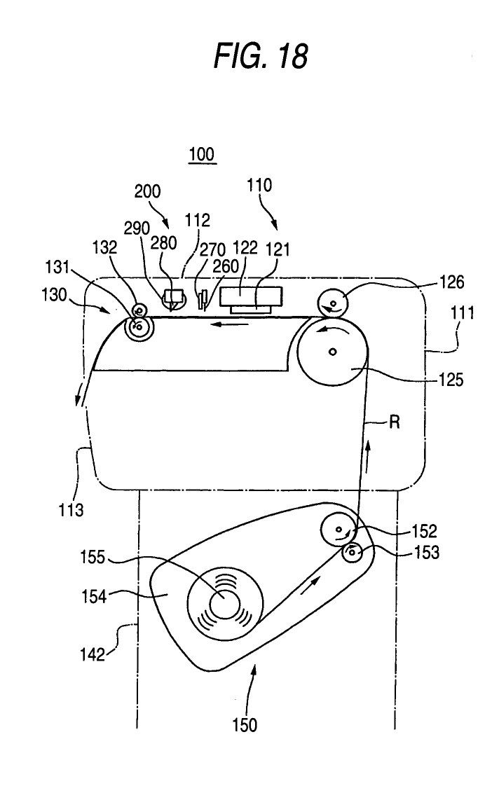

In this configuration, the operation of the cutting device 200 according to the fifth embodiment before and after cutting of the rolled sheet R will be described with reference to FIGS. 18 to 20. As shown in FIG. 18, the rolled sheet R is transported in the secondary scanning direction while the rolled sheet R is held between the feeding roller 125 and the follower roller 126 and held between the ejection roller 131 and the follower roller 132. In this condition, ink drops are jetted from the recording heads 121 moving in the primary scanning direction, so that predetermined information is recorded on the rolled sheet R.

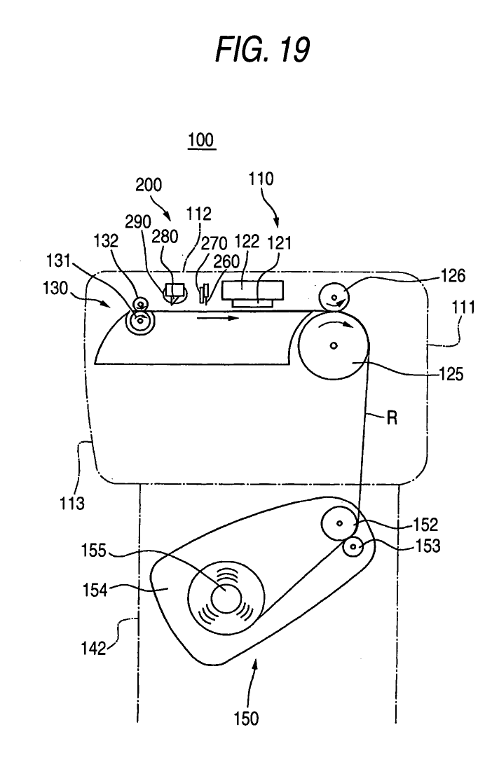

After the completion of the recording, as shown in FIG. 19, the rolled sheet R is transported backward by the backward rotation of the feeding roller 125 and the ejection roller 131 and stopped in a position where the front left corner of the recorded portion P coincides with the lateral direction cutter 263. Then, the lateral direction cutter 263 is moved in the primary scanning direction to thereby cut the front end of the recorded portion P. On this occasion, the press roller 270 is rolling in the front side of the cutting line of the lateral direction cutter 263 so as not to interfere with the recorded portion P. Accordingly, even in the case where the recorded portion P is not fully dried, the rolled sheet R can be prevented from being contaminated with ink Then, the rolled sheet R is transported by the rotation of the feeding roller 125 and the ejection roller 131 and stopped in a position where the rear left corner of the recorded portion P coincides with the vertical direction cutter 283. Then, the rolled sheet R is transported backward by the backward rotation of the feeding roller 125 and the ejection roller 131 to thereby cut the left end of the recorded portion P. On this occasion, the press roller 290 is rolling in the left side of the cutting line of the vertical direction cutter 283 so as not to interfere with the recorded portion P. Accordingly, even in the case where the recorded portion P is not fully dried, the rolled sheet R can be prevented from being contaminated with ink.

Then, the rolled sheet R is transported by the rotation of the feeding roller 125 and the ejection roller 131 and stopped in a position where the rear right corner of the recorded portion P coincides with the vertical direction cutter 283. Then, the rolled sheet R is transported backward by the backward rotation of the feeding roller 125 and the ejection roller 131 to thereby cut the right end of the recorded portion P. On this occasion, the press roller 290 is rolling in the left side of the cutting line of the vertical direction cutter 283 so as to interfere with the recorded portion P. At this point of time, the recorded portion P has been however already dried, so that the rolled sheet R can be prevented from being contaminated with ink.

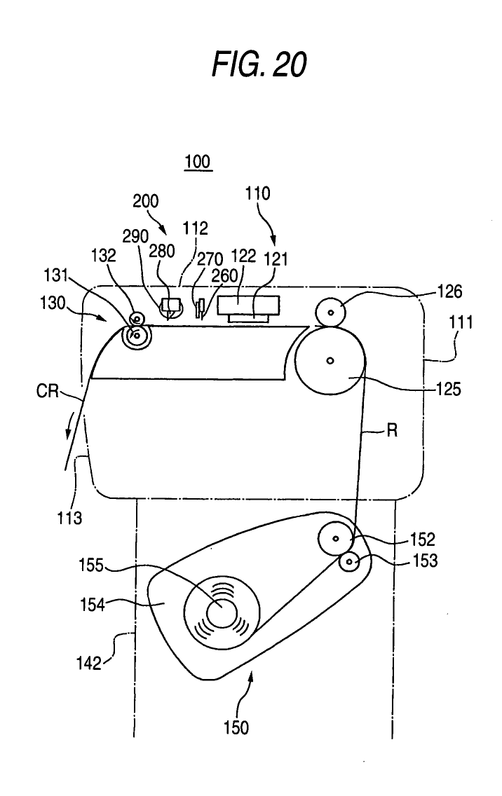

Then, the rolled sheet R is transported by the rotation of the feeding roller 125 and the ejection roller 131 and stopped in a position where the rear left corner of the recorded portion P coincides with the lateral direction cutter 263. Then, the lateral direction cutter 263 is moved in the primary scanning direction to thereby cut the rear end of the recorded portion P. On this occasion, the press roller 270 is rolling in the front side of the cutting line of the lateral direction cutter 263 so as to interfere with the recorded portion P. At this point of time, the recorded portion P has been however already dried, so that the rolled sheet R can be prevented from being contaminated with ink. Finally, as shown in FIG. 20, after the completion of cutting, the rolled sheet R is ejected while being held between the ejection roller 131 and the follower roller 132.

As described above, the cutting device 200 according to the fifth embodiment is configured so that the widthwise cutting unit 260 provided with the press roller 270 and the lengthwise cutting unit 280 provided with the press roller 290 can be retractably brought into contact with the surface of the rolled sheet R. Accordingly, the widthwise cutting unit 260 provided with the press roller 270 and the lengthwise cutting unit 280 provided with the press roller 290 can be moved individually in accordance with the cutting direction so that either of the cutting units 260 and 280 can be selected. Accordingly, the rolled sheet R can be cut by the widthwise cutting unit 260 and the lengthwise cutting unit 280 while the rolled sheet R is pressed firmly by the respective press rollers 270 and 290.

The widthwise cutting unit 260 moves in the primary scanning direction automatically so that the recorded portion P of the rolled sheet R in a standstill state is cut in the primary scanning direction. In the condition that the lengthwise cutting unit 280 is in a standstill state, the rolled sheet R is transported backward so that the recorded portion P is cut in the secondary scanning direction. Accordingly, if the widthwise cutting unit 260 and the lengthwise cutting unit 280 can move only in the primary scanning direction, cutting of the recorded portion P can be completed. Accordingly, the moving mechanism can be simplified in configuration. Because the rolled sheet R can be cut while being pulled backward in the transporting direction, cutting accuracy can be improved.

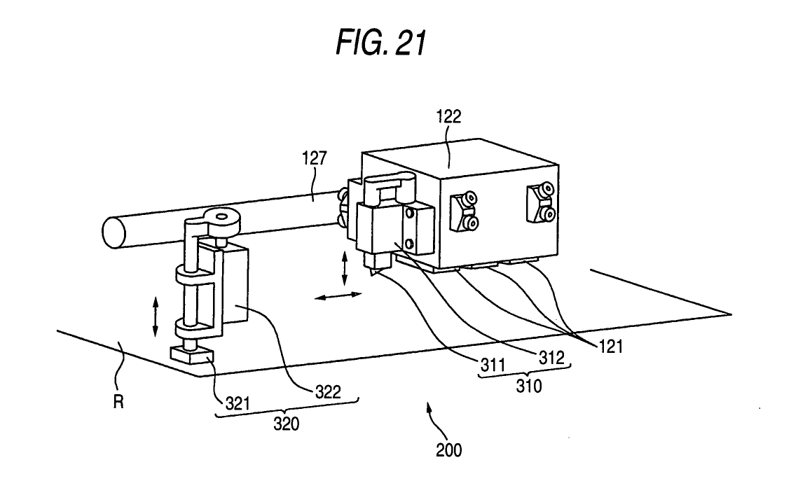

FIG. 21 shows the details of a sixth embodiment of the cutting device 200. The cutting device 200 comprises a cutter unit 310 and a retainer unit 320. The cutter unit 310 cuts the rolled sheet R which has been subjected to the recording. The retainer unit 320 retains the rolled sheet R while the rolled sheet R needs to be cut. While the rolled sheet R is held by the retainer unit 320 so as not to be displaced, the rolled sheet R is cut into a predetermined dimension by the cutter unit 310.

The cutter unit 310 has a single-edged cutter 311, and a solenoid coil 312. The single-edged cutter 311 is disposed so that the edge of the cutter 311 faces downward. The solenoid coil 312 drives the cutter 311 to move vertically. The cutter unit 310 is attached to the carriage 122. The cutter unit 310 configured as described above can cut the rolled sheet R in a widthwise direction because the cutter 311 is moved down by the solenoid coil 312 and moved in the primary scanning direction (rightward viewed from the front side of the housing 111) by the carriage 122. When cutting is not required, the cutter 311 can be prevented from interfering with the rolled sheet R because the cutter 311 is moved up by the solenoid coil 312 so as to be retracted from the rolled sheet R.

The retainer unit 320 has a press member 321, and a solenoid coil 322. The press member 321 presses the rolled sheet R. The solenoid coil 322 drives the press member 321 to move vertically. The retainer unit 320 is attached to a frame or the like located in the left viewed from the front side of the housing 111. According to the retainer unit 320 configured as described above, the press member 321 is moved down by the solenoid coil 322 so as to press and hold an end portion of the rolled sheet R. For this reason, holding power due to pressing as well as holding power due to suction is applied on the rolled sheet R. Accordingly, the rolled sheet R can be prevented from being displaced while the rolled sheet R is cut. Moreover, the press member 321 can be prevented from interfering with the rolled sheet R when cutting is not required because the press member 321 is moved up by the solenoid coil 322 so as to be retracted from the rolled sheet R.

Moreover, there is no gap under the rolled sheet R at the cutting start point because the press member 321 is moved down by the solenoid coil 322 so as to press and hold the cutting start side of the rolled sheet R. Moreover, there is no gap under the rolled sheet R because the rolled sheet R is pulled in the cutting direction after cutting starts. For this reason, the rolled sheet R can be cut accurately.

Although this embodiment has been described on the case where the cutter unit 310 is attached to the carriage 122, the invention may be applied to the case where the cutter unit 310 is provided individually so as to be movable in the primary scanning direction. Although this embodiment has been described on the case where the single-edged cutter 311 is used in the cutter unit 310, the invention may be applied to the case where a double-edged cutter or a rounded rod-shaped cutter is used. Although this embodiment has been described on the case where the solenoid coil 312 is used for moving the single-edged cutter 311 vertically, the invention may be applied to the case where an air cylinder, an oil pressure cylinder or a combination of a motor and a gear or pulley mechanism is used.

Although this embodiment has been described on the case where one retainer unit 320 is attached to a frame or the like located in the left viewed from the front side of the housing 111, the invention may be applied to the case where one retainer unit 320 is attached to the right or center or a plurality of retainers 320 are attached thereto. Although this embodiment has been described on the case where the solenoid coil 322 is used for moving the press member 321 vertically, the invention may be applied to the case where an air cylinder, an oil pressure cylinder or a combination of a motor and a gear or pulley mechanism is used.

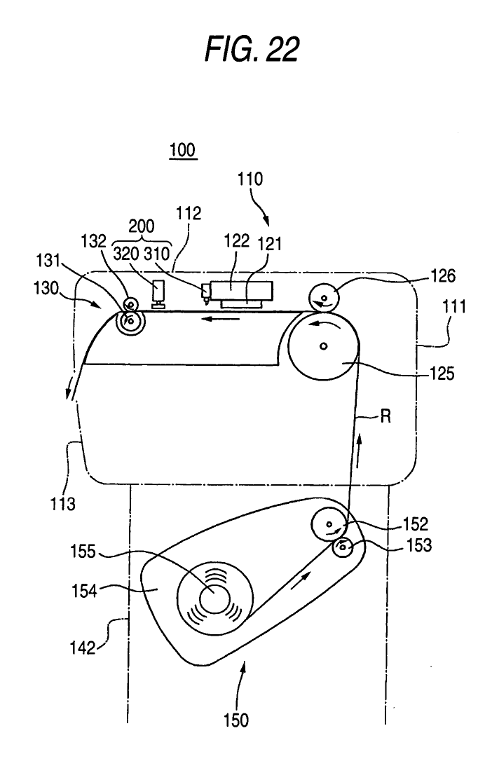

In this configuration, the operation of the cutting device 200 according to the sixth embodiment before and after cutting of the rolled sheet R will be described with reference to FIGS. 22 to 24. As shown in FIG. 22, the rolled sheet R is transported in the secondary scanning direction while the rolled sheet R is held between the feeding roller 125 and the follower roller 126 and held between the ejection roller 131 and the follower roller 132. In this condition, ink drops are jetted from the recording heads 121 moving in the primary scanning direction, so that predetermined information is recorded on the rolled sheet R.

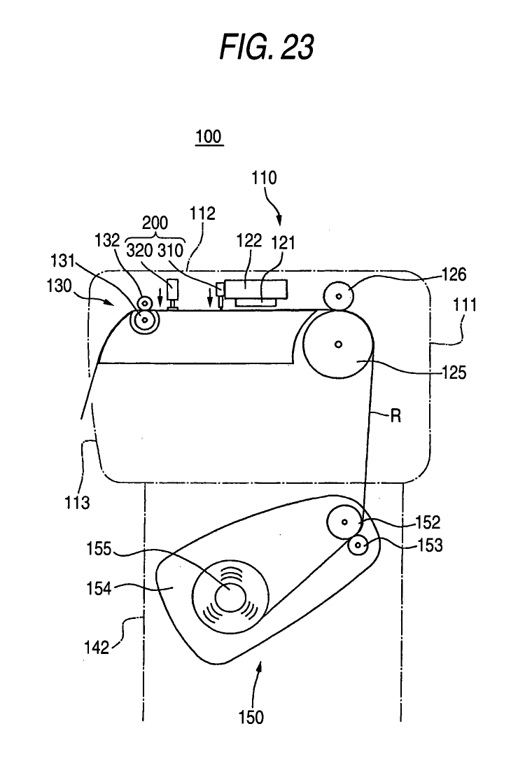

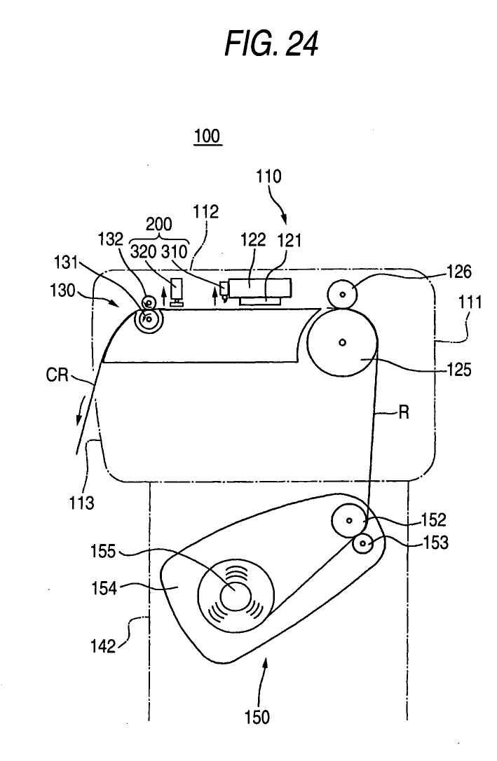

After the completion of the recording, as shown in FIG. 23, the rolled sheet R is stopped and an end portion of the rolled sheet R is pressed by the retainer unit 320 moving down. Then, the rolled sheet R is cut by Fe cutter unit 310 moving down and in the primary scanning direction. Finally, as shown in FIG. 24, the retainer unit 320 and the cutter unit 310 move up so as to be retracted. As a result, the rolled sheet R cut in this manner is ejected while held between the ejection roller 131 and the follower roller 132.

As described above, in the cutting device 200 according to the sixth embodiment, holding power due to pressing as well as holding power due to suction is applied on the rolled sheet R. Accordingly, the rolled sheet R can be prevented from being displaced when the rolled sheet R is cut, so that the rolled sheet R can be cut accurately. Moreover, there is no gap under the rolled sheet R at the cutting start point because the cutting start side of the rolled sheet R is pressed and held. Moreover, there is no gap under the rolled sheet R after cutting starts because the rolled sheet R is pulled in the cutting direction. Accordingly, the rolled sheet R can be cut accurately. In addition, the retainer unit 320 has a press member 321 for pressing the rolled sheet R, and a solenoid coil 322 for retractably bring the press member 321 into contact with the rolled sheet R. Accordingly, the rolled sheet R can be retracted when cutting is not required, so that the retainer unit 320 can be prevented from interfering with the rolled sheet R.

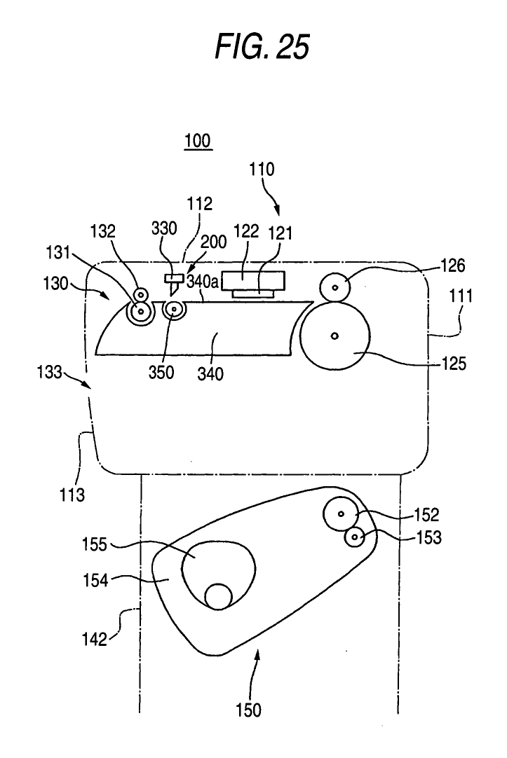

FIG. 25 shows the internal configuration of an essential part of an ink jet printer provided with the cutting device 200 according to a seventh embodiment, as in the same manner as FIG. 3. In these figures, the same reference numerals refer to like similar components. The cutting device 200 comprises a cutter 330, a platen 340, and a transport roller 350. The cutter 330 cuts the rolled sheet R after completion of recording. The platen 340 guides transporting of the rolled sheet R. The transport roller 350 transports the rolled sheet R. The cutter 330 is disposed so as to be movable in the vertical direction and the primary and secondary scanning directions in the condition that the edge of the cutter 330 faces downward. The cutter 330 has a single-edged cutter or a double-edged cutter. The cutter 330 is formed so that the cutting direction can be changed to the primary scanning direction and the secondary scanning direction.

For example, a solenoid coil, an air cylinder, an oil pressure cylinder or a combination of a motor and a gear or pulley mechanism may be used to move the cutter 330 vertically. For example, a combination of a motor and a pulley mechanism may be used to move the cutter 330 in the primary scanning direction. The device may be directly attached to the carriage 122. For example, a combination of a motor and a gear mechanism may be used to move the cutter 330 in the secondary scanning direction. For example, a combination of a motor and a gear mechanism may be used to change the direction of the cutter 330 to the primary scanning direction and the secondary scanning direction.

The platen 340 is disposed below the cutter 330 and the recording heads 121. The transport roller 350 is disposed just below the cutter 330 and embedded in the platen 340 so as to be level with a guide face 340a of the platen 340. The platen 340 guides the rolled sheet R in a transporting path ranging from the feeding roller 125 to a sheet ejection port 133 via the transport roller 350 and the ejection roller 131. The transport roller 350 generally has a metal shaft 351, and a rubber roller fitted onto the metal shaft The transport roller 350 may be formed as a suitable combination of metal, rubber, plastics, etc.

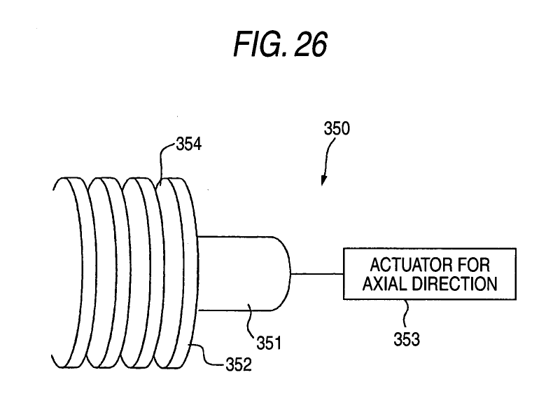

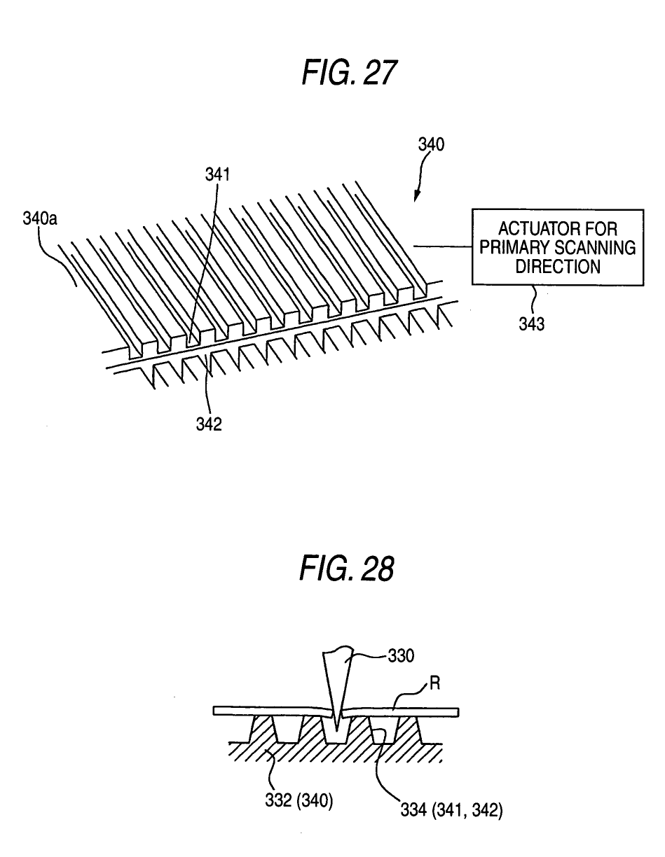

FIGS. 26 and 27 show the details of the seventh embodiment of the cutting device 200. As shown in FIG. 26, the transport roller 350 has a metal shaft 351, a rubber roller body 352 fitted onto the metal shaft 351, and an actuator 353 for moving the transport roller 350 entirely in the axial direction thereof. Annular grooves 354 with a predetermined depth and a predetermined width am formed in the outer circumferential face of the roller body 352 so as to be arranged at a predetermined pitch in the axial direction. For example, the actuator 353 may be formed as a solenoid coil, an air cylinder, an oil pressure cylinder or a combination of a motor and a gear or pulley mechanism. The actuator 353 is provided so that the transport roller 350 can be moved by at least the pitch of formation of the grooves 354.

Because the grooves 354 are provided, the edge of the cutter 330 moving down to cut the rolled sheet R in the secondary scanning direction enters one of the grooves 354 when the edge of the cutter 330 passes through the rolled sheet R. Accordingly, the outer circumferential face of the roller body 352 can be prevented from being damaged. Incidentally, the depth and width of each groove 354 are selected so that the edge of the cutter 330 does not interfere with the outer circumferential face of the roller body 352 even in the case where the edge of the cutter 330 enters the groove 354.

Moreover, the transport roller 350 having the roller body 352 provided with the grooves 354 formed at a predetermined pitch in the axial direction is actuated by the actuator 353 so that the transport roller 350 can move in the axial direction by the pitch of formation of the grooves 354. Accordingly, even in the case where the cutter 330 is stopped in any position in the primary scanning direction, the cutter 330 can be made coincident with one of the grooves 354. The rolled sheet R can be cut in the secondary scanning direction by the cutter 330 located in this position without damage of the outer circumferential face of the roller body 352.

Incidentally, the transport roller 350 need not be provided. In this case, grooves need to be provided in the platen 340. The provision of grooves in the platen 340 will be described with reference to FIG. 27. In this case, the platen 340 has linear grooves 341 extending in the secondary scanning direction, a linear groove 342 extending in the primary scanning direction. The grooves 341 and 342 are formed in an upper face of the platen 340. Each of the linear grooves 341 has a predetermined depth and a predetermined width. The linear grooves 341 are formed at a predetermined pitch in the primary scanning direction. The linear groove 342 has the same predetermined depth and the same predetermined width as those of each of the linear grooves 341. An actuator 343 actuates the platen 340 entirely to move in the primary scanning direction. For example, the actuator 343 may be formed as a solenoid coil, an air cylinder, an oil pressure cylinder or a combination of a motor and a gear or pulley mechanism. The actuator 343 is provided so that the platen 340 can be moved by at least the pitch of formation of the grooves 341.

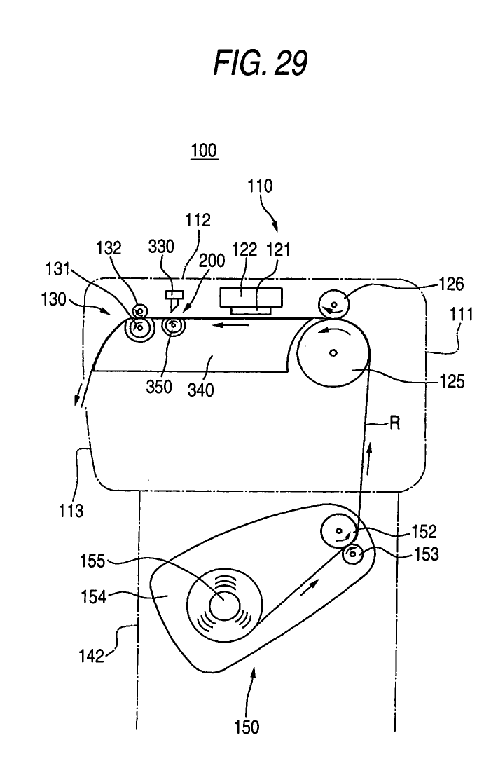

Because the grooves 341 and 342 are provided, as shown in FIG. 28, the edge of the cutter 330 moving down to cut the rolled sheet R in the secondary scanning direction or the primary scanning direction enters one of the grooves 341 or the groove 342 when the edge of the cutter 330 passes through the rolled sheet R. Accordingly, the upper face of the platen 340 can be prevented from being damaged. Incidentally, the depth and width of each groove 341 or the groove 432 are selected so that the edge of the cutter 330 does not interfere with the upper face of the platen 340 even in the case where the edge of the cutter 330 enters the groove 341 or 342.

Moreover, the platen 340 provided with the grooves 341 formed at a predetermined pitch in the primary scanning direction is actuated by the actuator 343 so that the platen 340 can move in the primary scanning direction by the pitch of formation of the grooves 341. Accordingly, even in the case where the cutter 330 is stopped in any position in the primary scanning direction, the cutter 330 can be made coincident with one of the grooves 341. The rolled sheet R can be cut in the secondary scanning direction by the cutter 330 located in this position without damage of the upper face of the platen 340.

Incidentally, the grooves 341 are formed so as to extend in the secondary scanning direction. Accordingly, even in the case where the cutter 330 is formed so as to be movable in the secondary scanning direction, the rolled sheet R can be cut in the secondary scanning direction without damage of the upper face of the platen 340. In this case, grooves 342 may be formed at a predetermined pitch in the secondary scanning direction so that the platen 340 can move in the secondary scanning direction by the pitch of formation of the grooves 342. According to this configuration, even in the case where the cutter 330 is stopped in any position in the secondary scanning direction, the cutter 330 can be made coincident with one of the grooves 342. As a result, the rolled sheet R can be cut in the primary scanning direction by the cutter 330 located in this position without damage of the upper face of the platen 340.

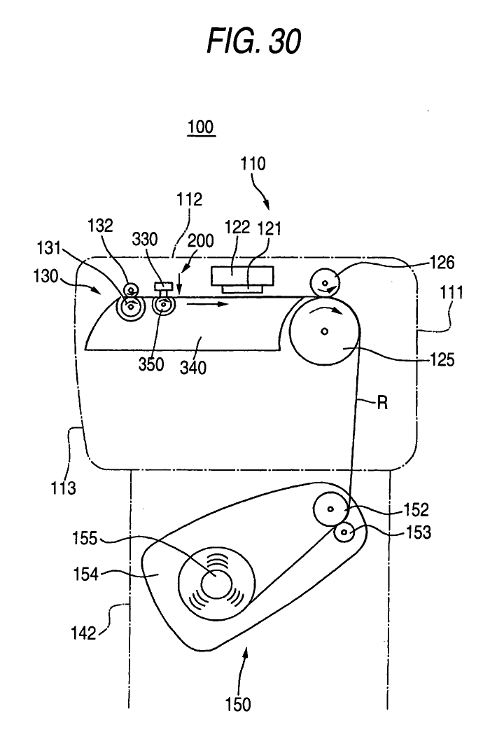

In this configuration, the operation of the cutting device 200 according to the seventh embodiment before and after cutting of the rolled sheet R will be described with reference to FIGS. 29 to 31. As shown in FIG. 29, the rolled sheet R is transported in the secondary scanning direction while the rolled sheet R is held between the feeding roller 125 and the follower roller 126 and held between the ejection roller 131 and the follower roller 132. In this condition, ink drops are jetted from the recording heads 121 moving in the primary scanning direction, so that predetermined information is recorded on the rolled sheet R.

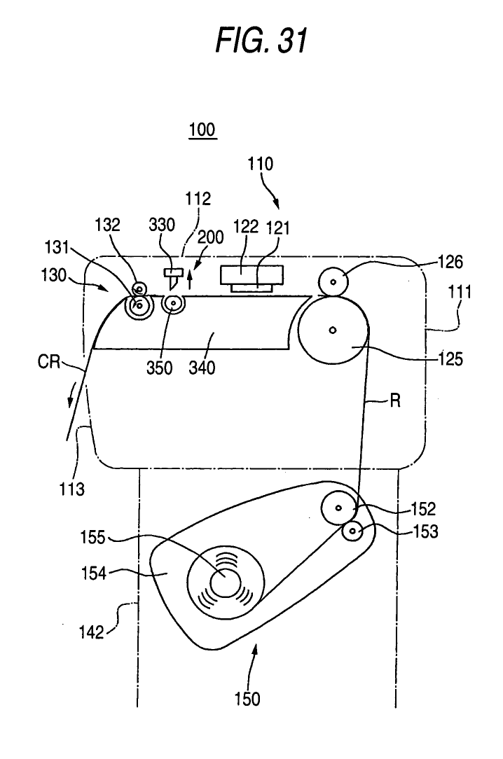

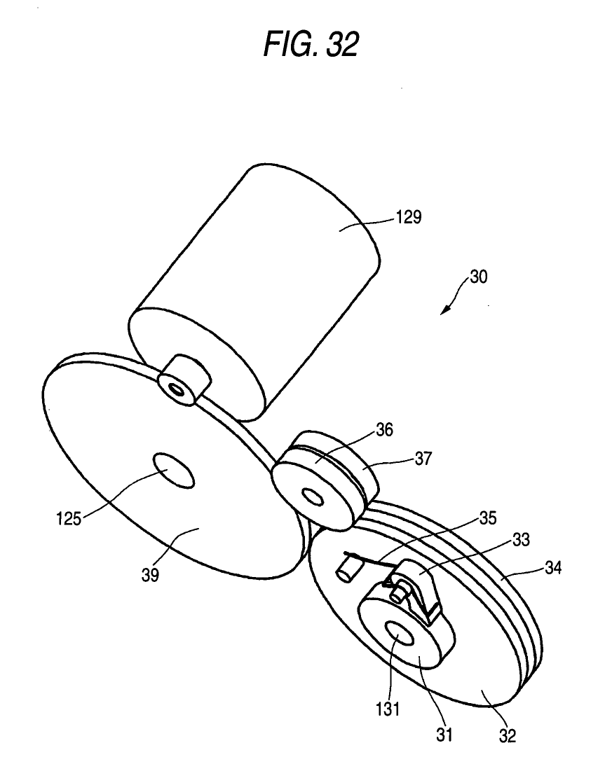

After the completion of the recording, as shown in FIG. 30, the rolled sheet R is transported backward by the backward rotation of the feeding roller 125 and the ejection roller 131 and cut in the secondary scanning direction by the cutter 330 moving down. Finally, as shown in FIG. 31, the rolled sheet R also cut in the primary scanning direction is ejected while held between the ejection roller 131 and the follower roller 132.

As described above, in the cutting device 200 according to the seventh embodiment, the grooves 354 are provided in the circumferential face of the transport roller 350 opposite to the cutter 330 with interposition of the rolled sheet R. Accordingly, the circumferential face of the transport roller 350 can be prevented from being damaged by the cutter 330 which passes through the rolled sheet R when the rolled sheet R is cut. Moreover, the life of the transport roller 350 can be elongated. Moreover, the grooves 354 are provided at a predetermined pitch in a direction perpendicular to the transporting direction of the rolled sheet R. Accordingly, when the cutter 330 is moved in a direction perpendicular to the transporting direction, the cutter 330 can be made coincident with one of the grooves 354, so that the circumferential face of the transport roller 350 can be prevented from being damaged.

Moreover, the actuator 353 is provided for moving the transport roller 350 in a direction perpendicular to the transporting direction. Accordingly, the cutter 330 can be made always coincident with one of the grooves 354. Even in the case where the cutter 330 is moved to any position in a direction perpendicular to the transporting direction, the circumferential face of the transport roller 350 can be perfectly prevented from being damaged. Moreover, because there is no necessity of setting the cutter pressure while changing the cutter pressure delicately in accordance with the kind of the rolled sheet R, the rolled sheet R can be cut reliably even in the case where the cutter pressure is set roughly.

Moreover, the grooves 341 and 342 are provided in the upper face of the platen 340 opposite to the cutter 330 with interposition of the rolled sheet R. Accordingly, the upper face of the platen 340 can be prevented from being damaged by the cutter 330 which passes through the rolled sheet R when the rolled sheet R is cut. Transporting accuracy can be improved. Moreover, the actuator for primary scanning direction 343 is provided for moving the platen 340 in a direction perpendicular to the transporting direction. Accordingly, the cutter 330 can be made always coincident with one of the grooves 341. Even in the case where the cutter 330 is moved to any position in a direction perpendicular to the transporting direction, the upper face of the platen 340 can be perfectly prevented from being damaged.

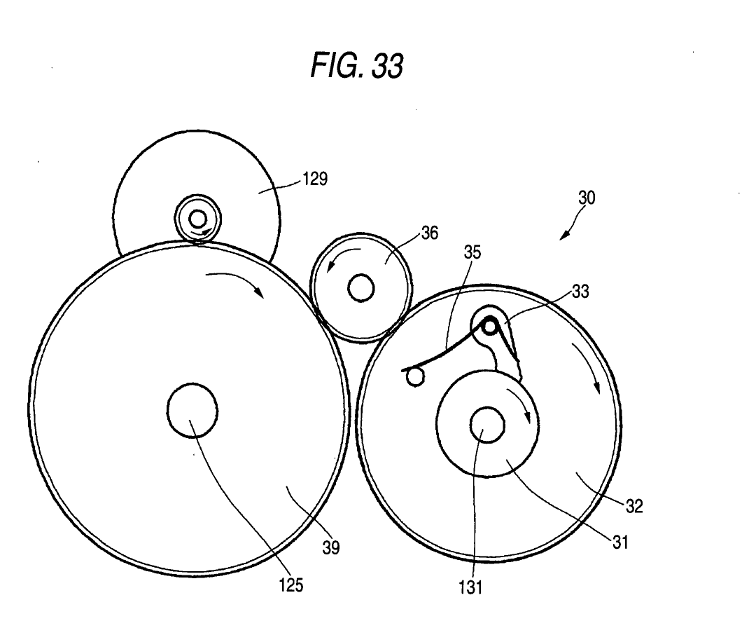

FIG. 32 is a perspective view showing a drive mechanism 30 for the ejection roller 131. The drive mechanism 30 comprises a frictional wheel 31 serving as a frictional switcher, and a first ejection gear 32 serving as a rotation transmitter. The frictional wheel 31 is fitted onto the shaft of the ejection roller 131. The first ejection gear 32 is fitted on the shaft of the ejection roller 131 so as to be adjacent to the frictional wheel 31. The drive mechanism 30 further comprises a claw member 33 serving as the frictional switcher, and a second ejection gear 34 serving as the rotation transmitter. The claw member 33 is disposed adjacent to the first ejection gear 32 so as to abut on the frictional wheel 31. The second ejection gear 34 is fitted onto the shaft of the ejection roller 131 so as to be adjacent to the first ejection gear 32.

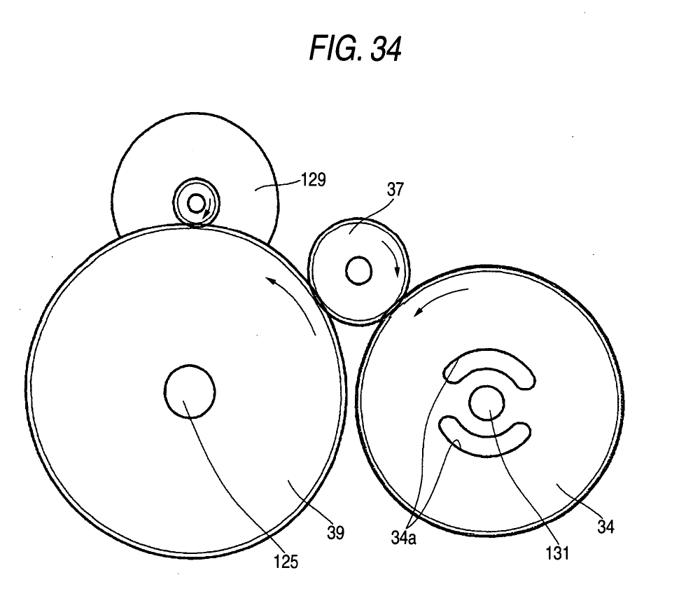

The outer circumferential face of the cylindrical frictional wheel 31 is formed as a rough surface having a high friction coefficient. Alternatively, a high friction material is laminated on the frictional wheel 31 so that the outer circumferential face of the frictional wheel 31 has a high friction coefficient. The frictional wheel 31 is fitted on the shaft of the ejection roller 131 so as to be rotatable together with the shaft of the ejection roller 131. The claw member 33 has an outer shape formed like a claw. The tip end of the claw member 33 has an arcuate surface adapted to be brought into oblique contact with the outer circumferential face of the frictional wheel 31. The claw member 33 has a rear end pivoted on the side face of the first ejection gear 32 where is away from the outer circumferential face of the frictional wheel 31. That is, the claw member 33 is disposed to make an acute angle with the frictional wheel 31 toward the direction of forward rotation (clockwise rotation shown in FIG. 33) of the ejection roller 131. A torsion coil spring 35 serving as the frictional switcher is retained on the side face of the first ejection gear 32 urges the arcuate tip end face of the claw member 33 to be pressed against the outer circumferential face of the frictional wheel 31. A combination of the frictional wheel 31 and the claw member 33 configured as described above serves as a ratchet which is forced to rotate clockwise (forward) as shown in FIG. 33.

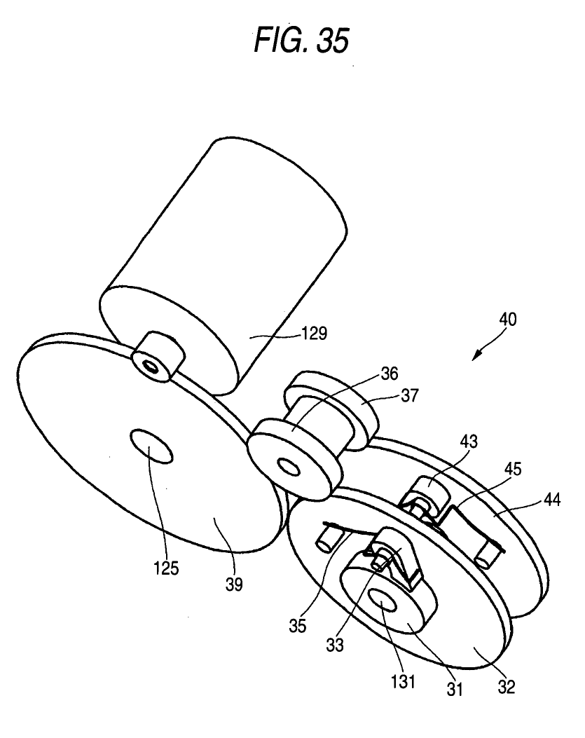

The first ejection gear 32 is linked, through a first transmission gear 36, to a feeding gear 129 fitted onto the shaft of the feeding roller 125. The first ejection gear 32 is fitted onto the shaft of the ejection roller 131 so that the first ejection gear 32 can rotate relative to the shaft of the ejection roller 131, that is, a predetermined clearance is formed between the first ejection gear 32 and the shaft of the ejection roller 131. The second ejection gear 34 is linked, through a second transmission gear 37, to the feeding gear 129 fitted onto the shaft of the feeding roller 125. The second transmission gear 37 is disposed so as to be coaxial with the first transmission gear 36. As shown in FIG. 34, arcuate slits 34a serving as the frictional switcher are formed in the second ejection gear 34. The second ejection gear 34 is fitted onto the shaft of the ejection roller 131 with predetermined interference. The first ejection gear 32 and the second ejection gear 34 configured as described above are coaxial gears which are formed so that the gear ratio of the first ejection gear 32 is higher than the gear ratio of the second ejection gear 34, and that the transfer ratio of forward rotation and the transfer ratio of backward rotation are different from each other. The first ejection gear 32 operates at the time of clockwise (forward) rotation shown in FIG. 33 whereas the second ejection gear 34 operates at the time of counterclockwise (backward) rotation shown in FIG. 34.

In the aforementioned configuration, when the second ejection gear 34 rotates forward, the rotation of the second ejection gear 34 has no relation with the forward rotation of the ejection roller 131 because the second ejection gear 34 slips on the outer circumferential face of the ejection roller 131 by the action of the slits 34a. When the first ejection gear 32 also rotates forward, the ejection roller 131 fitted into the frictional wheel 31 rotates forward because the tip end face of the claw member 33 presses the outer circumferential face of the frictional wheel 31 by friction.

On the other hand, when the first ejection gear 32 rotates backward, the rotation of the first ejection gear 32 has no relation with the backward rotation of the ejection roller 131 fitted into the frictional wheel 31 because the tip end face of the claw member 33 slips on the outer circumferential face of the frictional wheel 31. When the second ejection gear 34 also rotates backward, the ejection roller 131 rotates backward because the second ejection gear 34 rotates the outer circumferential face of the ejection roller 131 by friction.

In this manner, a combination of the frictional wheel 31, the claw member 33, the slits 34a and the torsion coil spring 35 serves as a frictional clutch. At the time of forward rotation, the gear is frictionally switched to the first ejection gear 32 having a high gear ratio. At the time of backward rotation, the gear is frictionally switched to the second ejection gear 34 having a low gear ratio. Accordingly, there can be provided a simple and small-sized switching mechanism in which the circumferential velocity of the ejection roller 131 can be made higher than the circumferential velocity of the feeding roller 125 at the time of forward rotation whereas the circumferential velocity of the feeding roller 125 can be made higher than the circumferential velocity of the ejection roller 131 at the time of backward rotation.

For this reason, when the rolled sheet R is transported in order to record information on the rolled sheet R, tensile force always acts on the rolled sheet R in the transporting direction so that accurate recording can be made while the rolled sheet R can be prevented from being deflected. When the rolled sheet R is transported backward to be cut not only in the primary scanning direction but also in the secondary scanning direction, tensile force always acts on the rolled sheet R backward in the transporting direction so that accurate cutting can be made while the rolled sheet R can be prevented from being deflected and the recording surface can be prevented from being contaminated with ink caused by rubbing of the rolled sheet R against the recording heads 121.

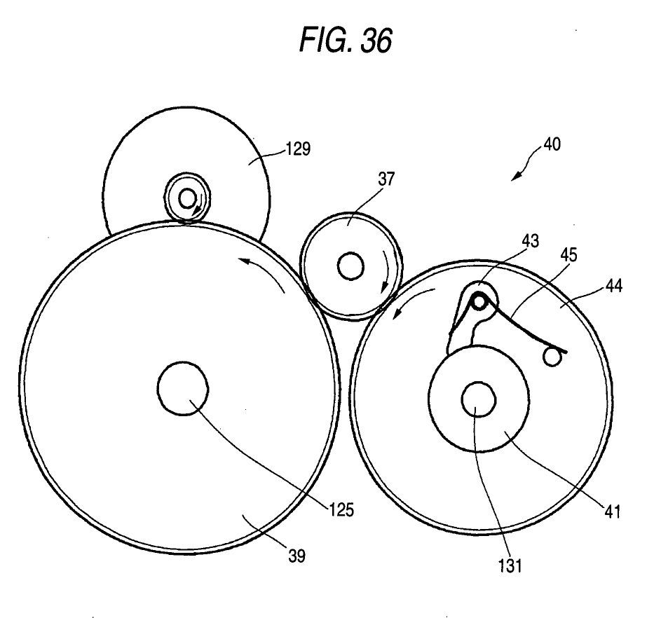

FIG. 35 shows a first modified example of the drive mechanism for the ejection roller 131 and its periphery as in the same manner as FIG. 32. In these figures, the same reference numerals refer to similar components so that repetitive description for those will be omitted. The drive mechanism 40 for the ejection roller 131 comprises a second ejection gear 44 which is different from the second ejection gear 34 in the drive mechanism 30 shown in FIG. 32.

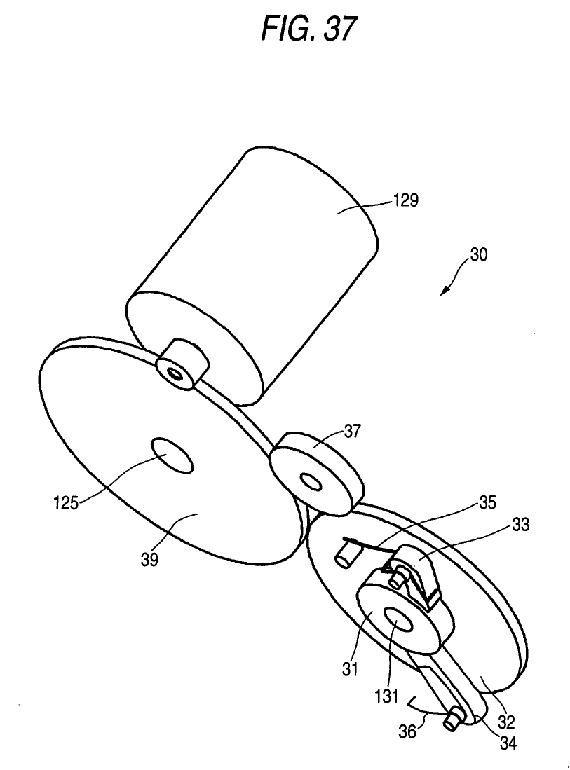

Specifically, as shown in FIGS. 35 and 36, the drive mechanism 40 comprises: a frictional wheel 41 serving as a frictional switcher; a second ejection gear 44 serving as a rotation transmitter; and a claw member 43 serving as the frictional switcher, as well as the first ejection gear 32 serving as the rotation transmitter. Slits 34a as shown in FIG. 34 are not formed in the second ejection gear 44. The frictional wheel 41 is fitted onto the shaft of the ejection roller 131. The second ejection gear 44 is fitted onto the shaft of the ejection roller 131 so as to be adjacent to the frictional wheel 41. The claw member 43 is disposed on the side face of the second ejection gear 44 so as to come into contact with the frictional wheel 41.

The outer circumferential face of the cylindrical frictional wheel 41 is formed as a rough surface having a high friction coefficient. Alternatively, a high friction material is laminated on the frictional wheel 41 so that the outer circumferential face of the frictional wheel 41 has a high friction coefficient The frictional wheel 41 is fitted on the shaft of the ejection roller 131 so as to be rotatable together with the shaft of the ejection roller 131. The claw member 43 has an outer shape formed like a claw. The claw member 43 has an arcuate tip end face which can be brought into oblique contact with the outer circumferential face of the frictional wheel 41. The claw member 43 has a rear end pivoted on the side face of the second ejection gear 44 where is away from the outer circumferential face of the frictional wheel 41. That is, the claw member 43 is disposed to make an acute angle with the frictional wheel 41 toward the direction of backward rotation (counterclockwise rotation shown in FIG. 36) of the ejection roller 131. A torsion coil spring 45 serving as the frictional switcher is retained on the side face of the second ejection gear 44 urges the tip end face of the claw member 43 to be pressed against the outer circumferential face of the frictional wheel 41. A combination of the frictional wheel 41 and the claw member 43 configured as described above serves as a ratchet which is forced to rotate counterclockwise (backward) as shown in FIG. 36.

The second ejection gear 44 is linked, through a second transmission gear 37, to the feeding gear 129 fitted onto the shaft of the feeding roller 125. The second transmission gear 37 is disposed so as to be coaxial with the first transmission gear 36. The second ejection gear 44 is fitted onto the shaft of the ejection roller 131 so that the second ejection gear 44 can rotate relative to the shaft of the ejection roller 131, that is, a predetermined clearance is formed between the second ejection gear 44 and the shaft of the election roller 131. The first ejection gear 32 and the second ejection gear 44 configured as described above are coaxial gears which are formed so that the gear ratio of the first ejection gear 32 is higher than the gear ratio of the second ejection gear 44, and that the transfer ratio of forward rotation and the transfer ratio of backward rotation are different from each other. The first ejection gear 32 operates at the time of clockwise (forward) rotation shown in FIG. 33 whereas the second ejection gear 44 operates at the time of counterclockwise (backward) rotation shown in FIG. 36.

In the aforementioned configuration, when the second ejection gear 44 rotates forward, the rotation of the second ejection gear 44 has no relation with the forward rotation of the ejection roller 131 fitted into the frictional wheel 41 because the tip end face of the claw member 43 slips on the outer circumferential face of the frictional wheel 41. When the first ejection gear 32 also rotates forward, the ejection roller 131 fitted into the frictional wheel 31 rotates forward because the tip end face of the claw member 33 presses the outer circumferential face of the frictional wheel 31 by friction.

On the other hand, when the first ejection gear 32 rotates backward, the rotation of the first ejection gear 32 has no relation with the backward rotation of the ejection roller 131 fitted into the frictional wheel 31 because the tip end face of the claw member 33 slips on the outer circumferential face of the frictional wheel 31. When the second ejection gear 44 also rotates backward, the ejection roller 131 fitted into the frictional wheel 41 rotates backward because the tip end face of the claw member 43 presses the outer circumferential face of the frictional wheel 41 by friction.

In this manner, a combination of the frictional wheels 31 and 41, the claw members 33 and 43 and the torsion coil springs 35 and 45 serves as a friction clutch. At the time of forward rotation, the gear is frictionally switched to the first ejection gear 32 having a high gear ratio. At the time of backward rotation, the gear is frictionally switched to the second ejection gear 44 having a low gear ratio. Accordingly, there can be provided a simple and small-sized switching mechanism in which the circumferential velocity of the ejection roller 131 can be made higher than the circumferential velocity of the feeding roller 125 at the time of forward rotation whereas the circumferential velocity of the feeding roller 125 can be made higher than the circumferential velocity of the ejection roller 131 at the time of backward rotation.

For this reason, when the rolled sheet R is transported in order to record information on the rolled sheet R, tensile force always acts on the rolled sheet R in the transporting direction so that accurate recording can be made while the rolled sheet R can be prevented from being deflected. When the rolled sheet R is transported backward to be cut not only in the primary scanning direction but also in the secondary scanning direction, tensile force always acts on the rolled sheet R backward in the transporting direction so that accurate cutting can be made while the rolled sheet R can be prevented from being deflected and the recording surface can be prevented from being contaminated with ink caused by rubbing of the rolled sheet R against the recording heads 121.

As described above, the ejection roller 131 has the first and second ejection gears 32 and 34 (44) in which the transfer ratio of forward rotation and the transfer ratio of backward rotation are different from each other, the frictional wheels 31 and 41 for frictionally switching these gears 32 and 34 (44), the claw members 33 and 43, the slits 34a, and the torsion coil springs 35 and 45. Accordingly, switching of forward rotation and backward rotation of the ejection roller 131 and change in circumferential velocity of the ejection roller 131 between forward rotation and backward rotation can be achieved by the simple and small-sized mechanism.

Because the first and second ejection gears 32 and 34 (44) are two coaxial gears different in gear ratio, the circumferential velocity of the ejection roller 131 can be changed reliably between forward rotation and backward rotation. Because the frictional wheels 31 and 41, the claw members 33 and 43, the slits 34a and the torsion coil springs 35 and 45 operate as friction clutches disposed in the first and second ejection gears 32 and 34 (44), the rotation of the ejection roller 131 can be switched to forward rotation or backward rotation reliably.

Because the circumferential velocity of the ejection roller 131 is set to be higher than the circumferential velocity of the feeding roller 125 at the time of forward rotation, the feeding roller 125 operates to brake the feeding power of the ejection roller 131. Because the circumferential velocity of the feeding roller 125 is set to be higher than the circumferential velocity of the ejection roller 131 at the time of backward rotation, the ejection roller 131 operates to brake the feeding power of the feeding roller 125. Accordingly, the rolled sheet R is always pulled between the ejection roller 131 and the feeding roller 125, so that the rolled sheet R can be transported forward and backward without deflection between the ejection roller 131 and the feeding roller 125.

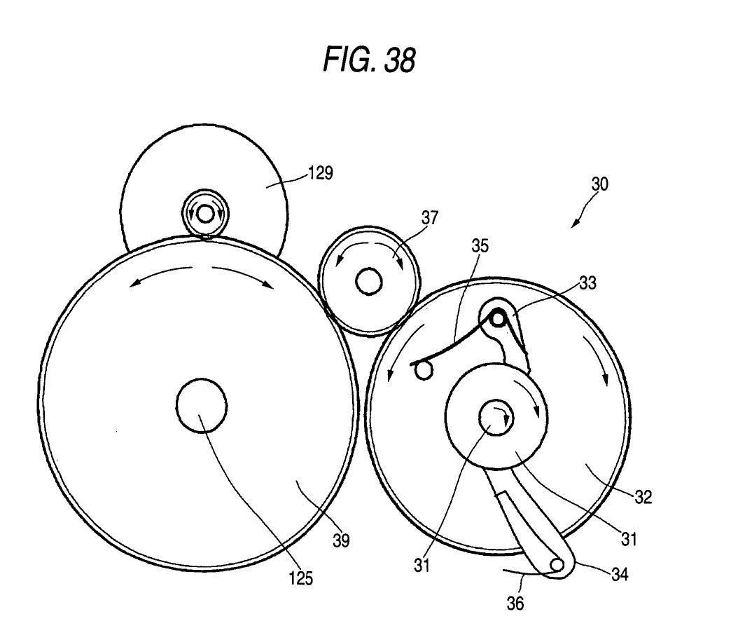

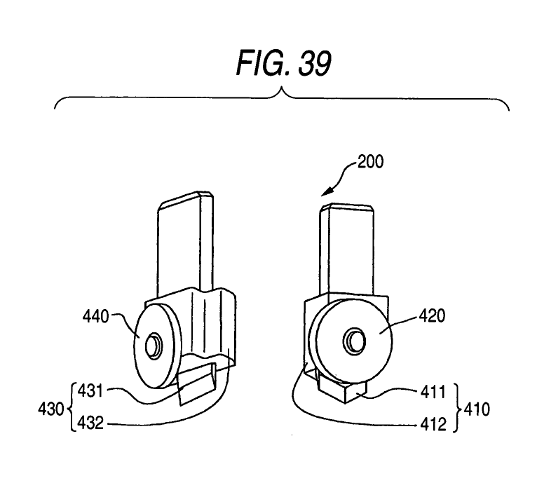

FIGS. 37 and 38 show a second modified example of the drive mechanism for the ejection roller 131 and its periphery. The drive mechanism 30 comprises: a frictional wheel 31 serving as a frictional driver and a frictional brake; an ejection gear 32 serving as the frictional driver and a transmission wheel; and a claw member 33 serving as the frictional driver. The frictional wheel 31 is fitted onto the shaft of the ejection roller 131. The ejection gear 32 is fitted onto the shaft of the ejection roller 131 so as to be adjacent to the frictional wheel 31. The claw member 33 is disposed on the side face of the ejection gear 32 so as to come into contact with the frictional wheel 31. The drive mechanism 30 further comprises a brake lever 34 serving as the frictional brake and disposed on a frame or the like in the housing 111 so as to come into contact with the frictional wheel 31.

The outer circumferential face of the cylindrical frictional wheel 31 is formed as a rough surface having a high friction coefficient. Alternatively, a high friction material is laminated on the frictional wheel 31 so that the outer circumferential face of the frictional wheel 31 has a high friction coefficient. The frictional wheel 31 is fitted on the shaft of the ejection roller 131 so as to be rotatable together with the shaft of the ejection roller 131. The claw member 33 has an outer shape formed like a claw. The claw member 33 has an arcuate tip end which can be brought into oblique contact with the outer circumferential face of the frictional wheel 31. The claw member 33 has a rear end pivoted on the side face of the ejection gear 32 where is away from the outer circumferential face of the frictional wheel 31. That is, the claw member 33 is disposed to make an acute angle with the frictional wheel 31 toward the direction of forward rotation (clockwise rotation shown in FIG. 38) of the ejection roller 131. A torsion coil spring 35 serving as the frictional driver is retained on the side face of the ejection gear 32 urges the tip end face of the claw member 33 to be pressed against the outer circumferential face of the frictional wheel 31. A combination of the frictional wheel 31 and the claw member 33 configured as described above serves as a brake mechanism which applies an intensive braking force on clockwise rotation (forward rotation) shown in FIG. 38.

The claw-shaped brake lever 34 has an arcuate tip end face which can be brought into oblique contact with the outer circumferential face of the frictional wheel 31. The tip end face of the brake lever 34 is formed as a rough surface having a high friction coefficient. Alternatively, a high friction material is laminated onto the front end of the brake lever 34 to obtain a high friction coefficient. The brake lever 34 has a rear end pivoted on a frame or the like in the housing 111 where is away from the outer circumferential face of the frictional wheel 31. That is, the brake lever 34 is disposed to make an acute angle with the frictional wheel 31 toward the direction of forward rotation (clockwise rotation shown in FIG. 38) of the ejection roller 131. A torsion coil spring 36 serving as a frictional brake is retained on the side face of the ejection gear 32 urges the tip end face of the brake lever 34 to be pressed against the outer circumferential face of the frictional wheel 31. A combination of the frictional wheel 31 and the brake lever 34 configured as described above serves as a brake mechanism which applies an intensive braking force on counterclockwise (backward) rotation shown in FIG. 38.

The ejection gear 32 is linked, through a transmission gear 37, to a feeding gear 39 fitted onto the shaft of the feeding roller 125. The ejection gear 32 is fitted onto the shaft of the ejection roller 131 so that the ejection gear 32 can rotate relative to the shaft of the ejection roller 131, that is, a predetermined clearance is formed between the ejection gear 32 and the shaft of the ejection roller 131.

In the aforementioned configuration, when the ejection gear 32 rotates forward, the ejection roller 131 fitted into the frictional wheel 31 rotates forward because the tip end face of the claw member 33 presses the outer circumferential face of the frictional wheel 31 by friction. On this occasion, the brake lever 34 has no relation with the forward rotation of the ejection roller 131 fitted into the frictional wheel 31 because the tip end face of the brake lever 34 slips on the outer circumferential face of the frictional wheel 31.

On the other hand, when the ejection gear 32 rotates backward, an intensive braking force is applied on the ejection roller 131 fitted into the frictional wheel 31 because the tip end face of the brake lever 34 presses the outer circumferential face of the frictional wheel 31 by friction. On this occasion, the claw member 33 has no relation with the backward rotation of the ejection roller 131 fitted into the frictional wheel 31 because the tip end face of the claw member 33 slips on the outer circumferential face of the frictional wheel 31.

As described above, a combination of the frictional wheel 31, the ejection gear 32, the claw member 33 and the torsion coil spring 35 serves as the frictional driver whereas a combination of the frictional wheel 31, the brake lever 34 and the torsion coil spring 36 serves as the frictional brake. Accordingly, there can be provided a simple and small-sized drive mechanism in which the circumferential velocity of the ejection roller 131 can be set to be higher than the circumferential velocity of the feeding roller 125 at the time of forward rotation and in which only the feeding roller 125 can be rotated backward at the time of backward rotation to apply a braking force on the ejection roller 131 without transmission of any driving force to the ejection roller 131.

In this configuration, when the rolled sheet R is transported in order to record information on the rolled sheet R, tensile force is always applied on the rolled sheet R in the transporting direction so that accurate recording can be made while the rolled sheet R can be prevented from being deflected. When the rolled sheet R is transported backward to be cut not only in the primary scanning direction but also in the secondary scanning direction, tensile force is always applied on the rolled sheet R backward in the transporting direction so that accurate cutting can be made while the rolled sheet R can be prevented from being deflected and the recording surface can be prevented from being contaminated with ink caused by rubbing of the rolled sheet R against the recording heads 121.

In the aforementioned configuration, the ejection roller 131 is provided with a combination of the frictional wheel 31, the ejection gear 32, the claw member 33 and the torsion coil spring 35 which serves as the frictional driver only at the time of forward rotation, and the ejection roller 131 is further provided with a combination of the frictional wheel 31, the brake lever 34 and the torsion coil spring 36 which serves as the frictional brake at the time of backward rotation. Accordingly, tensile force can be always applied on the rolled sheet R in the transporting direction and backward in the transporting direction by the action of the ejection roller 131 which can rotate forward but no driving force is transmitted to and a braking force is applied on the election roller 131 at the time of backward rotation. There can be provided a simple and small-sized mechanism which can transport the rolled sheet R forward and backward without deflection of the rolled sheet R.

Because the circumferential velocity of the ejection roller 131 is set to be higher than the circumferential velocity of the feeding roller 125 at the time of forward rotation, the feeding roller 125 operates to brake the feeding power of the ejection roller 131. Because setting is made at the time of backward rotation so that only the feeding roller 125 is rotated backward to apply a braking force on the ejection roller 131, the ejection roller 131 serves as a load imposed on the feeding power of the feeding roller 125. Accordingly, the rolled sheet R is always pulled between the ejection roller 131 and the feeding roller 125, so that the rolled sheet R can be transported forward and backward without deflection of the rolled sheet R between the ejection roller 131 and the feeding roller 125.

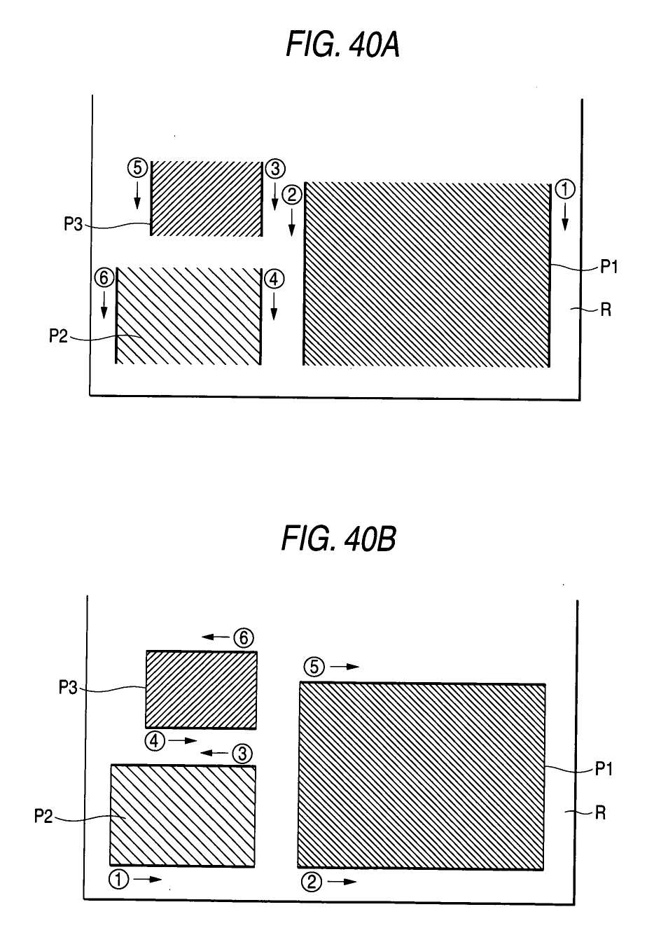

Next, a recording medium cutting method in the cutting device 200 according to any one of the aforementioned embodiments will be described. As shown in FIG. 39, the cutting device 200 according to any one of the aforementioned embodiments comprises a widthwise cutting unit 410, and a press roller 420. The widthwise cutting unit 410 cuts the recorded portion P of the rolled sheet R in the primary scanning direction. The press roller 420 is disposed adjacent to the widthwise cutting unit 410 so that the rolled sheet R can be retained by the press roller 420 while the rolled sheet R is cut in the primary scanning direction. The cutting device 200 further comprises a lengthwise cutting unit 430, and a press roller 440. The lengthwise cutting unit 430 cuts the recorded portion P of the rolled sheet R in the secondary scanning direction. The press roller 440 is disposed adjacent to the lengthwise cutting unit 430 so that the rolled sheet R is retained by the press roller 440 while the rolled sheet R is cut in the secondary scanning direction.

The widthwise cutting unit 410 comprises a double-edged lateral direction cutter 411, and a holder 412. The lateral direction cutter 411 is attached to a lower end of the holder 412. The press roller 420 is attached to the holder 412 so as to be arranged in front of the lateral direction cutter 411 viewed from the front of the printer. The holder 412 is disposed so as to be movable both in the vertical direction and in the primary scanning direction together with the press roller 420 in the condition that one of the cutting edges of the lateral direction cutter 411 faces downward. Although a double-edged cutter is used as the lateral direction cutter 411, the double-edged cutter may be replaced by a single-edged cutter.

For example, a solenoid coil, an air cylinder, an oil pressure cylinder or a combination of a motor and a gear or pulley mechanism may be used to move the lateral direction cutter 411 and the press roller 420 in the vertical direction. For example, a combination of a motor and a pulley mechanism may be used to move the lateral direction cutter 411 and the press roller 420 in the primary scanning direction. The device may be directly attached to the carriage 122.

The lengthwise cutting unit 430 has a single-edged vertical direction cutter 431, and a holder 432. The vertical direction cutter 431 is attached to a lower end of the holder 432. The press roller 440 is attached to the holder 432 so as to be arranged in the left of the vertical direction cutter 431 viewed from the front of the printer. The holder 432 is disposed so as to be movable both in the vertical direction and in the primary scanning direction together with the press roller 440 in the condition that the cutting edge of the vertical direction cutter 431 faces downward. Although a single-edged cutter is used as the vertical direction cutter 431, the single-edged cutter may be replaced by a double-edged cutter.

For example, a solenoid coil, an air cylinder, an oil pressure cylinder or a combination of a motor and a gear or pulley mechanism may be used to move the vertical direction cutter 431 and the press roller 440 in the vertical direction. For example, a combination of a motor and a pulley mechanism may be used to move the vertical direction cutter 431 and the press roller 440 in the primary scanning direction. The device may be directly attached to the carriage 122.

The widthwise cutting unit 410 provided with the press roller 420 and the lengthwise cutting unit 430 provided with the press roller 440 may be provided individually or integrally. In the case where the widthwise cutting unit 410 provided with the press roller 420 and the lengthwise cutting unit 430 provided with the press roller 440 are provided individually, the time required for cutting the rolled sheet R can be shortened because the lengthwise cutting unit 430 provided with the press roller 440 can be moved while the widthwise cutting unit 410 provided with the press roller 420 carries out a cutting operation. In the case where the widthwise cutting unit 410 provided with the press roller 420 and the lengthwise cutting unit 430 provided with the press roller 440 are integrally provided, the member for moving the widthwise cutting unit 410 and the press roller 420 in the primary scanning direction can serve also as the member for moving the lengthwise cutting unit 430 and the press roller 440 in the primary scanning direction.

A first cutting method for cutting the rolled sheet R by the cutting device 200 configured as described above will be described with reference to FIG. 5. This cutting method is a method for cutting the recorded portion P of the rolled sheet R into a required size and comprises steps of: cutting first a portion in which the press roller 420 or 440 is not rolling on the recorded portion P; and then cutting a portion in which the press roller 420 or 440 is rolling on the recorded portion P.

That is, the lateral direction cutter 411 first moves in the primary scanning direction and cuts a front side \mathring{1} of the recorded portion P. On this occasion, the press roller 420 is rolling in the front side of a cutting line L1 of the lateral direction cutter 411 so as not to interfere with the recorded portion P. Accordingly, even in the case where the recorded portion P is not fully dried, the rolled sheet R can be prevented from being contaminated with ink. Although FIG. 5 shows the case where the lateral direction cutter 411 cuts the front side \mathring{1} while moving rightward, the lateral direction cutter 411 may cut the front side \mathring{1} while moving leftward.

Then, the vertical direction cutter 431 cuts a left side \mathring{2} of the recorded portion P of the rolled sheet R transported backward. On this occasion, the press roller 440 is rolling in the left side of a cutting line L2 of the vertical direction cutter 431 so as not to interfere with the recorded portion P. Accordingly, even in the case where the recorded portion P is not fully dried, the rolled sheet R can be prevented from being contaminated with ink Although FIG. 5 shows the case where the vertical direction cutter 431 cuts the left side \mathring{2} from the rear end to the front end of the recorded portion P, the vertical direction cutter 431 may cut the left side \mathring{2} from the front end to the rear end of the recorded portion P in the condition that the rolled sheet R is transported forward.

Then, the vertical direction cutter 431 cuts a right side \mathring{3} of the recorded portion P of the rolled sheet R transported backward. On this occasion, the press roller 440 is rolling in the left side of a cutting line L3 of the vertical direction cutter 431 so as to interfere with the recorded portion P. At this point of time, the rolled sheet R can be however prevented from being contaminated with ink because the recorded portion P has been already dried. Although FIG. 5 shows the case where the vertical direction cutter 431 cuts the right side \mathring{3} from the rear end to the front end of the recorded portion P, the vertical direction cutter 431 may cut the right side \mathring{3} from the front end to the rear end of the recorded portion P in the condition that the rolled sheet R is transported forward.

Finally, the lateral direction cutter 411 moves in the primary scanning direction and cuts a rear side \mathring{4} of the recorded portion P. On this occasion, the press roller 420 is rolling in the front side of a cutting line L4 of the lateral direction cutter 411 so as to interfere with the recorded portion P. At this point of time, the rolled sheet R can be however prevented from being contaminated with ink because the recorded portion P has been already dried. Although FIG. 5 shows the case where the lateral direction cutter 411 cuts the rear side \mathring{4} while moving rightward, the cutter 411 may cut the rear side \mathring{4} while moving leftward. According to the aforementioned method, wasteful standby time for waiting for drying of ink to start cutting can be dispensed with.

In the case where the method for cutting the rolled sheet R as shown in FIG. 5 is applied to the cutting device 200 according to the first embodiment as shown in FIG. 4, the press roller 213 is not rolling on the recorded portion P when the front side \mathring{1} and the left side \mathring{2} are cut. Accordingly, even in the case where the recorded portion P is not fully dried at the point of time of the start of cutting, ink can be prevented from being deposited on the press roller 213, so that the rolled sheet R can be prevented from being contaminated with ink. On the other hand, the press roller 213 is rolling on the recorded portion P when the right side \mathring{3} and the rear side \mathring{4} are cut. At this point of time, the recorded portion P has been however already dried. Accordingly, ink can be prevented from being deposited on the press roller 213, so that the rolled sheet R can be prevented from being contaminated with ink.

Incidentally, when the recorded portion P needs to be fully dried in the case where the right side \mathring{3} and the rear side \mathring{4} are cut, setting may be made as follows. First, ink drying time is measured in accordance with the kind of the rolled sheet R and stored, as standby time from the completion of recording to the start of cutting, in the ink jet printer 100 in advance so as to be associated with the kind of the rolled sheet R.

When a user inputs the kind of the rolled sheet R into the ink jet printer 100, standby time corresponding to the kind of the rolled sheet R is set automatically. The ink jet printer 100 may have a built-in temperature sensor so that the standby time can be changed in accordance with the temperature measured by the built-in temperature sensor. Accordingly, the standby time can be optimized as just enough time for drying ink.

In the case where the method for cutting the rolled sheet R as shown in FIG. 5 is applied to the cutting device 200 according to the fifth embodiment as shown in FIG. 17, the press roller 270 or 290 is not rolling on the recorded portion P when the front side \mathring{1} or the left side \mathring{2} is cut. Accordingly, even in the case where the recorded portion P is not fully dried at the point of time of the start of cutting, ink can be prevented from being deposited on the press roller 270 or 290, so that the rolled sheet R can be prevented from being contaminated with ink. On the other hand, the press roller 290 or 270 is rolling on the recorded portion P when the right side \mathring{3} or the rear side \mathring{4} is cut. At this point of time, the recorded portion P has been however already dried. Accordingly, ink can be prevented from being deposited on the press roller 290 or 270, so that the rolled sheet R can be prevented from being contaminated with ink.

As described above, in the recording medium cutting method according to this embodiment, a portion in which the press roller 420, 440, 213, 270 or 290 is not rolling on the recorded portion P is cut first. Accordingly, even in the case where the recorded portion P is not fully dried at the point of time of the start of cutting, ink is not deposited on the press roller 420, 440, 213, 270 or 290. A portion in which the press roller 420, 440, 213, 270 or 290 is rolling on the recorded portion P is then cut. At this point of time, the recorded portion P has been however already dried, so that ink is not deposited on the press roller 420, 440, 213, 270 or 290.

The portion in which the press roller 420, 440, 213, 270 or 290 is not rolling is the front end and one side end of the recorded portion P. The portion in which the press roller 420, 440, 213, 270 or 290 is rolling is the rear end and the other side end of the recorded portion P. Accordingly, the press roller 420, 440, 213, 270 or 290 arranged adjacent to the widthwise cutting unit 410, the lengthwise cutting unit 430 or the cutter 211, 263 or 283 can retain the rolled sheet R in the condition that the press roller is not rolling on the recorded portion P at the front end and the one side end of the recorded portion P. Meanwhile, since the widthwise cutting unit 410, the lengthwise cutting unit 430 and the cutters 211, 263 and 283 cut the front end, the one side end, the other side end and the rear end of the recorded portion P in this order, after the completion of cutting, cut pieces of the rolled sheet R are not caught in the ejection roller 131, so that the rolled sheet R can be ejected smoothly in the transporting direction.

The widthwise cutting unit 410 or the cutter 211, 263 or 283 runs in the primary scanning direction to thereby cut the recorded portion P of the stopped rolled sheet R in the primary scanning direction. In the condition that the lengthwise cutting unit 430 or the cutter 211, 263 or 283 is stopped, the rolled sheet R is transported backward to thereby cut the recorded portion P in the secondary scanning direction. Accordingly, the mechanism for moving the widthwise cutting unit 410, the lengthwise cutting unit 430 or the cutter 211, 263 or 283 can be simplified because cutting can be completed when the widthwise cutting unit 410, the lengthwise cutting unit 430 or the cutter 211, 263 or 283 is formed so as to be movable in the primary scanning direction. Moreover, cutting accuracy can be improved because the rolled sheet R can be cut while being pulled backward in the transporting direction.

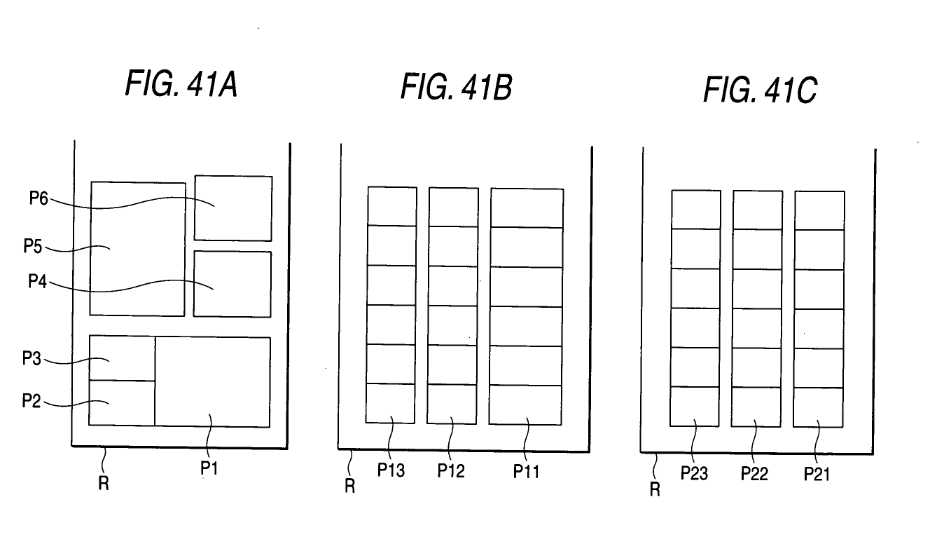

FIGS. 40A and 40B show a second example of the cutting method for cutting the rolled sheet R by the cutting device 200. An image P1 is recorded on the right side of the rolled sheet R in the primary scanning direction viewed from the front end in the transporting direction of the rolled sheet R. An image P2 smaller in width and length than the image P1 is recorded in the left of the image P1 in the primary scanning direction while a gap is formed in the primary scanning direction, that is, while the image P2 is separated from the image P1. An image P3 smaller in width and length than the image P2 is recorded in the left of the image P1 in the primary scanning direction and in the rear of the image P2 in the secondary scanning direction while gaps are formed both in the primary scanning direction and in the secondary scanning direction, that is, while the image P3 is separated from the images P1 and P2. Incidentally, the front end of the image P1 and the front end of the image P2 are aligned in the primary scanning direction while the right end of the image P2 and the right end of the image P3 are aligned in the secondary scanning direction.

The respective images P1 to P3 on the rolled sheet R are cut as follows. First, as shown in FIG. 40A, the vertical direction cutter 231 cuts the images P1 to P3 as recorded portions of the rolled sheet R in the transporting direction, that is, in the secondary scanning direction successively in the order of position nearer to one side end of the rolled sheet R. Then, as shown in FIG. 40B, the lateral direction cutter 211 cuts the images P1 to P3 as the recorded portions in a direction perpendicular to the transporting direction, that is, in the primary scanning direction successively in the order of position nearer to the leading end of the rolled sheet R.

That is, first, as shown in FIG. 40A, the rolled sheet R is transported backward while the vertical direction cutter 231 in an ascending state moves in the primary scanning direction. After the vertical direction cutter 231 is placed above the rear end of the right side \mathring{1} of the image P1 recorded in a position nearer to the right end of the rolled sheet R viewed from the leading end thereof and descends, the rolled sheet R is transported backward to thereby cut the right side \mathring{1} of the image P1. Then, the rolled sheet R is transported forward while the vertical direction cutter 231 ascends and moves in the primary scanning direction. After the vertical direction cutter 231 is placed above the rear end of the left side \mathring{2} of the image P1 and descends, the rolled sheet R is transported backward to thereby cut the left side \mathring{2} of the image P1.

Then, the rolled sheet R is transported while the vertical direction cutter 231 ascends and moves in the primary scanning direction. After the vertical direction cutter 231 is placed above the rear end of the right side \mathring{3} of the image P3 and descends, the rolled sheet R is transported backward to thereby cut the right side \mathring{3} of the image P3. Then, the vertical direction cutter 231 ascends and the rolled sheet R is transported backward. After the vertical direction cutter 231 is placed above the rear end of the right side \mathring{4} of the image P2 and descends, the rolled sheet R is transported backward to thereby cut the right side \mathring{4} of the image P2. On this occasion, the cutting sequence may be changed so that the right side \mathring{3} of the image P3 is cut after the right side \mathring{4} of the image P2 is cut.

Then, the rolled sheet R is transported while the vertical direction cutter 231 ascends and moves in the primary scanning direction. After the vertical direction cutter 231 is placed above the rear end of the left side \mathring{5} of the image P3 and descends, the rolled sheet R is transported backward to thereby cut the left side \mathring{5} of the image P3. Then, the rolled sheet R is transported backward while the vertical direction cutter 231 ascends and moves in the primary scanning direction. After the vertical direction cutter 231 is placed above the rear end of the left side \mathring{6} of the image P2 and descends, the rolled sheet R is transported backward to thereby cut the left side \mathring{6} of the image P2. In this manner, cutting of all the images P1 to P3 in the transporting direction is completed. Although the above description shows such a cutting sequence that the image P1 recorded in a position nearer to the right end of the rolled sheet R viewed from the leading end thereof is cut first, the cutting sequence may be changed so that the image P2 recorded in a position nearer to the left end of the rolled sheet R viewed from the leading end thereof is cut first.

Then, as shown in FIG. 40B, the lateral direction cutter 211 in an ascending state moves in the primary scanning direction. After the lateral direction cutter 211 is placed above the left end of the front side \mathring{1} of the image P2 recorded in a position nearer to the leading end of the rolled sheet R and descends, the lateral direction cutter 211 moves in the primary scanning direction to thereby cut the front side \mathring{1} of the image P2. Then, the lateral direction cutter 211 ascends and moves in the primary scanning direction. After the lateral direction cutter 211 is placed above the left end of the front side \mathring{2} of the image P1 and descends, the lateral direction cutter 211 moves in the primary scanning direction to thereby cut the front side \mathring{2} of the image P1.

Then, the rolled sheet R is transported while the lateral direction cutter 211 ascends and moves in the primary scanning direction. After the lateral direction cutter 211 is placed above the right end of the rear side \mathring{3} of the image P2 and descends, the lateral direction cutter 211 moves in the primary scanning direction to thereby cut the rear side \mathring{3} of the image P2. Then, the rolled sheet R is transported while the lateral direction cutter 211 ascends and moves in the primary scanning direction. After the lateral direction cutter 211 is placed above the left end of the front side \mathring{4} of the image P3 and descends, the lateral direction cutter 211 moves in the primary scanning direction to thereby cut the front side \mathring{4} of the image P3.

Then, the rolled sheet R is transported while the lateral direction cutter 211 ascends and moves in the primary scanning direction. After the lateral direction cutter 211 is placed above the left end of the rear side \mathring{5} of the image P1 and descends, the lateral direction cutter 211 moves in the primary scanning direction to thereby cut the rear side \mathring{5} of the image P1. Then, the rolled sheet R is transported while the lateral direction cutter 211 ascends and moves in the primary scanning direction. After the lateral direction cutter 211 is placed above the right end of the rear side \mathring{6} of the image P3 and descends, the lateral direction cutter 211 moves in the primary scanning direction to thereby cut the rear side \mathring{6} of the image P3. In this manner, cutting of all the images P1 to P3 in the direction perpendicular to the transporting direction is completed. Incidentally, cutting of all the images P1 to P3 in a direction perpendicular to the transporting direction may be changed so that each image is cut in a direction reverse to the aforementioned cutting direction.

Because the cutting lines of the images P1 to P3 in the primary scanning direction extend in a direction perpendicular to the transporting direction, there is a possibility that the cut edge of each image will be caught in a protrusion or a difference in level in the ink jet printer 100 when the rolled sheet R is transported forward or backward. On the other hand, because the cutting lines of the images P1 to P3 in the secondary scanning direction extend in the transporting direction, there is no possibility that the cut edge of each image will be caught in the protrusion or the difference in level in the ink jet printer 100 even in the case where the rolled sheet R is transported forward or backward.

Therefore, cutting of the respective images P1 to P3 in the secondary scanning direction is made first so that the cut edge of each image can be prevented from being caught in the protrusion or the difference in level in the ink jet printer 100. After cutting of the respective images P1 to P3 in the primary scanning direction is made second, the cut edge of each image is fed only in the transporting direction so as not to move backward in the transporting direction and neither protrusion nor difference in level is disposed on the short transporting path ranging from cutting to sheet ejection so that the cut edge of each image can be prevented from being caught in the protrusion or the difference in level in the ink jet printer 100. Accordingly, because the rolled sheet R can be prevented from being damaged, both recording accuracy and cutting accuracy can be kept high. Moreover, because the conventional user's operation of cutting the rolled sheet R into individual images manually after recording can be made needless, the users labor can be reduced.

As described above, in the recording medium cutting method according to this embodiment, a plurality of images recorded both in the transporting direction and in a direction perpendicular to the transporting direction are cut in the transporting direction successively in the order of position nearer to one end of the rolled sheet R and then cut in the direction perpendicular to the transporting direction successively in the order of position nearer to the leading end of the rolled sheet R. Accordingly, even in the case where the plurality of images with free sizes are recorded so as to be arranged freely on the rolled sheet R, the rolled sheet R can be cut into the respective images automatically. Accordingly, the conventional user's operation of cutting the rolled sheet R can be made needless, so that images high in cutting accuracy can be obtained easily.

The cutting device 200 is movable in a direction perpendicular to the transporting direction. In the condition that the cutting device 200 is stopped in a predetermined position in the direction perpendicular to the transporting direction, the rolled sheet R is transported backward to thereby be cut in the transporting direction. Accordingly, the rolled sheet R can be cut while being pulled, so that cutting accuracy can be improved. In the condition that the rolled sheet R is stopped in a predetermined position, the cutting device 200 moves in the direction perpendicular to the transporting direction to thereby cut the rolled sheet R in the direction perpendicular to the transporting direction. Accordingly, the cutting device 200 can be moved, for example, in the condition that the cutting device 200 is attached to the carriage 122 on which the recording heads 121 are mounted. Accordingly, it is unnecessary to provide any member for moving the cutting device 200 separately, so that the apparatus can be made compact while the cost of the apparatus can be reduced.

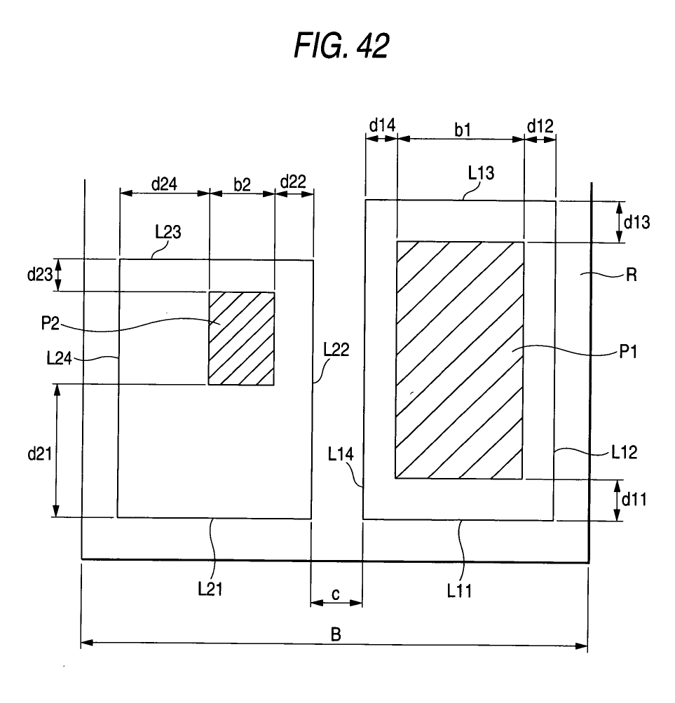

FIGS. 41A to 41C show examples of recording of images cut by the cutting device 200. In the example shown in FIG. 41A, images are recorded as follows. First, an image P1 is recorded on the right side of the rolled sheet R viewed from the leading end thereof. Then, an image P2 smaller in width and length than the image P1 is recorded on the left side of the image P1 so that no gap is formed in the primary scanning direction, that is, the image P2 contacts the image P1. Then, an image P3 equal in width and length to the image P2 is recorded on the left side of the image P1 and on the rear side of the image P2 so that no gap is formed both in the primary scanning direction and in the secondary scanning direction, that is, the image P3 contacts the images P1 and P2.

Then, an image P4 is recorded on the rear side of the image P1 so that a gap is formed in the secondary scanning direction, that is, the image P4 is separated from the image P1. Then, an image P5 larger in width and length than the image P4 is recorded on the left side of the image P4 so that gaps are formed both in the primary scanning direction and in the secondary scanning direction, that is, the image P5 is separated from the images P1, P3 and P4. Then, an image P6 equal in width and length to the image P4 is recorded on the rear side of the image P4 and on the right side of the image P5 so that gaps are formed both in the primary scanning direction and in the secondary scanning direction, that is, the image P6 is separated from the images P4 and P5.

Because the aforementioned images can be cut easily by the cutting device 200, images with free sizes can be recorded so as to be arranged freely in the relatively large width of the rolled sheet R. Conventionally, a long recording time is required because recording must be stopped during the feeding of the rolled sheet R when a plurality of images need to be recorded while being arranged one by one in the secondary scanning direction. According to the cutting device 200, the recording time can be however reduced because the plurality of images are recorded while being arranged in the primary scanning direction as sufficiently as possible to reduce the number of times for feeding the rolled sheet R. In addition, because it is unnecessary to exchange the rolled sheet R in accordance with the size of each image, the user's labor can be reduced.

In the example shown in FIG. 41B, images are recorded as follows. First, an image P11 is recorded on the right side of the rolled sheet R viewed from the leading end thereof. Then, an image P12 smaller in width than the image P11 and equal in length to the image P11 is recorded on the left side of the image P11 so that a gap is formed in the primary scanning direction, that is, the image P12 is separated from the image P11. Then, an image P13 equal in width and length to the image P12 is recorded on the left side of the image P12 so that a gap is formed in the primary scanning direction, that is, the image P13 is separated from the image P12. Then, next images P11, P12 and P13 equal in width and length to the images P11, P12 and P13 are recorded on the rear side of the images P11, P12 and P13 so that no gap is formed in the secondary scanning direction, that is, the next images P11, P12 and P13 come in contact with each other in the secondary scanning direction.

The aforementioned images can be cut easily by the cutting device 200. Particularly when rows of images are recorded without any gap formed between the rows, there is a possibility that cutting lines will be poor because the cutting lines are displaced from the boundaries of the images. In the aforementioned example, the rows of images are recorded while a gap is formed between adjacent ones of the rows. Accordingly, when each image is cut at a position making inroads into the image, there is no problem even in the case where the cutting lines are more or less displaced from the boundaries. Because the cutting lines of the rows of images in the secondary scanning direction are straight lines and the cutting lines of the rows of images in the primary scanning direction are also straight lines, efficient cutting can be made. This efficiency becomes remarkable when rows of images P21, P22 and P23 such as L-size photographic images all equal in width and length as shown in FIG. 41C are cut.

As described above, the cutting device 200 is provided so that free-size images recorded so as to be arranged freely in the size of the rolled sheet R taken in a direction perpendicular to the transporting direction can be cut automatically. Accordingly, efficiency in recording and cutting processes can be improved. Moreover, the plurality of images are recorded while being arranged successively in the direction perpendicular to the transporting direction. Accordingly, even in the case where the size of the rolled sheet R in the direction perpendicular to the transporting direction is large, the plurality of images can be arranged in accordance with the size of the rolled sheet R so that efficiency in use of the rolled sheet R can be improved.

Moreover, the plurality of images are recorded without any gap in the transporting direction and with a gap in the direction perpendicular to the transporting direction. Accordingly, the cutting device 200 can be formed so that positioning accuracy only in the transporting direction is made high. The cutting device 200 can be achieved by a simple configuration. Moreover, images arranged in the transporting direction among the plurality of images are recorded so that the sizes of the images in a direction perpendicular to the transporting direction are equalized. Accordingly, the images arranged in the transporting direction can be cut linearly in the direction perpendicular to the transporting direction, so that cutting efficiency can be improved.

On the other hand, images arranged in a direction perpendicular to the transporting direction among the plurality of images are recorded so that the sizes of the images in the transporting direction are equalized. Accordingly, the images arranged in the direction perpendicular to the transporting direction can be cut linearly in the direction perpendicular to the transporting direction, so that cutting efficiency can be improved. In the cutting device 200, all the recorded portions of the rolled sheet R are cut in the transporting direction and then cut in a direction perpendicular to the transporting direction. Accordingly, the images which have been already cut can be ejected successively in the order of position nearer to the front end of the rolled sheet R in the transporting direction, so that transporting error can be prevented from being caused by interference between the rolled sheet R and the ejection roller 131 or the like.

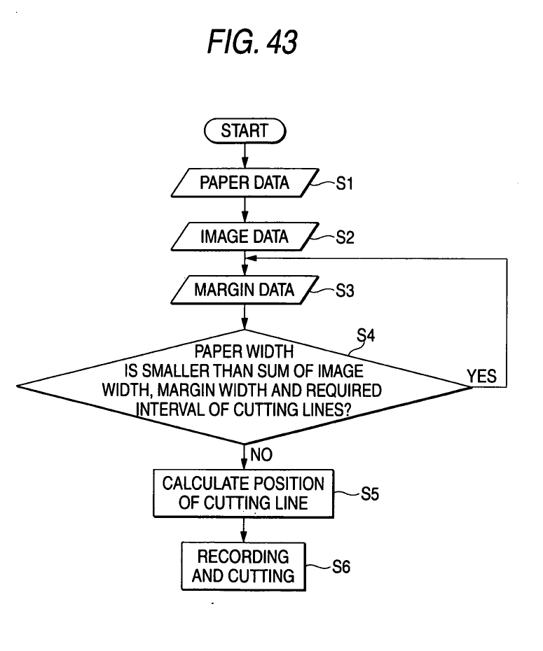

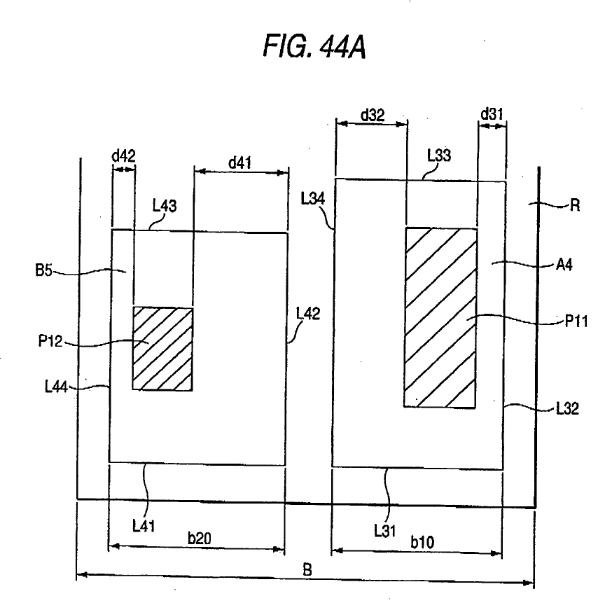

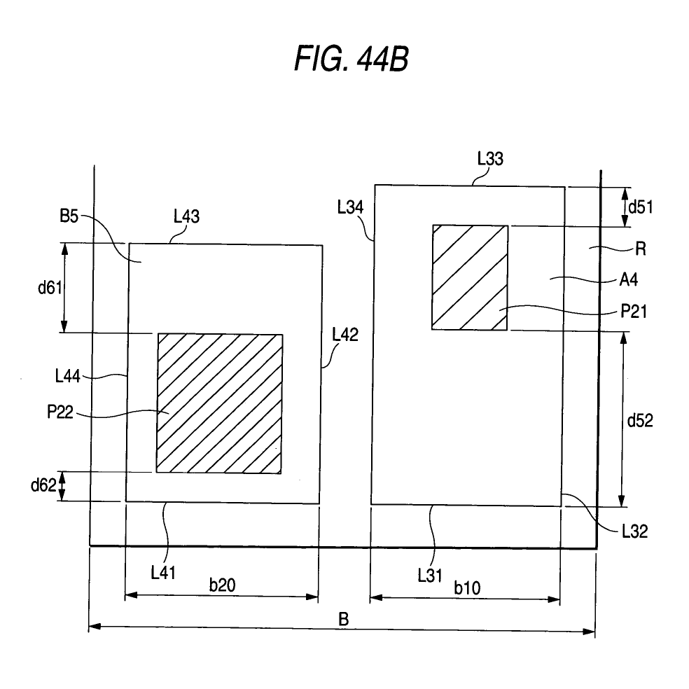

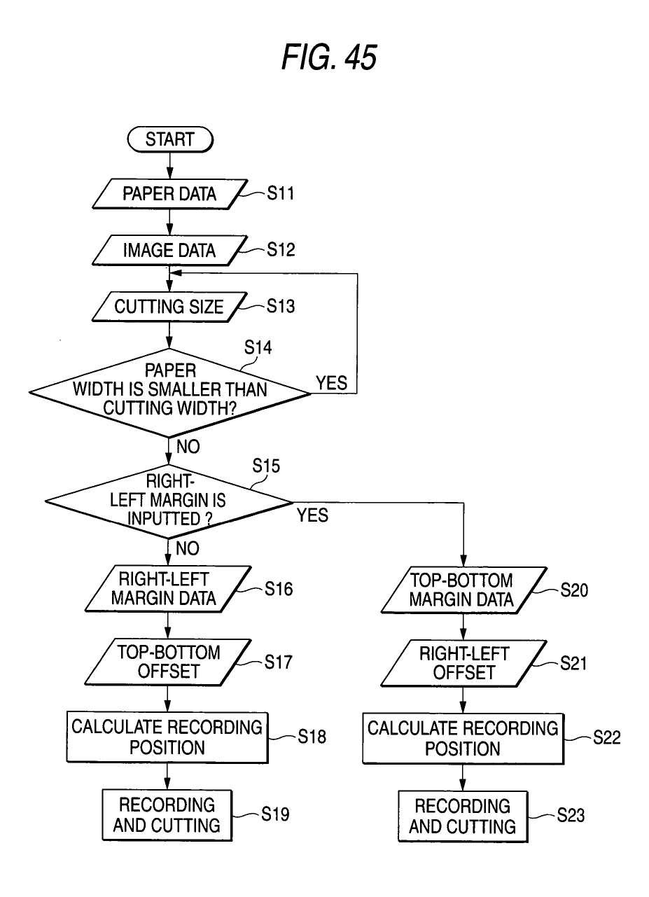

FIGS. 42 and 43 show a third cutting example of the method for cutting the rolled sheet R by the cutting device 200. FIGS. 44A, 44B and 45 show a fourth example of the cutting method for cutting the rolled sheet R by the cutting device 200. The third example of the cutting method is carried out as follows. The user inputs margin data by determining the degree of margins formed around each image recorded on the rolled sheet R or by determining whether margins are provided or not. The ink jet printer 100 calculates cutting lines automatically on the basis of the margin data and operates the cutting device 200 to cut the rolled sheet R along the cutting lines.

The fourth example of the cutting method is carried out as follows. The user inputs cutting size data by determining the cutting size of each image recorded on the rolled sheet R. The ink jet printer 100 arranges each image in an arbitrary position in the cutting area automatically on the basis of the cutting size data and operates the cutting device 200 to cut the image with the cutting size.

The third example will be described first. The user operates the control panel 170 to input data of sheet to be used, such as data concerning the kind and size of the rolled sheet R shown in FIG. 42, and data of images to be recorded, such as data concerning the shape and size of an image P1 shown in FIG. 42 and data concerning the shape and size of an image P2 shown in FIG. 42. That is, sheet data and image data are set (in steps S1 and S2 in FIG. 43).

Then, the user operates the control panel 170 to input data of margins provided around each image. For example, data d11, d12, d13 and d14 concerning widths of margins around the four sides of a rectangular image P1 shown in FIG. 42 and data d21, d22, d23 and d24 concerning widths of margins around the four sides of a rectangular image P2 shown in FIG. 42 are set (in step S3 in FIG. 43). When the user inputs the margin data as a plus value, a margin is provided. When the user inputs the margin data as zero, cutting is made along the edges of the image without any margin. When the user inputs the margin data as a minus value, cutting is made so as to be caved in the image without any margin.

The ink jet printer 100 reads sheet width data, image width data, margin width data and required interval data of cutting lines in connection with the primary scanning direction from the input data. For example, the ink jet printer 100 reads data B concerning the width of the rolled sheet R, data b1 concerning the width of the image P1, data b2 concerning the width of the image P2, data d12 and d14 concerning the widths of margins around the image P1, data d22 and d24 concerning the widths of margins around the image P2, and data c concerning the interval between cutting lines L14 and L22 as shown in FIG. 42.

Here, the term “required interval between cutting lines” means the smallest distance in which the residual portion of the rolled sheet R between cutting lines of adjacent images can be prevented from causing transporting error such as jamming at the time of transporting of the rolled sheet R while the residual portion can be kept rigid when a plurality of images are recorded on the rolled sheet R as in the example. Accordingly, the interval between cutting lines is not required when only one image is recorded on the rolled sheet R. Incidentally, data concerning the required interval of cutting lines may be housed as a table in accordance with the kind of the rolled sheet R in advance so that the required interval of cutting lines can be set automatically.

Then, the ink jet printer 100 judges whether the sheet width in the primary scanning direction is smaller than the sum of the image width, the margin width and the required interval of cutting lines (step S4 in FIG. 43). When a decision is made that the sheet width is smaller than the sum of the image width, the margin width and the required interval of cutting lines, the current position of this routine goes back to the step S3. The user operates the control panel 170 to change the data of margins provided around each image. Thus, the margin data is input and set again.

On the other hand, when the ink jet printer 100 makes a decision in the step S4 that the sheet width is not smaller than the sum of the image width, the margin width and the required interval of cutting lines, data concerning positions of cutting lines are calculated on the basis of the input data. For example, data concerning positions of start and end points of cutting lines L1, L12, L13 and L14 of the image P1 and cutting lines L21, L22, L23 and L24 of the image P2 are calculated (step S5 in FIG. 43).

Then, the ink jet printer 100 operates the recording heads 121 and the carriage 122 to record the images P1 and P2 on predetermined positions of the rolled sheet R. After the recording, the ink jet printer 100 operates the cutting device 200 to cut the rolled sheet R along the cutting lines L11, L12, L13 and L14 of the image P1 and the cutting lines L21, 122, L23 and L24 of the image P2 (step S6 in FIG. 43).

For example, first, the rolled sheet R is transported backward while the vertical direction cutter 231 which has ascended moves in the primary scanning direction. After the vertical direction cutter 231 is placed above the rear end of the cutting line L12 of the image P1 recorded in a position near to the right end of the rolled sheet R viewed from the leading end thereof and descends, the rolled sheet R is transported backward to thereby be cut along the cutting line L12 of the image P1. Then, the rolled sheet R is transported while the vertical direction cutter 231 ascends and moves in the primary scanning direction. After the vertical direction cutter 231 is placed above the rear end of the cutting line L14 of the image P1 and descends, the rolled sheet R is transported backward to thereby be cut along the cutting line L14 of the image P1.

Then, the rolled sheet R is transported while the vertical direction cutter 231 ascends and moves in the primary scanning direction. After the vertical direction cutter 231 is placed above the rear end of the cutting line L22 of the image P2 and descends, the rolled sheet R is transported backward to thereby be cut along the cutting line L22 of the image P2. Then, the rolled sheet R is transported while the vertical direction cutter 231 ascends and moves in the primary scanning direction.

After the vertical direction cutter 231 is placed above the rear end of the cutting line L24 of the image P2 and descends, the rolled sheet R is transported backward to thereby be cut along the cutting line L24 of the image P2. In this manner, cutting of the rolled sheet R along the cutting lines L12, L14, L22 and L24 of all the images P1 and P2 in the transporting direction is completed. Although the cutting sequence is set so that the image P1 recorded in a position nearer to the right end of the rolled sheet R viewed from the leading end thereof is cut first, the cutting sequence may be changed so that the image P2 recorded in a position nearer to the left end of the rolled sheet R viewed from the leading end thereof is cut first.

Then, the lateral direction cutter 211 which has ascended moves in the primary scanning direction. After the lateral direction cutter 211 is placed above the left end of the cutting line L21 of the image P2 recorded in a position nearer to the leading end of the rolled sheet R and descends, the lateral direction cutter 211 moves in the primary scanning direction to thereby cut the rolled sheet R along the cutting line L21 of the image P2. Then, the lateral direction cutter 211 ascends and moves in the primary scanning direction. After the lateral direction cutter 211 is placed above the left end of the cutting line L11 of the image P1 and descends, the lateral direction cutter 211 moves in the primary scanning direction to thereby cut the rolled sheet R along the cutting line L11 of the image P1.

Then, the rolled sheet R is transported while the lateral direction cutter 211 ascends and moves in the primary scanning direction. After the lateral direction cutter 211 is placed above the left end of the cutting line L23 of the image P2 and descends, the lateral direction cutter 211 moves in the primary scanning direction to thereby cut the rolled sheet R along the cutting line L23 of the image P2. Then, the rolled sheet R is transported while the lateral direction cutter 211 ascends and moves in the primary scanning direction.

After the lateral direction cutter 211 is placed above the left end of the cutting line L13 of the image P1 and descends, the lateral direction cutter 211 moves in the primary scanning direction to thereby cut the rolled sheet R along the cutting line L13 of the image P1. In this manner, cutting of the rolled sheet R along the cutting lines L11, L13, L21 and L23 of all the images P1 and P2 in a direction perpendicular to the transporting direction is completed. Incidentally, cutting of all the images P1 and P2 in the direction perpendicular to the transporting direction may be made in a direction reverse to the aforementioned cutting direction. The aforementioned cutting method is taken as an example and may be replaced by another cutting method.

As described above, even in the case where a plurality of images P1 and P2 are recorded in the widthwise direction of the rolled sheet R, cutting can be made automatically so that margins are provided around the images P1 and P2. Accordingly, the labor for manually cutting the rolled sheet R into individual images P1 and P2 with margins after recording can be omitted. Incidentally, the shape of each image is not limited to a rectangular shape. Even in the case where any shape is used as the shape of each image, cutting can be made automatically in the same manner as described above regardless of whether margins are provided or not.

The fourth example will be described below. The user operates the control panel 170 to input data of sheet to be used and data of images to be recorded. For example, data concerning the kind and size of the rolled sheet R shown in FIG. 44A and data concerning the shape and size of an image P11 and the shape and size of an image P12 shown in FIG. 44A are input and set (in steps S11 and S12 in FIG. 45). Then, the user operates the control panel 170 to input data concerning the cutting sizes of the images. For example, data A4 concerning the cutting size of the rectangular image P11 shown in FIG. 44A and data B5 concerning the cutting size of the rectangular image P12 shown in FIG. 44A are input and set (in step S13 in FIG. 45).

The ink jet printer 100 reads sheet width data and cutting size width data in connection with the primary scanning direction from the input data. For example, the ink jet printer 100 reads data B concerning the width of the rolled sheet R, data b10 concerning the width of the cutting size A4 and data b20 concerning the width of the cutting size B5 as shown in FIG. 44A. Then, the ink jet printer 100 judges whether the sheet width in the primary scanning direction is smaller than the width of the cutting size (step S14 in FIG. 45). When a decision is made that the sheet width is smaller than the width of the cutting size, the current position of this routine goes back to the step S13. The user operates the control panel 170 to change the data of the width of the cutting size of each image. Thus, the cutting size width data is input and set again.

On the other hand, when the ink jet printer 100 makes a decision in the step S14 that the sheet width is not smaller than the width of the cutting size, the user is informed of whether margins are provided in the left and right of each image, through the control panel 170 (step S15 in FIG. 45). When margins need to be provided in the left and right of each image, the user operates the control panel 170 to input data concerning the margins provided in the left and right of the image. For example, data d31 and d32 concerning the widths of margins provided in the left and right of the rectangular image P11 shown in FIG. 44A and data d41 and d42 concerning the widths of margins provided in the left and right of the rectangular Image P12 shown in FIG. 44A are input and set (in step S16 in FIG. 45). Then, the user inputs an instruction that the margins provided in the top and bottom of each image are prescribed (off set) values (step S17 in FIG. 45).

The ink jet printer 100 calculates data concerning the recording positions of the images on the basis of the input data. For example, the ink jet printer 100 calculates data concerning the recording position of the image P11 with left and right margins d31 and d32 in the cutting area of the cutting size A4 and data concerning the recording position of the image P12 with left and right margins d41 and d42 in the cutting area of the cutting size B5 (step S18 in FIG. 45).

Then, the ink jet printer 100 operates the recording heads 121 and the carriage 122 to record the images P11 and P12 on predetermined positions of the rolled sheet R. After recording, the ink jet printer 100 operates the cutting device 200 to cut the rolled sheet R along the cutting lines L31, L32, L33 and L34 of the image P11 and the cutting lines L41, L42, L43 and L44 of the image P12 (step S19 in FIG. 45).

On the other hand, the user operates the control panel 170 to input data of sheet to be used and data of images to be recorded. For example, data concerning the kind and size of the rolled sheet R shown in FIG. 44B, data concerning the shape and size of an image P21 shown in FIG. 44B and data concerning the shape and size of an image P22 shown in FIG. 44B are input and set (in steps S11 and S12 in FIG. 45). Then, the user operates the control panel 170 to input data concerning the cutting size of each image. For example, data A4 concerning the cutting size of the rectangular image P21 shown in FIG. 44B and data B5 concerning the cutting size of the rectangular image P22 shown in FIG. 44B are input and set (in step S13 in FIG. 45).

The ink jet printer 100 reads sheet width data and cutting size width data in connection with the primary scanning direction from the input data. For example, the ink jet printer 100 reads data B concerning the width of the rolled sheet R, data b10 concerning the width of the cutting size A4 and data b20 concerning the width of the cutting size B5 as shown in FIG. 44B. Then, the ink jet printer 100 judges whether the sheet width in the primary scanning direction is smaller than the width of the cutting size (step S14 in FIG. 45). When a decision is made that the sheet width is smaller than the width of the cutting size, the current position of this routine goes back to the step S13. The user operates the control panel 170 to change the data of the width of the cutting size of each image. Thus, the cutting size width data is input and set again.

On the other hand, when the ink jet printer 100 makes a decision in the step S14 that the sheet width is not smaller than the width of the cutting size, the user is informed of whether margins are provided in the left and right of each image, through the control panel 170 (step S15 in FIG. 45). When margins need not be provided in the left and right of each image, the user operates the control panel 170 to input data concerning the top-bottom margins of the image. For example, data d51 and d52 concerning the widths of margins provided in the top and bottom of the rectangular image P21 shown in FIG. 44B and data d61 and d62 concerning the widths of margins provided in the top and bottom of the rectangular image P22 shown in FIG. 44B are input and set (in step S20 in FIG. 45). Then, the user inputs an instruction that the margins provided in the left and right of each image are prescribed (off set) values (step S21 in FIG. 45).

The ink jet printer 100 calculates data concerning the recording positions of the images on the basis of the input data. For example, the ink jet printer 100 calculates data concerning the recording position of the image P21 with top and bottom margins d51 and d52 in the cutting area of the cutting size A4 and data concerning the recording position of the image P22 with top and bottom margins d61 and d62 in the cutting area of the cutting size B5 (step S22 in FIG. 45).

Then, the ink jet printer 100 operates the recording heads 121 and the carriage 122 to record the images P21 and P22 on predetermined positions of the rolled sheet R. After recording, the ink jet printer 100 operates the cutting device 200 to cut the rolled sheet R along the cutting lines L31, L32, L33 and L34 of the image P21 and the cutting lines L41, L42, L43 and L44 of the image P22 (step S23 in FIG. 45).

As described above, when a plurality of images P11 and P12 (or P21 and P22) need to be recorded in the widthwise direction of the rolled sheet R, cutting can be made automatically after the images P11 and P12 (or P21 and P22) are recorded on arbitrary positions in a cutting area with a desired cutting size. Accordingly, the labor for manually cutting the rolled sheet R into the individual images P11 and P12 (or P21 and P22) with margins after recording can be omitted. Incidentally, it is possible to provide desired margins in the top, bottom, left and right of each image. The shape of each image is not limited to a rectangular shape. Even in the case where any shape is used as the shape of each image, cutting can be made automatically regardless of whether margins are provided or not.

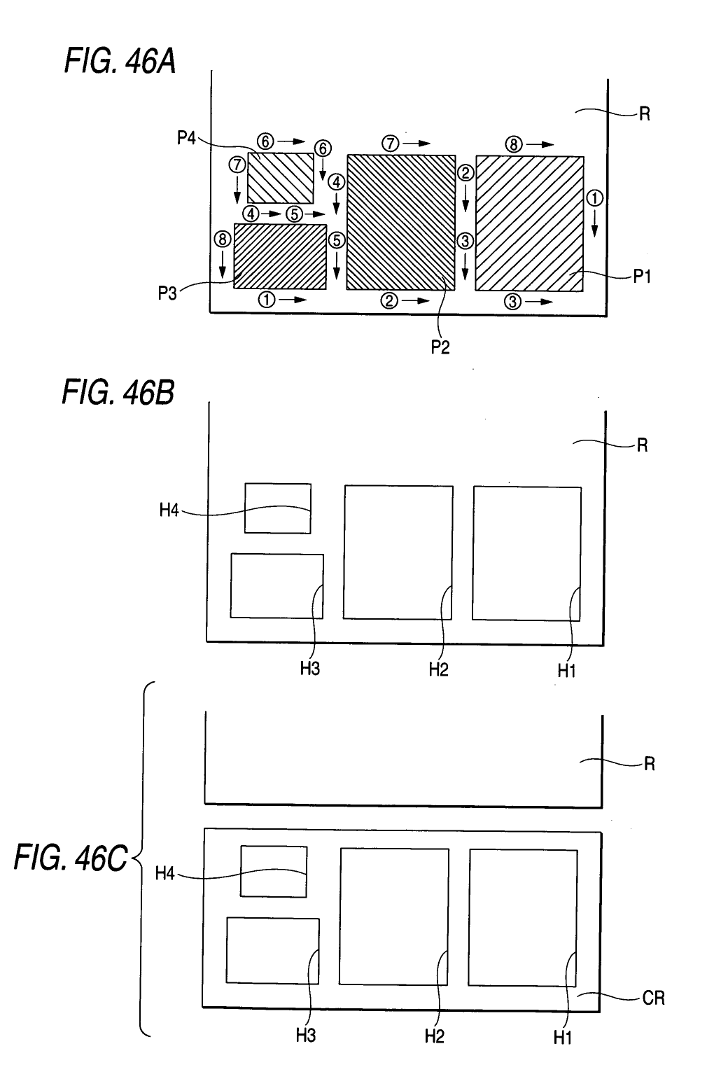

FIGS. 46A to 46C show a fifth example of a method for cutting the rolled sheet R by the cutting device 200. A plurality of images can be recorded on the rolled sheet R so as to be arranged both in the secondary scanning direction and in the primary scanning direction. The user decides a region in which a plurality of images are recorded, as a set of images. Incidentally, the region provided as a set of images can be decided desirably by the user. Alternatively, the printer may decide the region automatically. The cutting device 200 is formed so that the region with holes provided as a set of images is cut away in the primary scanning direction after the respective images recorded in the set of images decided in the aforementioned manner are cut.

As shown in FIG. 46A, first, the user determines a region in which images P1 to P4 can be recorded orderly, for example, in the widthwise and longitudinal directions of the rolled sheet R, as a set of images. That is, an image P1 is recorded on the right side of the rolled sheet R viewed from the leading end thereof. An image P2 equal in width and length to the image P1 is recorded on the left side of the image P1 so that a gap is formed in the primary scanning direction, that is, the image P2 is separated from the image P1. Further, an image P3 smaller in width and length than the image P2 is recorded on the left side of the image P2 so that a gap is formed in the primary scanning direction, that is, the image P3 is separated from the image P2. An image P4 smaller in width and length than the image P3 is recorded on the rear side of the image P3 and on the left side of the image P2 so that gaps are formed both in the secondary scanning direction and in the primary scanning direction, that is, the image P4 is separated from the images P3 and P2.

Then, for example, the vertical direction cutter 231 cuts the images P1 to P4 as the recorded portions of the rolled sheet R successively, in the transporting direction, that is, in the secondary scanning direction in the order of recording position nearer to one side end of the rolled sheet R. Then, the lateral direction cutter 211 cuts the images P1 to P4 as the recorded portions successively in a direction perpendicular to the transporting direction, that is, in the primary scanning direction in the order of recording position nearer to the leading end of the rolled sheet R.

That is, first, the rolled sheet R is transported backward while the vertical direction cutter 231 which has ascended moves in the primary scanning direction. After the vertical direction cutter 231 is placed above the rear end of the right side \mathring{1} of the image P1 recorded in a position nearer to the right end of the rolled sheet R viewed from the leading end thereof and descends, the rolled sheet R is transported backward to thereby be cut along the right side \mathring{1} of the image P1. Then, the rolled sheet R is transported while the vertical direction cutter 231 ascends and moves in the primary scanning direction. After the vertical direction cutter 231 is placed above the rear end of the left side \mathring{2} of the image P1 and descends, the rolled sheet R is transported backward to thereby be cut along the left side \mathring{2} of the image P1.

Then, the rolled sheet R is transported while the vertical direction cutter 231 ascends and moves in the primary scanning direction. After the vertical direction cutter 231 is placed above the rear end of the right side \mathring{3} of the image P2 and descends, the rolled sheet R is transported backward to thereby be cut along the right side \mathring{3} of the image P2. Then, the rolled sheet R is transported while the vertical direction cutter 231 ascends and moves in the primary scanning direction. After the vertical direction cutter 231 is placed above the rear end of the left side \mathring{4} of the image P2 and descends, the rolled sheet R is transported backward to thereby be cut along the left side \mathring{4} of the image P2.

Then, the vertical direction cutter 231 ascends and the rolled sheet R is transported. After the vertical direction cutter 231 is placed above the rear end of the right side \mathring{5} of the image P3 and descends, the rolled sheet R is transported backward to thereby be cut along the right side \mathring{5} of the image P3. Then, the rolled sheet R is transported while the vertical direction cutter 231 ascends and moves in the primary scanning direction. After the vertical direction cutter 231 is placed above the rear end of the right side \mathring{6} of the image P4 and descends, the rolled sheet R is transported backward to thereby be cut along the right side \mathring{6} of the image P4.

Then, the rolled sheet R is transported while the vertical direction cutter 231 ascends and moves in the primary scanning direction. After the vertical direction cutter 231 is placed above the rear end of the left side \mathring{7} of the image P4 and descends, the rolled sheet R is transported backward to thereby be cut along the left side \mathring{7} of the image P4. Then, the rolled sheet R is transported backward while the vertical direction cutter 231 ascends and moves in the primary scanning direction.

After the vertical direction cutter 231 is placed above the rear end of the left side \mathring{8} of the image P3 and descends, the rolled sheet R is transported backward to thereby be cut along the left side \mathring{8} of the image P3. In this manner, cutting of all the images P1 to P4 in the transporting direction is completed. Although the above description shows the cutting sequence in which the image P1 recorded in a position nearer to the right end of the rolled sheet R viewed from the leading end thereof is cut first, the cutting sequence may be changed so that the image P3 recorded in a position nearer to the left end of the rolled sheet R viewed from the leading end thereof is cut first.

Then, the lateral direction cutter 211 which has ascended moves in the primary scanning direction. After the lateral direction cutter 211 is placed above the left end of the front side \mathring{1} of the image P3 recorded in a position nearer to the leading end of the rolled sheet R and descends, the lateral direction cutter 211 moves in the primary scanning direction to thereby cut the rolled sheet R along the front side \mathring{1} of the image P3. Further, the lateral direction cutter 211 ascends and moves in the primary scanning direction. After the lateral direction cutter 211 is placed above the left end of the front side \mathring{2} of the image P2 and descends, the lateral direction cutter 211 moves in the primary scanning direction to thereby cut the rolled sheet R along the front side \mathring{2} of the image P2. Further, the lateral direction cutter 211 ascends and moves in the primary scanning direction. After the lateral direction cutter 211 is placed above the left end of the front side \mathring{3} of the image P1 and descends, the lateral direction cutter 211 moves in the primary scanning direction to thereby cut the rolled sheet R along the front side \mathring{3} of the image P1.

Then, the rolled sheet R is transported while the lateral direction cutter 211 ascends and moves in the primary scanning direction. After the lateral direction cutter 211 is placed above the left end of the rear side \mathring{4} of the image P3 and descends, the lateral direction cutter 211 moves in the primary scanning direction to thereby cut the rolled sheet R along the rear side \mathring{4} of the image P3. Further, the rolled sheet R is transported while the lateral direction cutter 211 ascends and moves in the primary scanning direction. After the lateral direction cutter 211 is placed above the left end of the front side \mathring{5} of the image P4 and descends, the lateral direction cutter 211 moves in the primary scanning direction to thereby cut the rolled sheet R along the front side \mathring{5} of the image P4.

Then, the rolled sheet R is transported while the lateral direction cutter 211 ascends and moves in the primary scanning direction. After the lateral direction cutter 211 is placed above the left end of the rear side \mathring{6} of the image P4 and descends, the lateral direction cutter 211 moves in the primary scanning direction to thereby cut the rolled sheet R along the rear side \mathring{6} of the image P4. Further, the lateral direction cutter 211 ascends and moves in the primary scanning direction. After the lateral direction cutter 211 is placed above the left end of the rear side \mathring{7} of the image P2 and descends, the lateral direction cutter 211 moves in the primary scanning direction to thereby cut the rolled sheet R along the rear side \mathring{7} of the image P2.

Further, the lateral direction cutter 211 ascends and moves in the primary scanning direction. After the lateral direction cutter 211 is placed above the left end of the rear side \mathring{8} of the image P1 and descends, the lateral direction cutter 211 moves in the primary scanning direction to thereby cut the rolled sheet R along the rear side \mathring{8} of the image P1. In this manner, cutting of all the images P1 to P4 in a direction perpendicular to the transporting direction is completed. Incidentally, cutting of all the images P1 to P4 in the direction perpendicular to the transporting direction may be performed in a direction reverse to the aforementioned cutting direction. The aforementioned cutting method is taken as an example and may be replaced by another cutting method.

By the aforementioned method, cutting of the images P1 to P4 recorded in a set of images is completed as shown in FIG. 46B. Accordingly, the region provided as the set of images is brought in a state in which holes H1 to H4 are formed in the region. Therefore, as shown in FIG. 46C, the rolled sheet R is transported while the lateral direction cutter 211 ascends and moves in the primary scanning direction. After the lateral direction cutter 211 is placed above the outside of the left edge of the rolled sheet R and descends, the lateral direction cutter 211 moves in the primary scanning direction to thereby cut away the leading end portion CR of the rolled sheet R which is the region provided as a set of images. As a result, next recording can be prevented from starting in the condition that large holes H1 to H4 are formed in the leading end portion of the rolled sheet R. Accordingly, the rolled sheet R can be transported while sucked reliably, so that recording accuracy can be kept high.

As described above, a region in which a plurality of arbitrary images are to be recorded is defined as a unit region, and the unit region is cut away in a direction perpendicular to the transporting direction after the respective images recorded in the unit region are cut. Accordingly, because the leading end portion of the rolled sheet R is cut away whenever all images contained in the unit region are cut, there is no large hole in the leading end portion of the rolled sheet R when a next set of images are recorded. Accordingly, the rolled sheet R can be sucked and transported reliably, so that recording accuracy can be kept high.

The cutting device 200 is movable in the direction perpendicular to the transporting direction. When the rolled sheet R is transported backward in the condition that the cutting device 200 is stopped in a predetermined position in the direction perpendicular to the transporting direction, the rolled sheet R is cut in the transporting direction. Accordingly, the rolled sheet R can be cut while being pulled, so that cutting accuracy can be improved. When the cutting device 200 moves in the direction perpendicular to the transporting direction in the condition that the rolled sheet R is stopped in a predetermined position, the rolled sheet R is cut in the direction perpendicular to the transporting direction. Accordingly, for example, the cutting device 200 can be moved in the condition that the cutting device 200 is attached to the carriage 122 provided with the recording heads 121. Accordingly, it is unnecessary to provide any member for moving the cutting device 200 individually. The apparatus can be formed compactly while the cost of the apparatus can be reduced.

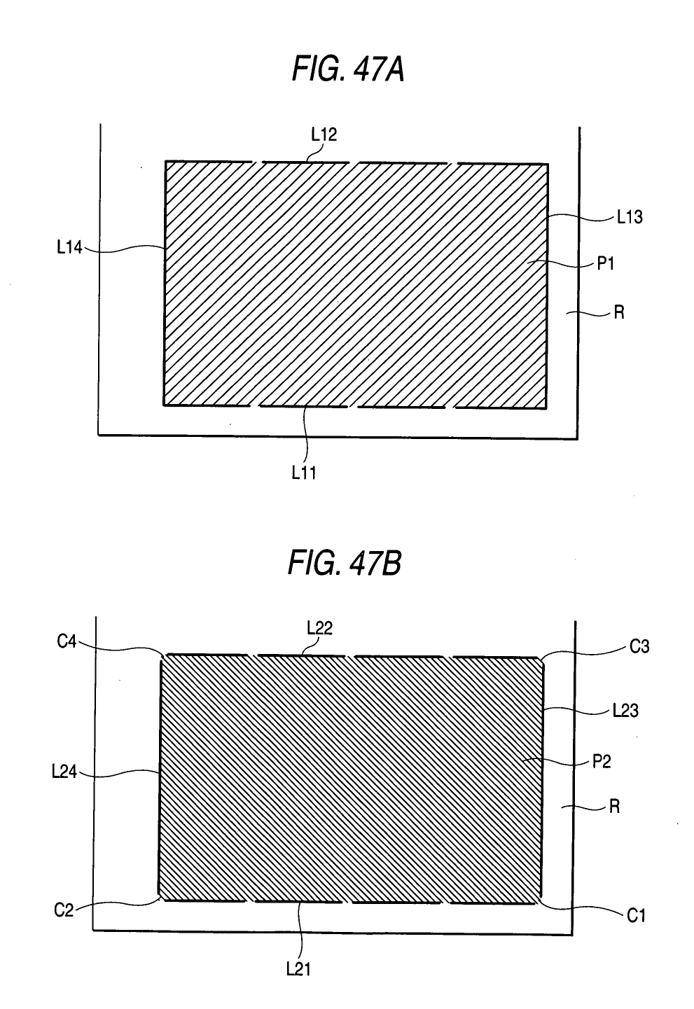

FIGS. 47A and 47B show a sixth example of a method for cutting the rolled sheet R by the cutting device 200. In the example shown in FIG. 47A, the rolled sheet R is cut as follows. Two sides taken in the primary scanning direction among four sides of a rectangular image P1 recorded on the rolled sheet R are cut so that cutting lines L11 and L12 are formed as intermittent lines. On the other hand, two sides taken in the secondary scanning direction are cut so that cutting lines L13 and L14 are formed as continuous lines.

Even in the case where two sides of the image P1 taken in the secondary scanning direction are cut continuously in the aforementioned manner, edges of the cutting lines L13 and L14 are not warped during the transportation because the cutting lines L13 and L14 are parallel to the transporting direction. On the other hand, if two sides of the image P1 taken in the primary scanning direction are cut continuously, there is a possibility that edges of the cutting lines L11 and L12 are warped during the transportation because the cutting lines L11 and L12 are straight lines perpendicular to the transporting direction.

Therefore, when two sides of the image P1 taken in the primary scanning direction are cut intermittently in the aforementioned manner, each of the cutting lines L11 and L12 is divided into a plurality of line segments arranged at regular intervals. Accordingly, edges of the cutting lines L11 and L12 are hardly warped during the transportation, so that the edges of the cutting lines L11 and L12 can be prevented from being caught in protrusions etc. provided on the transporting path.

In the example shown in FIG. 47B, the rolled sheet R is cut as follows. Two sides taken in the primary scanning direction among four sides of a rectangular image P2 recorded on the rolled sheet R are cut so that cutting lines L21 and L22 are provided as intermittent lines. On the other hand, two sides taken in the secondary scanning direction are cut so that cutting lines L23 and L24 are provided as continuous lines. Moreover, cutting is made so that portions of intersection between the cutting lines L21 and L22 on the two sides taken in the primary scanning direction and the cutting lines L23 and L24 on the two sides taken in the secondary scanning direction, that is, four corners C1 to C4 of the image P2 are not cut to be left as they are. Incidentally, the four corners C1 to C4 of the image P2 remain with respect to both the cutting lines L21 and L22 on the two sides taken in the primary scanning direction and the cutting lines L23 and L24 on the two sides taken in the secondary scanning direction or remain with respect to only the cutting lines L21 and 122 on the two sides taken in the primary scanning direction.

Even in the case where two sides of the image P2 taken in the secondary scanning direction are cut continuously in the aforementioned manner, edges of the cutting lines L23 and L24 are not warped during the transportation because the cutting lines L23 and L24 are parallel to the transporting direction. On the other hand, if two sides of the image P2 taken in the primary scanning direction are cut continuously, there is a possibility that edges of the cutting lines L21 and L22 are warped during the transportation because the cutting lines 121 and L22 are straight lines perpendicular to the transporting direction. Moreover, there is a possibility that the portions of intersection between the cutting lines L21 and L22 on the two sides taken in the primary scanning direction and the cutting lines L23 and L24 on the two sides taken in the secondary scanning direction, that is, the four corners C1 to C4 of the image P2 float up during the transportation.

Therefore, when cutting is made in the aforementioned manner so that the four corners C1 to C4 of the image P2 are not cut so as to remain while the two sides of the image P2 taken in the primary scanning direction are cut intermittently, the four corners C1 to C4 are integrated with the rolled sheet R while each of the cutting lines L21 and L22 is divided into a plurality of line segments arranged at regular intervals. Accordingly, the four corners C1 to C4 can be prevented from floating up during the transportation while the edges of the cutting lines L21 and L22 can be prevented from being warped during the transportation. Accordingly, the edges of the cutting lines L21 and 122 can be prevented from being caught in protrusions etc. provided on the transporting path.

For example, the intermittent cutting can be achieved when the user operates the control panel 170 to input: data concerning the length of portions to be cut and data concerning the length of portions to be not cut; data concerning the length of portions to be not cut and data concerning the number of cutting lines divided by the portions to be not cut; data concerning the number of cutting lines divided by the portions to be not cut (the entire length of the cutting lines is fixed); or data concerning the length of a cutting line in a direction perpendicular to the transporting direction, that is, data concerning the width of an image to be cut out.

Configuration may be made so that optimum intermittent cutting can be set automatically in accordance with the kind of the rolled sheet R, the width of each image, and so on. When data concerning the kind of the rolled sheet R and the number of cutting lines divided by the portions to be not cut are input or when data concerning the kind of the rolled sheet R and the length of each cutting line in a direction perpendicular to the transporting direction are input, intermittent cutting lines can be obtained. In this manner, dashed cutting lines can be obtained in accordance with the user's request.

As described above, the cutting device 200 cuts the rolled sheet R so that at least one part of cutting lines are provided as intermittent lines, for example, cutting lines perpendicular to the transporting direction are provided as intermittent lines. Accordingly, edges of the cutting lines are hardly warped during the transportation, so that the edges of the cutting lines can be prevented from being caught in protrusions etc. provided on the transporting path. Moreover, cutting is made so that the corners of each image which are portions of intersection between the cutting lines perpendicular to the transporting direction and the cutting lines parallel to the transporting direction are not cut so as to remain. Accordingly, edges of the corners do not float up during the transportation, so that the edges of the corners can be prevented from being caught in protrusions etc. provided on the transporting path.

Although the embodiments have been described on the case where an ink jet printer is used as a recording apparatus, the embodiments may be applied to a recording apparatus such as a facsimile machine or a copying machine if the recording apparatus can be equipped with the cutting device. The invention can be applied not only to a recording apparatus but also to an apparatus in terms of liquid jet apparatus in which liquid corresponding to the purpose of use is jet instead of ink from liquid jet heads to a recording medium so as to be deposited on the recording medium. Examples of the liquid jet apparatus are apparatuses equipped with color material ejection heads used for production of a color filter in a liquid crystal display or the like, electrode material (electrically conducting paste) ejection heads used for formation of an electrode in an organic EL display, a surface light-emitting display (FED) or the like, bio-organic matter ejection heads used for production of a biochip, specimen ejection heads as a precision pipette, and so on.

1. A cutting device for a recording medium, comprising:
a cutter, which cuts a portion of the recording medium, which has been transported in a first direction and subjected to a recording operation, in the first direction and a second direction perpendicular to the first direction;
a press roller, disposed adjacent to the cutter to retain the recording medium when the cutting operation is performed;
a first driver, which moves the cutter and the press roller between a first position and a second position in a third direction orthogonal to the first direction and the second direction; and
a second driver, which changes an attitude of at least one of the cutter and the press roller in accordance with the direction of the cutting operation.
